(19) United States
(12) Patent Application Publication
(10) Pub. No.: US 2025/0320065 A1
(43) Pub. Date: Oct. 16, 2025

(54) HYDROGEN STORAGE AND WITHDRAWAL IN A 3-PHASE (METHANE+CARBON DIOXIDE+NITROGEN, BRINE AND N-OCTANE) GAS RESERVOIR

(71) Applicant: KING FAHD UNIVERSITY OF PETROLEUM AND MINERALS, Dhahran (SA)

(72) Inventors: Md Bashirul HAQ, Dhahran (SA); Dhafer Abdullah AL SHEHRI, Dhahran (SA); Nasiru Salahu MUHAMMED, Dhahran (SA)

(73) Assignee: KING FAHD UNIVERSITY OF PETROLEUM AND MINERALS, Dhahran (SA)

(21) Appl. No.: 18/632,836

(22) Filed: Apr. 11, 2024

(51) Int. Cl. E21B 43/18; E21B 43/24; F17C 1/00

(52) U.S. Cl. CPC B65G 5/00; F17C 1/007

(57) ABSTRACT

A method of hydrogen (H₂) storage and withdrawal is described. The method includes injecting a fluid stream into a subsurface formation via an injection well to form a composition containing a gas-phase mixture, a first liquid-phase mixture, and a solid matrix, injecting a H₂-containing gas stream into the subsurface formation via the injection well to form a first gas mixture containing H₂ gas, heating and pressurizing the subsurface formation containing the first gas mixture via at least one heat well to achieve a storage condition and maintaining the storage condition to store the H₂ in the subsurface formation, injecting a CH₄-containing gas stream into the subsurface formation via the at least one injection well to form a second gas mixture, withdrawing the second gas mixture via at least one production well, and introducing the second gas mixture into a hydrogen purification device including hydrogen-selective membranes.

### CROSS-REFERENCE TO RELATED APPLICATION

Aspects of the present disclosure are related to Applicant's co-pending patent application Ser. No. 18/330,895 filed on Jun. 7, 2023, titled “METHOD OF STORING HYDROGEN GAS IN A SUBSURFACE FORMATION USING NITROGEN, METHANE, AND CARBON DIOXIDE BLEND AS A CUSHION GAS”, which is incorporated herein by reference in its entirety.

### STATEMENT OF ACKNOWLEDGEMENT

Support provided by the College of Petroleum Engineering and Geoscience (CPG) at King Fahd University of Petroleum and Minerals (KFUPM) and the College of Petroleum and Geosciences with Start-Up Fund-SF19005 is gratefully acknowledged.

### BACKGROUND

### Technical Field

The present disclosure is directed toward a method of hydrogen (H₂) storage and withdrawal, particularly a method of H₂ storage and withdrawal in a three-phase system.

### Description of Related Art

The “background” description provided herein is to present the context of the disclosure generally. Work of the presently named inventors, to the extent it is described in this background section, as well as aspects of the description that may not otherwise qualify as prior art at the time of filing, are neither expressly nor impliedly admitted as prior art against the present invention.

The emission of greenhouse gases into the atmosphere from fossil fuel combustion is a serious environmental concern, contributing to global warming. This issue has led to a growing interest in replacing fossil fuels with hydrogen as a cleaner alternative. The adoption of renewable resources for hydrogen production holds promise in substantially reducing carbon emissions, making it desirable for addressing climate change.

Hydrogen (H₂) storage faces challenges due to its lightweight nature and limited volumetric capacity; thus, achieving large-scale compressed H₂ storage within practical limits set by technical, economic, land usage, and safety concerns related to surface-based tanks is complex. However, geological formations like aquifers, depleted hydrocarbon reservoirs, and salt caverns are potential high-capacity H₂ storage options. Over time, large-scale storage of natural gas (e.g., CH₄) and carbon dioxide (CO₂) has been accomplished in geological formations. Nevertheless, in the case of pure H₂ storage at an industrial scale, only salt caverns have been utilized thus far. Limited cases involving the successful storage of gas mixtures containing H₂ in other locations like aquifers and depleted oil and gas reservoirs have been reported. Insights gained from depleted gas reservoir pilot projects-such as sun storage [See: RAG Austria, Underground sun.storage, (2017)] and Hychico [See: A. Perez, E. Pérez, S. Dupraz, J. Bolcich, Patagonia Wind—Hydrogen Project: Underground Storage and Methanation To cite this version:HAL Id: hal-01317467 Patagonia Wind—Hydrogen Project: Underground Storage and Methanation, (2016)] can facilitate our understanding of H₂ storage projects on an industrial scale. Hence, exploring alternative storage site options holds immense importance and warrants further investigation.

Recently, many investigations have been undertaken to predict the movement of H₂ plumes within geological porous media. It has been demonstrated that the migration of H₂ and its storage efficacy is chiefly governed by the interaction of fluid and rock properties, the existence of heterogeneity, and other geological and operational attributes of the porous structure. Nonetheless, efficient gas storage hinges on containment or trapping mechanisms that minimize environmental leakage. For instance, structural (where a low-permeability caprock, brine-saturated, forms a barrier against gas escape) and residual (gas droplets held by capillary forces at the gas-liquid interface) trapping mechanisms have been ascribed as the major containment security during the early years of hydrogen injection. The main trapping method (i.e., structural) employs the capillary properties of the caprock, which holds hydrogen until net buoyancy surpasses the seal's capillary displacement pressure. However, caprock can permit H₂ leakage via a mechanical failure (like membrane or hydraulic seal issues), capillary breakthrough, diffusion, and/or fractures caused by tectonic activity.

Recent investigations have extensively explored fluid and rock properties to understand the intricacies of effective gas storage and containment. These explorations have primarily focused on the interfacial phenomena through wettability studies, encompassing both experimental [See: M. Ali, N. K. Jha, A. Al-Yaseri, Y. Zhang, S. Iglauer, M. Sarmadivaleh, Hydrogen wettability of quartz substrates exposed to organic acids; Implications for hydrogen geo-storage in sandstone reservoirs, J. Pet. Sci. Eng. 207 (2021) 109081. https://doi.org/10.1016/j.petrol.2021.109081., M. Ali, N. K. Jha, A. Al-Yaseri, Y. Zhang, S. Iglauer, M. Sarmadivaleh, Hydrogen wettability of quartz substrates exposed to organic acids; Implications for hydrogen geo-storage in sandstone reservoirs, J. Pet. Sci. Eng. 207 (2021) 109081, L. Hashemi, M. Boon, W. Glerum, R. Farajzadeh, H. Hajibeygi, A comparative study for H2-CH4 mixture wettability in sandstone porous rocks relevant to underground hydrogen storage, Adv. Water Resour. 163 (2022). https://doi.org/10.1016/j.advwatres.2022.104165] and simulation [See: A. Al-Yaseri, S. Abdel-Azeim, J. Al-Hamad, Wettability of water-H₂-quartz and water-H₂-calcite experiment and molecular dynamics simulations: Critical assessment, Int. J. Hydrogen Energy. (2023)] approaches within gas/brine/rock systems. Among these, limited attention has been directed towards gas mixtures (H₂-CH₄/H₂—CO₂/H₂-N₂)/brine/rock systems [See: V. Mirchi, M. Dejam, V. Alvarado, Interfacial tension and contact angle measurements for hydrogen-methane mixtures/brine/oil-wet rocks at reservoir conditions, Int. J. Hydrogen Energy. 47 (2022) 34963-34975., A. Alanazi, N. Yekeen, M. Ali, M. Ali, I. S. Abu-Mahfouz, A. Keshavarz, S. Iglauer, H. Hoteit, Influence of organics and gas mixing on hydrogen/brine and methane/brine wettability using Jordanian oil shale rocks: Implications for hydrogen geological storage, J. Energy Storage. 62 (2023) 106865, L. Hashemi, M. Boon, W. Glerum, R. Farajzadeh, H. Hajibeygi, A comparative study for H2 CH4 mixture wettability in sandstone porous rocks relevant to underground hydrogen storage, Adv. Water Resour. 163 (2022), N. S. Muhammed, B. Haq, D. A. Al Shehri, Hydrogen storage in depleted gas reservoirs using nitrogen cushion gas: A contact angle and surface tension study, Int. J. Hydrogen Energy. (2023)]. Similarly, fluid-fluid interactions have been examined through experimental [See: V. Mirchi, M. Dejam, V. Alvarado, Interfacial tension and contact angle measurements for hydrogen-methane mixtures/brine/oil-wet rocks at reservoir conditions, Int. J. Hydrogen Energy. 47 (2022) 34963-34975, A. Alanazi, N. Yekeen, M. Ali, M. Ali, I. S. Abu-Mahfouz, A. Keshavarz, S. Iglauer, H. Hoteit, Influence of organics and gas mixing on hydrogen/brine and methane/brine wettability using Jordanian oil shale rocks: Implications for hydrogen geological storage, J. Energy Storage. 62 (2023) 106865, L. Hashemi, M. Boon, W. Glerum, R. Farajzadeh, H. Hajibeygi, A comparative study for H2-CH4 mixture wettability in sandstone porous rocks relevant to underground hydrogen storage, Adv. Water Resour. 163 (2022)., N. S. Muhammed, B. Haq, D. A. Al Shehri, Hydrogen storage in depleted gas reservoirs using nitrogen cushion gas: A contact angle and surface tension study, Int. J. Hydrogen Energy. (2023)., M. Hosseini, J. Fahimpour, M. Ali, A. Keshavarz, S. Iglauer, H2-brine interfacial tension as a function of salinity, temperature, and pressure; implications for hydrogen geo-storage, J. Pet. Sci. Eng. 213 (2022) 110441., E. J. Slowinski, E. E. Gates, C. E. Waring, The Effect of Pressure on the Surface Tensions of Liquids, J. Phys. Chem. 61 (1957) 808-810] and simulation [See: Y. Yang, A. K. Narayanan Nair, W. Zhu, S. Sang, S. Sun, Molecular perspectives of interfacial properties of the hydrogen+water mixture in contact with silica or kerogen, J. Mol. Liq. 385 (2023) 122337., Q. T. Doan, A. Keshavarz, C. R. Miranda, P. Behrenbruch, S. Iglauer, Molecular dynamics simulation of interfacial tension of the CO₂-CH₄-water and H₂-CH₄-water systems at the temperature of 300 K and 323 K and pressure up to 70 MPa, J. Energy Storage. 66 (2023)] methods, delving into the interfacial behaviors involving hydrogen, water, and aqueous solutions.

Collectively, insights gathered from contact angle-based wettability studies reveal notable trends. In the absence of organic acid and depending on the rock types, H₂ is inclined to exhibit strong water wetness. Similarly, the presence of organic acid can potentially increase hydrogen's wettability. Additionally, increased proportions of certain impurities (or cushion gas) like CH₄, N₂, and CO₂ demonstrate that contact angles experience a direct relationship with increasing pressure, yet they tend to decrease with increasing temperatures. Conversely, the interaction between hydrogen and aqueous solutions (water+salts) demonstrates a nearly linear decline in interfacial tension (IFT) with increasing pressure and temperature. Notably, at elevated temperatures, the IFT reduction resulting from pressure increase is less pronounced. Furthermore, (H₂+brine) systems IFTs showcase proportional increments alongside increasing salinity. Introducing impurities like N₂, CO₂, and/or CH₄ into (gas+H₂)+H₂O systems leads to IFT reductions. Molecular dynamic simulation studies also exhibited reasonable accuracy in predicting IFTs within (H₂+water) systems when compared to experimental data.

Upon closer examination, it becomes evident that the majority of the reported studies have predominantly concentrated on two-phase mixtures, namely H₂+water, (H₂+cushion)+water, and/or (H₂+oil)+water. Notably, apart from the recent work by Yang and coworkers [See: Y. Yang, J. Wan, J. Li, G. Zhao, X. Shang, Molecular modeling of interfacial properties of the hydrogen+water+decane mixture in three-phase equilibrium, (2023)], the literature lacks information regarding wettability and IFT behaviors within depleted gas reservoirs having a hydrocarbon liquid like n-octane.

In view of the foregoing, one objective of the present disclosure is to provide a method for hydrogen storage in a depleted gas condensate reservoir containing a third hydrocarbon phase and for providing experimental insights into these pertinent system properties for (H₂+n-octane)+brine and (H₂+cushion+n-octane)+brine in a three-phase system.

### SUMMARY

In an exemplary embodiment, a method of hydrogen (H₂) storage and withdrawal is described. The method includes injecting a fluid stream into a subsurface formation via at least one injection well to form a composition containing a gas-phase mixture, a first liquid-phase mixture, and a solid matrix. Injecting the fluid stream increases the wettability of the solid matrix by contacting with the gas-phase mixture and the first liquid-phase mixture and reduces the surface tension of the gas-phase mixture. The first liquid-phase mixture. In some embodiments, the gas-phase mixture of the composition includes 60 to 100 vol. % of H₂ based on a total volume of the gas-phase mixture, and the first liquid-phase mixture of the composition includes water and at least one water-soluble mineral. The solid matrix of the composition includes clay, shale, slate, and minerals. The method further includes injecting a H₂-containing gas stream into the subsurface formation via the at least one injection well to form a first gas mixture containing H₂ gas. The H₂-containing gas stream includes at least 50 vol. % of H₂ based on a total volume of the H₂-containing gas stream. The method further includes heating and pressurizing the subsurface formation containing the first gas mixture via at least one heat well to achieve a storage condition and maintaining the storage condition to store the H₂ in the subsurface formation. The method further includes injecting a CH₄-containing gas stream into the subsurface formation via the at least one injection well to form a second gas mixture and withdrawing the second gas mixture under a withdrawal condition from the subsurface formation via at least one production well, the withdrawal condition having at least one of a matrix temperature and an injection well pressure the same as the storage condition. The method further includes introducing the second gas mixture into a hydrogen purification device including a plurality of hydrogen-selective membranes.

In some embodiments, the composition further includes a second liquid-phase mixture that contains at least one hydrocarbon compound and is immiscible with the first liquid-phase mixture.

In some embodiments, the second liquid-phase mixture contains n-octane.

In some embodiments, the gas-phase mixture of the composition includes no methane (CH₄), the first gas mixture includes no CH₄, and the second gas mixture includes 30 vol. % to 50 vol. % of CH₄ based on a total volume of the second gas mixture.

In some embodiments, the first gas mixture under the storage condition includes about 72 vol. % to 100 vol. % of H₂, about 0 to 14 vol. % of N₂, and about 0 to 14 vol. % of CO₂ based on a total volume of the first gas mixture, and the second gas mixture includes about 60 vol. % of H₂, about 30 vol. % of CH₄, about 5 vol. % of CO₂ and about 5 vol. % of N₂ based on the total volume of the second gas mixture.

In some embodiments, the gas-phase mixture of the composition includes 60 vol. % to 100 vol. % of H₂, 0 to 30 vol. % of nitrogen (N₂), and 0 to 10 vol. % of carbon dioxide (CO₂) based on the total volume of the gas-phase mixture.

In some embodiments, the gas-phase mixture of the composition further includes up to 5 vol. % hydrogen sulfide (H₂S), based on the total volume of the gas-phase mixture.

In some embodiments, the gas-phase mixture of the composition further includes up to 5 vol. % moisture (H₂O), based on the total volume of the gas-phase mixture.

In some embodiments, the subsurface formation is a hydrocarbon-containing reservoir, a depleted natural gas reservoir, a carbon sequestration reservoir, an aquifer, a geothermal reservoir, and/or an in-situ leachable ore deposit.

In some embodiments, the subsurface formation includes a rock material from at least one shale selected from the group consisting of Eagle ford shale, Wolfcamp shale, Posidonia shale, Wellington shale, and Mancos shale.

In some embodiments, the rock material includes one or more of Bentheimer sandstone, Berea sandstone, Vosges sandstone, quartz, borosilicate glass, basalt, shale, calcite, granite, dolomite, gypsum, anhydrite, mica, kaolinite, illite, montmorillonite, and coal.

In some embodiments, at least one water-soluble mineral includes one or more of sodium bicarbonate, sodium carbonate, sodium chloride, potassium bicarbonate, potassium carbonate, and potassium chloride.

In some embodiments, at least one water-soluble mineral is present in the first liquid-phase mixture at a concentration of 0.1 to 30 wt. % based on a total weight of the first liquid-phase mixture.

In some embodiments, at least one water-soluble mineral includes sodium chloride at a concentration of 2 to 5 wt. % based on a total weight of the first liquid-phase mixture.

In some embodiments, the solid matrix of the composition further includes silicate, argillite, quartz, sandstone, gypsum, conglomerate, basalt, feldspar, mica, granite, granodiorite, diorite, calcite, kaolinite, illite, montmorillonite, and sand.

In some embodiments, the storage condition has a temperature in a range of 20 to 80° C. in the subsurface formation.

In some embodiments, the storage condition has a pressure of 300 to 5000 psi in the subsurface formation.

In some embodiments, the fluid stream is injected to increase the H₂ storage capacity of the subsurface formation. The first gas mixture under the storage condition includes about 80 vol. % of H₂, about 10 vol. % of N₂, and about 10 vol. % of CO₂ based on a total volume of the first gas mixture, and the storage condition has a temperature in a range of 30 to 40° C.

In another exemplary embodiment, a method includes passing the gas mixture through the plurality of hydrogen-selective membranes in the hydrogen purification device, thereby allowing hydrogen gas to pass through the hydrogen-selective membranes and rejecting other components in the gas mixture to form a residue composition. The plurality of hydrogen-selective membranes are permeable to hydrogen gas but are at least substantially impermeable to other components in the gas mixture. The method further includes collecting the hydrogen gas after passing the gas mixture through the plurality of hydrogen-selective membranes to form the residue composition, and then recycling the residue composition.

In some embodiments, the plurality of hydrogen-selective membranes in the hydrogen purification device is arranged in parallel, and each membrane of the plurality of hydrogen-selective membranes is placed in a plane perpendicular to the direction of a gas mixture flow in the hydrogen purification device to form a product gas stream comprising H₂.

In some embodiments, the solid matrix, the gas-phase mixture and the first liquid-phase mixture form a three-phase system. The injecting the fluid stream into the subsurface formation increases wettability of the solid matrix by contact with the gas-phase mixture and the first liquid-phase mixture so that a contact angle of the three-phase system is 20°-50°. The injecting the fluid stream into the subsurface formation reduces surface tension of the gas-phase mixture and the first liquid-phase mixture so that an interfacial tension of the three-phase system is 20-45 mN/m.

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is a method flowchart for hydrogen (H₂) storage and withdrawal, according to certain embodiments.

FIG. 2 is a schematic illustration of the drop shape experimental set up, according to certain embodiments.

FIG. 3A shows a real-time image of rock/brine/(gas+n-octane) contact angle, according to certain embodiments.

FIG. 3B shows a real-time image of brine/(gas+n-octane) interfacial tension (IFT), according to certain embodiments.

FIG. 4A is a scanning electron microscopic (SEM) image of the of a reservoir rock (i.e., pure quartz), according to certain embodiments.

FIG. 4B is an SEM image of a calcite mineral constituting the Wolf camp (WC) shale used as a caprock, according to certain embodiments.

FIG. 4C is an SEM image of a quartz mineral constituting the WC shale used as the caprock, according to certain embodiments.

FIG. 5A shows effect of bubble size and time on contact angle (CA) for a three-phase system of ([H₂+cushion] +n-octane)/brine/quartz) at 30° C., according to certain embodiments.

FIG. 5B shows effect of bubble size and time on CA for a three-phase system of ([H₂+cushion] +n-octane)/brine/quartz) at 50° C., according to certain embodiments.

FIG. 5C shows effect of bubble size and time on CA for a three-phase system of ([H₂+cushion] +n-octane)/brine/quartz) at 70° C., according to certain embodiments.

FIG. 6A shows effect of temperature (30 to 70° C.) and pressure (500 to 3000 pounds per square inch (psi) on CA for a (H₂+n-octane)/brine/quartz three-phase system at NaCl brine concentration of 2 wt. %, according to certain embodiments.

FIG. 6B shows effect of temperature (30 to 70° C.) and pressure (500 to 3000 psi) on CA for a (H₂+n-octane)/brine/quartz three-phase system at NaCl brine concentration of 5 wt. %, according to certain embodiments.

FIG. 6C shows effect of temperature (30 to 70° C.) and pressure (500 to 3000 psi) on CA for a (H₂+n-octane)/brine/quartz three-phase system at NaCl brine concentration of 10 wt. %, according to certain embodiments.

FIG. 6D shows effect of temperature (30 to 70° C.) and pressure (500 to 3000 psi) on CA for a (H₂+n-octane)/brine/quartz three-phase system at NaCl brine concentration of 15 wt. %, according to certain embodiments.

FIG. 6E shows effect of temperature (30 to 70° C.) and pressure (500 to 3000 psi) on CA for a (H₂+n-octane)/brine/quartz three-phase system at NaCl brine concentration of 20 wt. %, according to certain embodiments.

FIG. 7A shows effect of temperature (30 to 70° C.) and pressure (500 to 3000 psi) on CA for a (H₂+cushion+n-octane)/brine/quartz three-phase system at NaCl brine concentration of 2 wt. %, according to certain embodiments.

FIG. 7B shows effect of temperature (30 to 70° C.) and pressure (500 to 3000 psi) on CA for a (H₂+cushion+n-octane)/brine/quartz three-phase system at NaCl brine concentration of 5 wt. %, according to certain embodiments.

FIG. 7C shows effect of temperature (30 to 70° C.) and pressure (500 to 3000 psi) on CA for a (H₂+cushion+n-octane)/brine/quartz three-phase system at NaCl brine concentration of 10 wt. %, according to certain embodiments.

FIG. 7D shows effect of temperature (30 to 70° C.) and pressure (500 to 3000 psi) on CA for a (H₂+cushion+n-octane)/brine/quartz three-phase system at NaCl brine concentration of 15 wt. %, according to certain embodiments.

FIG. 7E shows effect of temperature (30 to 70° C.) and pressure (500 to 3000 psi) on CA for a (H₂+cushion+n-octane)/brine/quartz three-phase system at NaCl brine concentration of 20 wt. %, according to certain embodiments.

FIG. 7F shows effect of temperature (30 to 70° C.) and pressure (500 to 3000 psi) on CA for a (H₂+n-octane)/brine/WC shale three phase system at NaCl brine concentration of 2 wt. %, according to certain embodiments.

FIG. 7G shows effect of temperature (30 to 70° C.) and pressure (500 to 3000 psi) on CA for a (H₂+n-octane)/brine/WC shale three phase system at NaCl brine concentration of 5 wt. %, according to certain embodiments.

FIG. 7H shows effect of temperature (30 to 70° C.) and pressure (500 to 3000 psi) on CA for a (H₂+n-octane)/brine/WC shale three phase system at NaCl brine concentration of 10 wt. %, according to certain embodiments.

FIG. 7I shows effect of temperature (30 to 70° C.) and pressure (500 to 3000 psi) on CA for a (H₂+n-octane)/brine/WC shale three phase system at NaCl brine concentration of 15 wt. %, according to certain embodiments.

FIG. 7J shows effect of temperature (30 to 70° C.) and pressure (500 to 3000 psi) on CA for a (H₂+n-octane)/brine/WC shale three phase system at NaCl brine concentration of 20 wt. %, according to certain embodiments.

FIG. 7K shows effect of temperature (30 to 70° C.) and pressure (500 to 3000 psi) on CA for a (H₂+cushion+n-octane)/brine/WC shale three-phase system at NaCl brine concentration of 2 wt. %, according to certain embodiments.

FIG. 7L shows effect of temperature (30 to 70° C.) and pressure (500 to 3000 psi) on CA for a (H₂+cushion+n-octane)/brine/WC shale three-phase system at NaCl brine concentration of 5 wt. %, according to certain embodiments.

FIG. 7M shows effect of temperature (30 to 70° C.) and pressure (500 to 3000 psi) on CA for a (H₂+cushion+n-octane)/brine/WC shale three-phase system at NaCl brine concentration of 10 wt. %, according to certain embodiments.

FIG. 7N shows effect of temperature (30 to 70° C.) and pressure (500 to 3000 psi) on CA for a (H₂+cushion+n-octane)/brine/WC shale three-phase system at NaCl brine concentration of 15 wt. %, according to certain embodiments.

FIG. 7O shows effect of temperature (30 to 70° C.) and pressure (500 to 3000 psi) on CA for a (H₂+cushion+n-octane)/brine/WC shale three-phase system at NaCl brine concentration of 20 wt. %, according to certain embodiments.

FIG. 8 shows CA effect on salinity with respect to quartz and WC shale when injecting 100% H₂ at 50° C. and 2000 psi, according to certain embodiments.

FIG. 9 shows CA effect on salinity with respect to quartz and WC shale when injecting (60% H₂+40% cushion) at 50° C. and 2000 psi, according to certain embodiments.

FIG. 10A shows effect of rock type for pure H₂ for quartz and WC shale samples at NaCl brine concentration of 2 wt. %, at a constant reservoir temperature of 50° C., according to certain embodiments.

FIG. 10B shows effect of rock type for pure H₂ for quartz and WC shale samples at NaCl brine concentration of 10 wt. %, at a constant reservoir temperature of 50° C., according to certain embodiments.

FIG. 10C shows effect of rock type for pure H₂ for quartz and WC shale samples at NaCl brine concentration of 20 wt. %, at a constant reservoir temperature of 50° C., according to certain embodiments.

FIG. 10B shows effect of rock type for pure H₂ for quartz and WC shale samples at NaCl brine concentration of 10 wt. %, at a constant reservoir temperature of 50° C., according to certain embodiments.

FIG. 10D shows effect of rock type for H₂+cushion for quartz and WC shale samples at NaCl brine concentration of 2 wt. %, at a constant reservoir temperature of 50° C., according to certain embodiments.

FIG. 10E shows effect of rock type for H₂+cushion for quartz and WC shale samples at NaCl brine concentration of 10 wt. %, at a constant reservoir temperature of 50° C., according to certain embodiments.

FIG. 10F shows effect of rock type for H₂+cushion for quartz and WC shale samples at NaCl brine concentration of 20 wt. %, at a constant reservoir temperature of 50° C., according to certain embodiments.

FIG. 11 is a schematic representation of the dynamic and equilibrium interfacial tensions (IFTs) between a (H₂/n-octane/brine) three-phase system as a function of pressure (500 to 3000 psi) at a constant temperature of 30° C. and 2 wt. % NaCl brine, according to certain embodiments.

FIG. 12A shows equilibrium IFTs for (n-octane/brine) in the presence of 100% H₂ as a function of pressure (500 to 3000 psi) and temperature (30 to 70° C.) for different salinities at NaCl brine concentration of 2 wt. %, according to certain embodiments.

FIG. 12B shows equilibrium IFTs for (n-octane/brine) in the presence of 100% H₂ as a function of pressure (500 to 3000 psi) and temperature (30 to 70° C.) for different salinities at NaCl brine concentration of 5 wt. %, according to certain embodiments.

FIG. 12C shows equilibrium IFTs for (n-octane/brine) in the presence of 100% H₂ as a function of pressure (500 to 3000 psi) and temperature (30 to 70° C.) for different salinities at NaCl brine concentration of 10 wt. %, according to certain embodiments.

FIG. 12D shows equilibrium IFTs for (n-octane/brine) in the presence of 100% H₂ as a function of pressure (500 to 3000 psi) and temperature (30 to 70° C.) for different salinities at NaCl brine concentration of 15 wt. %, according to certain embodiments.

FIG. 12E shows equilibrium IFTs for (n-octane/brine) in the presence of 100% H₂ as a function of pressure (500 to 3000 psi) and temperature (30 to 70° C.) for different salinities at NaCl brine concentration of 20 wt. %, according to certain embodiments.

FIG. 13A shows equilibrium IFTs for (n-octane/brine) in the presence of 60% H₂+40% cushion as a function of pressure (500 to 3000 psi) and temperature (30 to 70° C.) for different salinities at NaCl brine concentration of 2 wt. %, according to certain embodiments.

FIG. 13B shows equilibrium IFTs for (n-octane/brine) in the presence of 60% H₂+40% cushion as a function of pressure (500 to 3000 psi) and temperature (30 to 70° C.) for different salinities at NaCl brine concentration of 5 wt. %, according to certain embodiments.

FIG. 13C shows equilibrium IFTs for (n-octane/brine) in the presence of 60% H₂+40% cushion as a function of pressure (500 to 3000 psi) and temperature (30 to 70° C.) for different salinities at NaCl brine concentration of 10 wt. %, according to certain embodiments.

FIG. 13D shows equilibrium IFTs for (n-octane/brine) in the presence of 60% H₂+40% cushion as a function of pressure (500 to 3000 psi) and temperature (30 to 70° C.) for different salinities at NaCl brine concentration of 15 wt. %, according to certain embodiments.

FIG. 13E shows equilibrium IFTs for (n-octane/brine) in the presence of 60% H₂+40% cushion as a function of pressure (500 to 3000 psi) and temperature (30 to 70° C.) for different salinities at NaCl brine concentration of 20 wt. %, according to certain embodiments.

FIG. 14A shows a comparative plot between 100% pure H₂, 60% H₂+40% cushion and 100% pure CH₄ at constant 5 wt. % NaCl salinity with a panel representing 30° C. isotherm, according to certain embodiments.

FIG. 14B shows a comparative plot between 100% pure H₂, 60% H₂+40% cushion and 100% pure CH₄ at constant 5 wt. % NaCl salinity with a panel representing 40° C. isotherm, according to certain embodiments.

FIG. 14C shows a comparative plot between 100% pure H₂, 60% H₂+40% cushion and 100% pure CH₄ at constant 5 wt. % NaCl salinity with a panel representing 50° C. isotherm, according to certain embodiments.

FIG. 14D shows a comparative plot between 100% pure H₂, 60% H₂+40% cushion and 100% pure CH₄ at constant 5 wt. % NaCl salinity with a panel representing 60° C. isotherm, according to certain embodiments.

FIG. 14E shows a comparative plot between 100% pure H₂, 60% H₂+40% cushion and 100% pure CH₄ at constant 5 wt. % NaCl salinity with a panel representing 70° C. isotherm, according to certain embodiments.

FIG. 15 shows a difference between the IFT of ([60% H₂+40% cushion]/brine) two-phase system and the IFT of ([60% H₂+40% cushion]/n-octane/brine) three-phase system as a function of pressure, temperature, and 10 wt. % NaCl brine salinity, according to certain embodiments.

FIG. 16A shows effect of IFT on salinity at 50° C. constant temperature and 500 psi pressure, according to certain embodiments.

FIG. 16B shows effect of IFT on salinity at 50° C. constant temperature and 3000 psi pressure, according to certain embodiments.

FIG. 17A shows the calculated maximum H₂ column heights of the Wolf camp (WC) shale for a (100% H₂/n-octane/brine) three-phase system for different pressures (500 to 3000 psi) and at a temperature of 30° C., and 20 wt. % constant NaCl salinity, according to certain embodiments.

FIG. 17B shows the calculated maximum H₂ column heights of the WC shale for a (100% H₂/n-octane/brine) three-phase system for different pressures (500 to 3000 psi) and at a temperature of 40° C., and 20 wt. % constant NaCl salinity, according to certain embodiments.

FIG. 17C shows the calculated maximum H₂ column heights of the WC shale for a (100% H₂/n-octane/brine) three-phase system for different pressures (500 to 3000 psi) and at a temperature of 50° C., and 20 wt. % constant NaCl salinity, according to certain embodiments.

FIG. 17D shows the calculated maximum H₂ column heights of the WC shale for a (100% H₂/n-octane/brine) three-phase system for different pressures (500 to 3000 psi) and at a temperature of 60° C., and 20 wt. % constant NaCl salinity, according to certain embodiments.

FIG. 17E shows the calculated maximum H₂ column heights of the WC shale for a (100% H₂/n-octane/brine) three-phase system for different pressures (500 to 3000 psi) and at a temperature of 70° C., and 20 wt. % constant NaCl salinity, according to certain embodiments.

FIG. 18A shows the calculated maximum H₂ column heights of the WC shale for a ((60% H₂+40% cushion)/n-octane/brine) three-phase system for different pressures (500 to 3000 psi) and at a temperature of 30° C., and 20 wt. % constant NaCl salinity, according to certain embodiments.

FIG. 18B shows the calculated maximum H₂ column heights of the WC shale for a ((60% H₂+40% cushion)/n-octane/brine) three-phase system for different pressures (500 to 3000 psi) and at a temperature of 40° C., and 20 wt. % constant NaCl salinity, according to certain embodiments.

FIG. 18C shows the calculated maximum H₂ column heights of the WC shale for a ((60% H₂+40% cushion)/n-octane/brine) three-phase system for different pressures (500 to 3000 psi) and at a temperature of 50° C., and 20 wt. % constant NaCl salinity, according to certain embodiments.

FIG. 18D shows the calculated maximum H₂ column heights of the WC shale for a ((60% H₂+40% cushion)/n-octane/brine) three-phase system for different pressures (500 to 3000 psi) and at a temperature of 60° C., and 20 wt. % constant NaCl salinity, according to certain embodiments.

FIG. 18E shows the calculated maximum H₂ column heights of the WC shale for a ((60% H₂+40% cushion)/n-octane/brine) three-phase system for different pressures (500 to 3000 psi) and at a temperature of 70° C., and 20 wt. % constant NaCl salinity, according to certain embodiments.

FIG. 19A shows the effect of temperature on the calculated column height at 20 wt. % salinity for a (100% H₂/n-octane/brine) three-phase system, according to certain embodiments.

FIG. 19B shows the effect of temperature on the calculated column height at a (20 wt. % salinity for 60% H₂+40% cushion/n-octane/brine) three-phase system, according to certain embodiments.

FIG. 20A shows the effect of salinity on column height for a (100% H₂/n-octane/brine) three-phase system at a constant 50° C. temperature (seal rock), according to certain embodiments.

FIG. 20B shows the effect of salinity on column height for a (100% H₂/n-octane/brine) three-phase system at a constant 50° C. temperature (reservoir and seal rock), according to certain embodiments.

FIG. 20C shows the effect of salinity on column height for a ((60% H₂+40% cushion)/n-octane/brine) three-phase system at a constant 50° C. temperature (seal rock), according to certain embodiments.

FIG. 20D shows the effect of salinity on column height for a ((60% H₂+40% cushion)/n-octane/brine) three-phase system at a constant 50° C. temperature (reservoir and seal rock), according to certain embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

As used herein, the term “contact angle (CA)” refers to the angle formed between the interface of a solid and a liquid.

As used herein, the term “interfacial tension (IFT)” refers to the work expended to increase the size of the interface between two adjacent phases that are not completely miscible with one another.

As used herein, the term “cushion gas” refers to a gas that is injected into an underground reservoir to maintain pressure and help extract oil or gas from the reservoir.

As used herein, the “volume of subsurface formation” generally refers to the underground reservoirs or geological formations that can be used to store the gas mixture. These formations can include depleted oil and gas reservoirs, aquifers, salt caverns, and other rock formations that are suitable for long-term storage of the gas mixture. The “volume of subsurface formation” may be determined by the size, shape, and properties of the formation, as well as the geologic and hydrologic conditions of the surrounding area.

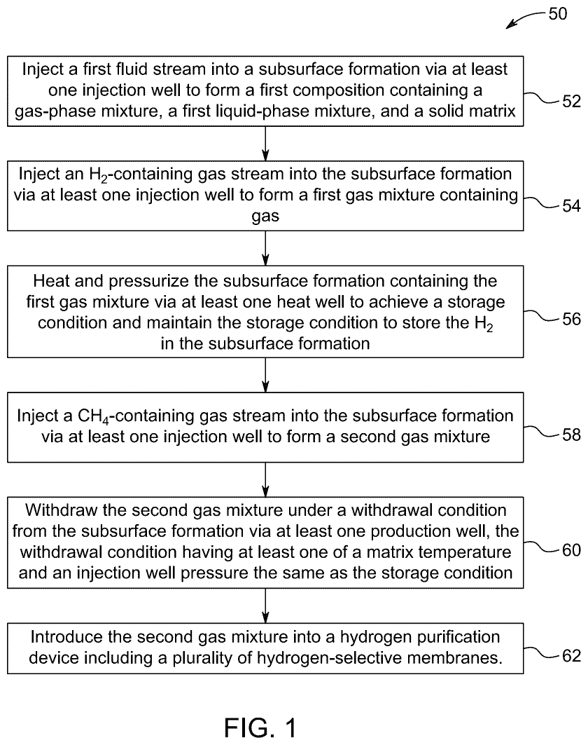

Aspects of this disclosure are directed to a system, device, and method for hydrogen storage in a depleted gas condensate reservoir containing a third hydrocarbon phase, such as n-octane. FIG. 1 illustrates a flow chart of a method 50 of hydrogen (H₂) storage and withdrawal.

The subsurface formation includes at least an injection well configured to place oil and gas production waste, such as brine, into a porous rock formation for storage. Generally, the injection well is drilled thousands of feet, preferably at least 1000 feet, preferably at least, 2000, 3000, 4000 or 5000 feet, preferably at least 10,000 feet, preferably at least 15,000 feet, or even more preferably at least 20,000 feet, into the earth to inject injection fluids into the porous rock formation. By injecting at depth, the injection well does not inject production waste into subsurface freshwater reservoirs. The production waste is further stored in the injection well during the oil and gas extraction process. The storage of production waste in the injection well involves an engineered process to safely and effectively contain fluids within the subsurface formation. The well is configured with casing and cementing to prevent leakage, and drilled to significant depths to access suitable porous rock formations, ensuring waste disposal below freshwater reservoirs. During extraction, waste fluids are directed to the well, pumped under pressure, and injected into the formation. The waste then remains stored for an extended period, minimizing surface impact.

However, geological considerations, continuous monitoring, and compliance with regulatory standards are often used to ensure the storage of the production waste is successful. The subsurface formation further includes at least one production well configured to extract oil or gas from the subsurface during the oil and gas extraction process. The production well is also drilled thousands of feet, preferably at least 1000 feet, preferably at least 2000, 3000, 4000, or 5000 feet, preferably at least 10,000 feet, preferably at least 15,000 feet, or even more, preferably at least 20,000 feet, into the earth directly into oil or gas-rich deposits contained in underground formations. During the oil and gas extraction process, hydraulic fracturing is used to bring the oil or gas to the surface. Hydraulic fracturing is defined as a method in which a mixture of water, sand, and chemicals called “brine” are injected at high pressure through the injection well to fracture the rock, which then releases the oil or natural gas and allows it to flow to the ground surface. The subsurface formation further includes at least one heat well configured to heat the subsurface formation containing storage composition. As used herein, the term “heat well” generally refers to a vertical and/or horizontal pipe or casing that is used to circulate heated fluid, e.g., hot water or steam, into an oil reservoir. In the present disclosure, the heat well can heat up the storage composition in the reservoir after injecting the H₂-containing fluid stream. The viscosity of the gas-phase mixture, and the liquid-phase mixture of the storage composition may be reduced after the heating, making it easier to pump out of the well.

In some embodiments, the volume amount of the gas-phase mixture that can be stored in a depleted gas reservoir ranges from hundreds of thousands of cubic meters (m³) to cubic kilometers, preferably at least 50 m³, preferably at least 500 m³, preferably at least 5,000 m³, or even more preferably at least 50,000 m³, preferably 1×10⁶ m³, preferably 1×10⁷ m³, preferably 1×10⁸ m³, preferably 1×10⁹ m³, preferably 1×10¹⁰ m³. In some embodiments, the mass amount of the gas-phase mixture that can be stored in a depleted gas reservoir ranges from tens of thousands to millions of kilograms (kg), preferably at least 5,000 kg, preferably at least 10,000 kg, preferably at least 50,000 kg, or even more preferably at least 100,000 kg or 1,000,000 kg. Other ranges are also possible. The volume of subsurface formation required to store a given amount of the gas-phase mixture depends on the pressure and temperature conditions of the reservoir, the rock properties of the formation, and the injection and withdrawal rates of the gas. In some further embodiments, the volume of subsurface formation ranges from hundreds to thousands of cubic meters (m³), at least 50 m³, preferably at least 500 m³, preferably at least 5,000 m³, or even more preferably at least 50,000 m³, preferably 1×10⁶ m³, preferably 1×10⁷ m³, preferably 1×10⁸ m³, preferably 1×10⁹ m³, preferably 1×10¹⁰ m³. Other ranges are also possible.

In some embodiments, the heat well is in the form of a closed-loop pipeline having an aboveground loop part, and an underground loop part. The aboveground loop part is in thermal communication with a heat pump supplied by at least one energy source preferably selected from the group consisting of natural gas, electricity, diesel fuel, and solar energy. The heat pump may be monitored and controlled by a computer system to ensure that a desired temperature for the storage composition in the subsurface formation is achieved. In some further embodiments, the underground loop part is extended into the central cavity of the subsurface formation and is in a helix shape that allows substantial contact with the gas-phase mixture, and the liquid-phase mixture of the storage composition. In some more preferred embodiments, the underground loop part is in thermal communication with the gas-phase mixture, and the liquid-phase mixture of the storage composition. In some embodiments, the amount of heat required to store the gas-phase mixture in a depleted gas reservoir is determined by the temperature for the storage composition in the subsurface formation. To determine the required heat needed for storage, a method that considers several factors related to the subsurface formation and the composition of the gas-phase mixture is employed. The approach involves utilizing parameters such as the reservoir temperature profile from analog fields, the specific heat capacities of the storage composition components, the desired storage temperature, and the thermal conductivity of the surrounding rock formation. By simulating the heat exchange processes between the aboveground and underground loop parts of the pipeline, the amount of heat needed to achieve and maintain the desired temperature for the storage composition in the reservoir is determined.

In yet some other embodiments, the underground loop part of the heat well may be located around the subsurface formation and is surrounded by layers of rock and soil. The underground loop part is drilled deep into the ground and is equipped with a series of perforations or slots, known as a perforated casing, that allow the heated fluid to flow into the surrounding rock and heat up the subsurface formation surrounded by the underground loop part.

In some embodiments, the subsurface formation includes a hydrocarbon-containing reservoir, a depleted natural gas reservoir, a carbon sequestration reservoir, an aquifer, a geothermal reservoir, and/or an in-situ leachable ore deposit. In some embodiments, the subsurface formation includes a rock material obtained from at least one shale selected from the group consisting of Eagle ford shale, Wolfcamp shale, Posidonia shale, Wellington shale, and Mancos shale. The rock material includes one or more of Bentheimer sandstone, Berea sandstone, Vosges sandstone, quartz, borosilicate glass, basalt, shale, calcite, granite, dolomite, gypsum, anhydrite, mica, kaolinite, illite, montmorillonite, and coal.

The order in which the method 50 is described is not intended to be construed as a limitation, and any number of the described method steps can be combined in any order to implement the method 50. Additionally, individual steps may be removed or skipped from the method 50 without departing from the spirit and scope of the present disclosure.

At step 52, the method 50 includes injecting a fluid stream into a subsurface formation via at least one injection well. The fluid stream is injected to increase the H₂ storage capacity of the subsurface formation. After injecting, the fluid stream is further stored in the injection well to form a composition containing a gas-phase mixture, a first liquid-phase mixture, and a solid matrix. In some embodiments, the first liquid-phase mixture and the solid matrix are present in the subsurface formation before injecting the fluid stream.

In some embodiments, the solid matrix, the gas-phase mixture and the first liquid-phase mixture form a three-phase system. The injecting the fluid stream into the subsurface formation can change/increase wettability of the solid matrix by contact with the gas-phase mixture and the first liquid-phase mixture so that a contact angle of the three-phase system is 20°-50°, preferably 25°-45°, preferably 30°-40°, preferably 33°-37°. The injecting the fluid stream into the subsurface formation can change/reduce surface tension of the gas-phase mixture and the first liquid-phase mixture so that an interfacial tension of the three-phase system is 20-45 mN/m, preferably 25-40 mN/m, preferably 30-35 mN/m.

In some embodiments, the first liquid-phase mixture of the composition includes water and at least one water-soluble mineral. In some embodiments, at least one water-soluble mineral includes one or more of sodium bicarbonate, sodium carbonate, sodium chloride, potassium bicarbonate, potassium carbonate, and potassium chloride. The water-soluble mineral is present in the first liquid-phase mixture at a concentration of 0.1-30 wt. %, preferably 0.5-29 wt. %, preferably 1-28 wt. %, preferably 2-27 wt. %, preferably 3-26 wt. %, preferably 4-25 wt. %, preferably 5-24 wt. %, preferably 6-23 wt. %, preferably 7-22 wt. %, preferably 8-21 wt. %, preferably 9-20 wt. %, preferably 10-19 wt. %, preferably 11-18 wt. %, preferably 12-17 wt. %, preferably 13-16 wt. %, and preferably 14-15 wt. %, based on a total weight of the first liquid-phase mixture. In some embodiments, the water-soluble mineral is sodium chloride, which is present in the liquid-phase mixture at a concentration of 2-5 wt. %, preferably 2.5-4.5 wt. %, and preferably 3-4 wt. % based on the total weight of the first liquid-phase mixture. In some further preferred embodiments, the liquid-phase mixture may further include a crude oil selected from the group consisting of Arabian Heavy oil, Arabian Light oil, Gulf crudes, and Brent crude. As used herein, the term “crude oil” generally refers to oil that has undergone some pre-treatment, such as water-oil separation, oil-gas separation and/or desalting, and/or a stabilized mixture that contains crude oil. In a specific embodiment, the subsurface formation includes Wolfcamp (WC) shale, and rock material includes quartz.

In some embodiments, the composition further includes a second liquid-phase mixture that contains at least one hydrocarbon compound and is immiscible with the first liquid-phase mixture. Suitable examples of hydrocarbon compounds include methane, ethane, propane, pentane, hexane, heptane, octane, and decane. In a specific embodiment, the second liquid-phase mixture contains n-octane.

The solid matrix of the composition includes clay, shale, slate, and minerals. In some embodiments, the solid matrix of the composition further includes silicate, argillite, quartz, sandstone, gypsum, conglomerate, basalt, feldspar, mica, granite, granodiorite, diorite, calcite, kaolinite, illite, montmorillonite, and sand.

The gas-phase mixture of the composition includes hydrogen (H₂), nitrogen (N₂), and carbon dioxide (CO₂), and preferably does not include methane (CH₄). In some embodiments, the gas-phase mixture of the composition includes 60-100 vol. % of H₂, preferably 65-95%, preferably 70-90%, and preferably 75-85% of H₂; 0-30 vol. % of nitrogen (N₂), preferably 0.5-29%, preferably 1-28%, preferably 2-27%, preferably 3-26%, preferably 4-25%, preferably 5-24%, preferably 6-23%, preferably 7-22%, preferably 8-21%, preferably 9-20%, preferably 10-19%, preferably 11-18%, preferably 12-17%, preferably 13-16%, and preferably 14-15% of N₂; and 0-10 vol. % of carbon dioxide (CO₂), preferably 1-9%, preferably 2-8%, preferably 3-7%, and preferably 4-6% of CO₂, based on the total volume of the gas-phase mixture. In some more preferred embodiments, the gas-phase mixture of the composition further includes up to 5% of hydrogen sulfide (H₂S), preferably 1%, preferably 2%, preferably 3%, and preferably 4% of H₂S, based on the total volume of the gas-phase mixture. In some most preferred embodiments, the gas-phase mixture of the composition further includes up to 5% of moisture (H₂O), preferably 1%, preferably 2%, preferably 3%, and preferably 4% of moisture, based on the total volume of the gas-phase mixture. Other ranges are also possible.

At step 54, the method 50 includes injecting a H₂-containing gas stream into the subsurface formation via at least one injection well to form a first gas mixture containing H₂ gas. The H₂-containing gas stream includes at least 50% of H₂ based on a total volume of the H₂-containing gas stream, preferably at least 70%, preferably at least 90%, or even more preferably at least 99% of H₂ based on the total volume of the H₂-containing gas stream.

In some embodiments, the first gas mixture under the storage condition includes about 72-100% of H₂, preferably 74-96%, preferably 78-92%, preferably 82-88% of H₂, about 0-14% of N₂, preferably 1-13%, preferably 2-12%, preferably 3-11%, preferably 4-10%, preferably 5-9%, preferably 6-7% of N₂ and about 0-14% of CO₂, preferably 1-13%, preferably 2-12%, preferably 3-11%, preferably 4-10%, preferably 5-9%, preferably 6-7% of CO₂ based on a total volume of the first gas mixture. In an embodiment, the first gas mixture does not include CH₄.

At step 56, the method 50 includes heating and pressurizing the subsurface formation containing the first gas mixture via at least one heat well to achieve a storage condition and maintaining the storage condition to store the H₂ in the subsurface formation. The heating can be done by using heating appliances such as an in-situ electric heater and/or by transferring a heat medium via a casing, a pipe and the like. In some embodiments, the storage condition has a temperature in a range of 20-80° C., preferably 30-70° C., preferably 40-60° C., or even more preferably about 50° C. in the subsurface formation in the subsurface formation. In an embodiment, the storage condition has a temperature in a range of 30-40° C., preferably 31-39° C., preferably 32-38° C., preferably 33-37° C., and preferably 34-36° C. In some embodiments, the storage condition has a pressure of 300-5000 psi, preferably 500-3000 psi, preferably 750-2750 psi, preferably 1000-2500 psi, preferably 1250-2250 psi, and preferably 1500-2000 psi, in the subsurface formation.

At step 58, the method 50 includes injecting a CH₄-containing gas stream into the subsurface formation via at least one injection well to form a second gas mixture. In some embodiments, the second gas mixture includes 30-50%, preferably 31-49%, preferably 32-48%, preferably 33-47%, preferably 34-46%, preferably 35-45%, preferably 36-44%, preferably 37-43%, preferably 38-42%, and preferably 39-41%, of CH₄ based on the total volume of the second gas mixture. In some embodiments, the second gas mixture includes about 60% of H₂, about 30% of CH₄, about 5% of CO₂, and about 5% of N₂ based on the total volume of the second gas mixture.

At step 60, the method 50 includes withdrawing the second gas mixture under a withdrawal condition from the subsurface formation via at least one production well. The withdrawal condition has at least one parameter selected from the matrix temperature, and an injection well pressure, the same as the storage condition.

At step 62, the method 50 includes introducing the second gas mixture into a hydrogen purification device including a plurality of hydrogen-selective membranes. This is carried out to separate hydrogen from the second gas mixture. To bring about the separation process, the gas mixture is passed through the plurality of hydrogen-selective membranes in the hydrogen purification device. The membranes allow the hydrogen gas to pass through the hydrogen-selective membranes and reject other components in the gas mixture, leaving behind a residue composition.

The hydrogen purification device is configured to separate hydrogen from the gas mixture. For example, the hydrogen purification device may be a palladium membrane hydrogen purifier. The palladium membrane may include metallic tubes of palladium and silver alloy to allow only monatomic hydrogen to pass through its crystal lattice when it is heated above 300° C. The plurality of hydrogen-selective membranes is permeable to hydrogen gas but is at least substantially impermeable to other components in the gas mixture. The method further includes collecting the hydrogen gas after passing and recycling the residue composition.

### EXAMPLES

The following examples demonstrate a method for hydrogen (H₂) storage and withdrawal. The examples are provided solely for illustration and are not to be construed as limitations of the present disclosure, as many variations thereof are possible without departing from the spirit and scope of the present disclosure.

### Example 1: Materials

High-purity gases were sourced from Air Liquide, Saudi Arabia, including hydrogen (H₂: 99.99%), methane (CH₄: 99.99%), carbon dioxide (CO₂: 99.99%), and nitrogen (N₂: 99.99%). N-octane liquid (99.99%) was also procured from the same supplier. Sodium chloride (NaCl) with 99.99 mol % purity was obtained from Sigma Aldrich, and brine solutions of various concentrations (2 to 20 wt. %) were prepared using deionized water (Millipore purification system). Contact angle experiments used two rock samples: pristine quartz for the reservoir rock, as in a previous study [See: N. S. Muhammed, B. Haq, D. Al Shehri, Role of methane as a cushion gas for hydrogen storage in depleted gas reservoirs, Int. J. Hydrogen Energy. (2023), incorporated herein by reference in its entirety], representing sandstone formation and low TOC Wolf camp (WC) shale substrates for the caprock. The WC shale formation includes organic-rich shale and argillaceous carbonates, with distinct properties across its benches. Experimental conditions for gas compositions and mixtures are detailed in Table 1. Gas mixtures were meticulously prepared, adhering to the ideal gas mixing rule, which assumes seamless blending of ideal gases without interactions. As per this rule, each gas's partial pressure in the mixture is directly proportional to its mole fraction. It's worth emphasizing that the measurement uncertainty associated with preparing gas mixtures in Table 1 falls within a range of 0-3%.

TABLE 1
Experimental conditions used

| | Mixture composition (%) | | | | Salinity | Temperature | Pressure |
|---|---|---|---|---|---|---|---|
| Test Cases | H₂ | CH₄ | CO₂ | N₂ | (wt. %) | (° C.) | (psi) |
| Pure H₂ | 100 | 0 | 0 | 0 | 2, 5, 10, 15, | 30, 40, 50, 60, | 500-3000 |
| | | | | | 20 | 70 | |
| H₂ + | 60 | 30 | 5 | 5 | 2, 5, 10, 15, | 30, 40, 50, 60, | 500-3000 |
| Cushion | | | | | 20 | 70 | |

### Example 2: Sample Characterization

Various techniques were employed to characterize the rock samples, including X-ray diffraction (XRD), scanning electron microscopy (SEM), and Rock-Eval analysis. XRD assessed compositions and bulk mineralogy, while SEM provided high-resolution images of sample surfaces, revealing topography and morphology. For the WC shale sample, total organic carbon (TOC) analysis via the Soli TOC model with true temperature ramping up to 900° C. in an oxygenated atmosphere, complying with DIN 19539, was used to measure the organic content. Furthermore, the effect of surface roughness on contact angles was evaluated for both reservoir and caprock substrates using a Surface Roughness Analyzer device from KRÜSS GmbH.

### Example 3: Cleaning Procedure

Before commencing the experiment, the DSA device was thoroughly cleaned using deionized water (DI) to flush its flow lines. It was left to dry overnight at room temperature (25° C.). After each experimental run, the n-octane and gas-mixture flow lines (initially cleaned with DI) were carefully purged with the n-octane and gas-mixture to eliminate external air bubble interference. For the brine flowline, residual brine from the previous experiment was removed using DI water. On the other hand, the substrate samples, sized 2 cm×2 cm×0.5 cm, were initially cut from core plugs. A polishing process was performed using an EcoMet 250 Grinder-Polisher with 600 grit sandpaper to achieve a smooth surface. The polished samples were cleaned with DI and dried with pure N₂ gas to eliminate surface contaminants. To address concerns about natural organics impacting interfacial phenomena, the substrates were exposed to air plasma for 5 minutes based on previous studies [See: S. Iglauer, M. Ali, A. Keshavarz, Hydrogen Wettability of Sandstone Reservoirs: Implications for Hydrogen Geo-Storage, Geophys. Res. Lett. 48 (2021) 1-5., A. Al-Yaseri, D. Wolff-Boenisch, C. A. Fauziah, S. Iglauer, Hydrogen wettability of clays: Implications for underground hydrogen storage, Int. J. Hydrogen Energy. 46 (2021) 34356 34361, incorporated herein by reference in its entirety] before further analysis.

### Example 4: Experimental Setup

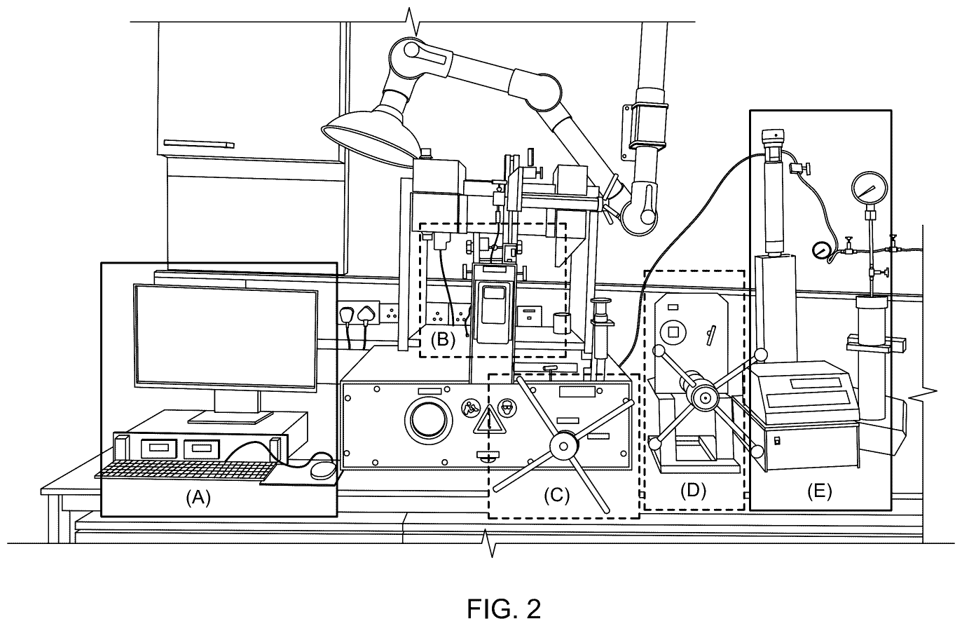

The captive bubble (contact angle) and pendant drop (IFT) techniques were employed in this experiment. The captive bubble method was chosen due to its advantages over the sessile drop approach, which can face challenges related to brine spreading and diffusion within porous hydrophilic substrates. These measurements were conducted within a dedicated high-temperature, high-pressure device, as shown in FIG. 2, capable of handling up to 10,000 psi pressure and 200° C. temperature. This setup features a high-pressure, high-temperature (HPHT) thermostatic view cell with an internal volume of around 30 cc. The view cell (B, in FIG. 2) incorporates dual sapphire windows that effectively seal the ends, enabling visual examination of suspended droplets or bubbles. A light-emitting diode (LED) light source was positioned alongside the view cell to illuminate the bubble and pendant, while an opposing CCD camera captured detailed droplet images. Temperature measurement uncertainty was 0.025 K, and pressure measurement uncertainty was 0.035 MPa. Brine, n-octane, and gas were injected through designated paths (C, D, and E in FIG. 2). The bubble created on the rock surface (for contact angle measurement) was continuously captured by the CCD camera and recorded in the connected computer system (A, in FIG. 2).

### Example 5: Contact angle measurement

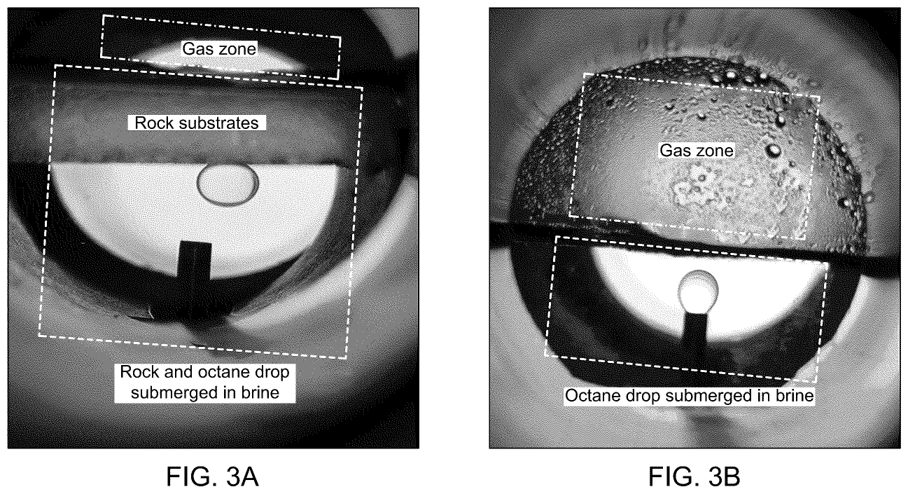

To measure the contact angle of the three-phase system, a custom fitting holder was used to mount the substrates (quartz or WC shale) inside the HPHT cell, ensuring a flat surface. Secondly, the HPHT chamber was sealed via sapphire windows to allow clear visualization. Thirdly, NaCl aqueous solution (i.e., from 2 to 20 wt. %) was used to fill the HPHT chamber (i.e., two-thirds of the 30 cc) using pump C (in FIG. 2) while the gas mixture (one-third of the 30 cc) was continuously injected until the prescribed pressure (say 500 psi) was reached using ISCO pump E (in FIG. 2). Following that, the temperature control was tuned to achieve the specific temperature (from 30 to 70° C.) based on the specific experiment. Subsequently, an inverted bubble of the n-octane (with a size ranging from 12 μL+2.5 μL) was released from the capillary needle (via pump D in FIG. 2) until it touched the flat rock substrate, ensuring no formation of filament (often observed when using captive bubble technique) between the rock and the brine. The tests were performed under equilibrium conditions (constant pressure and temperature) to mitigate the mass transfer between the three phases to ensure accurate measurements. To achieve this, a small n-octane bubble was produced at the capillary needle tip. The system was then allowed to reach equilibrium for approximately 5 minutes, ensuring stable pressure and temperature conditions before further measurements were conducted. The DSA software (computer A, in FIG. 2) was employed to automatically analyze the acquired images between the (gas-octane)/brine/rock (quartz and shale) systems. Finally, the equivalent static contact angles were measured using Young-Laplace fittings. The mean values were computed for at least 50 replicate data points, and results were presented based on standard deviations. A real-time image of this process is shown in FIG. 3A.

### Example 6: Interfacial Tension (IFT) Measurement

For the IFT assessments, all the contact angle procedure was repeated, excluding the insertion of the bespoke fitting material for the rock substrates and the changes in the volume of the gas (i.e., two-thirds of the 30 cc HPHT chamber). The system underwent equilibration once the desired experimental parameters were set within the measurement cell containing the designated brine, n-octane (ranging between 9 μL+2.5 μL), and gas (i.e., pure H₂ or H₂+cushion). Over time, the dynamic and equilibrium IFTs were measured based on standard deviations. Real-time images of the pendant drop are shown in FIG. 3B were captured through the charged coupled device (CCD) camera and subjected to analysis using the Axisymmetric Drop Shape Analysis (ADSA) technique. This technique involved matching the captured drop profile with a theoretical one derived from the Young-Laplace equation to determine the IFT. The IFT, denoted as y, can be calculated using the Eq. (1).

$$γ = \frac{Δρ {gb}^{2}}{β} \qquad ( 1 )$$

where Δρ represents the density difference between the two phases, g is the gravitational acceleration, b indicates the radius of curvature at the drop's apex, and β corresponds to the Bond number, dependent solely on the drop's shape.

A simplified but robust technique was adopted to calculate the density difference of the system, which is necessary to calculate the interfacial tension. Initially, the density of pure H₂ gas and n-octane liquid at the investigated temperature and pressure were retrieved from the National Institute of Standards and Technology (NIST) database. The density of the gas mixture (60% H₂ +30% CH₄+5% CO₂+5% N₂) and brine (2 to 20 wt. %) was adopted from the previous study on CH₄ cushion gas [See: N. S. Muhammed, B. Haq, D. Al Shehri, Role of methane as a cushion gas for hydrogen storage in depleted gas reservoirs, Int. J. Hydrogen Energy. (2023), incorporated herein by reference in its entirety]. Using Eq. (2), IFT for the three-phase system was then computed systematically by accounting for all the independent fluids.

$${γ}_{corr} = [ \frac{( {ρ}_{l} - ρ ( g / gas mixture ) )}{( {ρ}_{{water}_{@ 25 oC , 14.7 psi}} - {ρ}_{{octane}_{@ 25 oC , 14.7 psi}} )} ] \times {γ}_{measured} \qquad ( 2 )$$

Where γ_{corr} (in mN/m) is the corrected IFT and γ_{measured} (in mN/m) is the program IFT results based on the automated image digitization profile. Similarly, ρₗ and ρ_{g} in (kg/m³) represent the densities of the liquid and gas/gas-mixture phases. To account for the contribution of the third phase (which is the n-octane bubble) in the numerator of Eq. (2), both the brine and n-octane were assumed to be in a thermodynamic equilibrium as both phases are considered as a single liquid phase (refer to FIG. 3B). Thus, ρₗ becomes (ρ_{brine,}_{ᵢ}−ρ_{octane}), where ρ_{brine,}_{ᵢ} further represents the density of brine at the respective salinities denoted by subscript i, and ρ_{octane} is the density of n-octane. In the case of the denominator in Eq. (2), the density of

$$pure water = 997.05 \frac{kg}{{m}^{3}} and pure n - octane = 698.57 \frac{kg}{{m}^{3}}$$

at 25° C. and 14.7 psi retrieved from the NIST database were used as reference points. As a result, the new equation for the IFT correction at different NaCl densities based on the unanimous density correction for all the phases becomes:

$${γ}_{corr} = [ \frac{( [ {ρ}_{brine {,}_{i}} - {ρ}_{octane} ] - {ρ}_{( g / gas mixture )} )}{298.48} ] \times {γ}_{measured} \qquad ( 3 )$$

Note that the density difference (Δρ) values utilized in Eq. (3) for the calculation of IFT are documented comprehensively in Tables 3A-3E, Tables 4A-4E, and Tables 5A-5B with provisions for potential future adjustments. If subsequent measurements or models indicate a significant deviation from the currently employed density difference values, the reported interfacial tension values can be adjusted by multiplying them by the ratio of the updated density difference to the one employed in this study.

### Results and Discussion

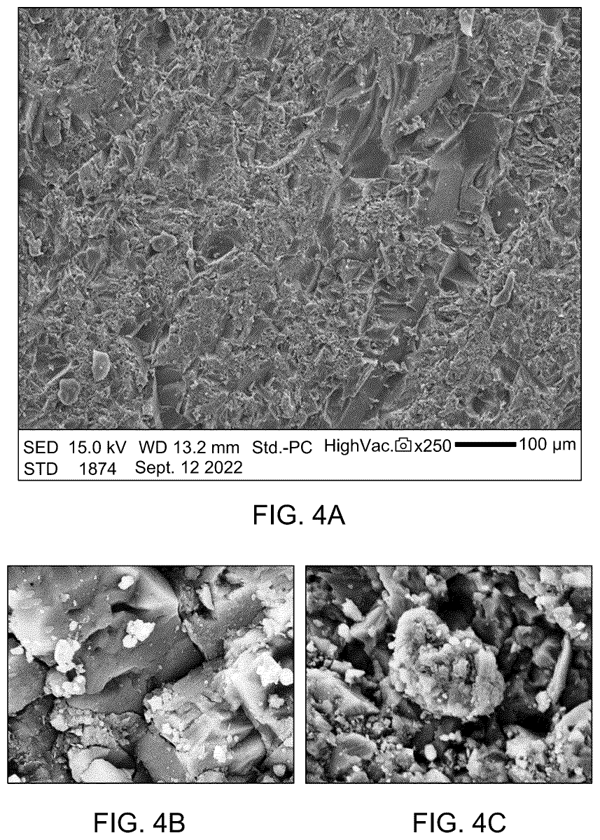

Table 2 reveals that the reservoir rock sample predominantly consists of quartz (100 wt. %), as observed in FIG. 4A. The SEM image typically appears as a crystalline structure. However, the quartz surface exhibited various levels of smoothness, attributed to the capacity of the cleaning device. On the other hand, FIG. 4B and FIG. 4C shows that the SEM images of the WC shale are primarily composed of calcite (98.2 wt. %) with a minor presence of quartz (1.8 wt. %), respectively. This indicates that the shale sample primarily consists of carbonate mineral mudstone. The presence of high calcite and low quartz content in the rock reduces its hydrophilic nature, aligning with findings from previous studies [See: H. N. Sørgård, C. Totland, W. Nerdal, J. G. Seland, Crude Oil Adsorbates on Calcite and Quartz Surfaces Investigated by NMR Spectroscopy, J. Phys. Chem. C. 121 (2017) 20892-20899, incorporated herein by reference in its entirety, H. Al-Mukainah, A. Al-Yaseri, N. Yekeen, J. Al Hamad, M. Mahmoud, Wettability of the shale-brine-H₂ system and H₂-brine interfacial tension for assessment of the sealing capacities of shale formations during underground hydrogen storage, Energy Reports. 8 (2022) 8830-8843, incorporated herein by reference in its entirety]. Additionally, the TOC content of the WC shale is measured as 0.30%. The results obtained from the surface roughness analysis reveal that the quartz sample has a root mean square (RMS) surface roughness of 0.367 mm, while the WC shale exhibits an RMS surface roughness of 0.183 mm. This indicates that the quartz sample has a relatively rough surface compared to the WC shale, despite undergoing a thorough polishing process. Literature indicates that surfaces with a higher degree of roughness generally exhibit greater water-wettability or hydrophilicity. This is attributed to the ability of water to readily enter the surface indentations and remain trapped there.

TABLE 2
Mineralogy and TOC of the material.

| | Mineral | Chemical | Abundance | TOC |
|---|---|---|---|---|
| Substrates type | composition | formula | (%) | (wt. %) |
| Quartz (reservoir rock) | Quartz | SiO₂ | 100% | Nil |
| Wolf camp | Calcite | CaCO₃ | 98.2 | 0.3 |
| shale (caprock) | Quartz | SiO₂ | 1.8 | |

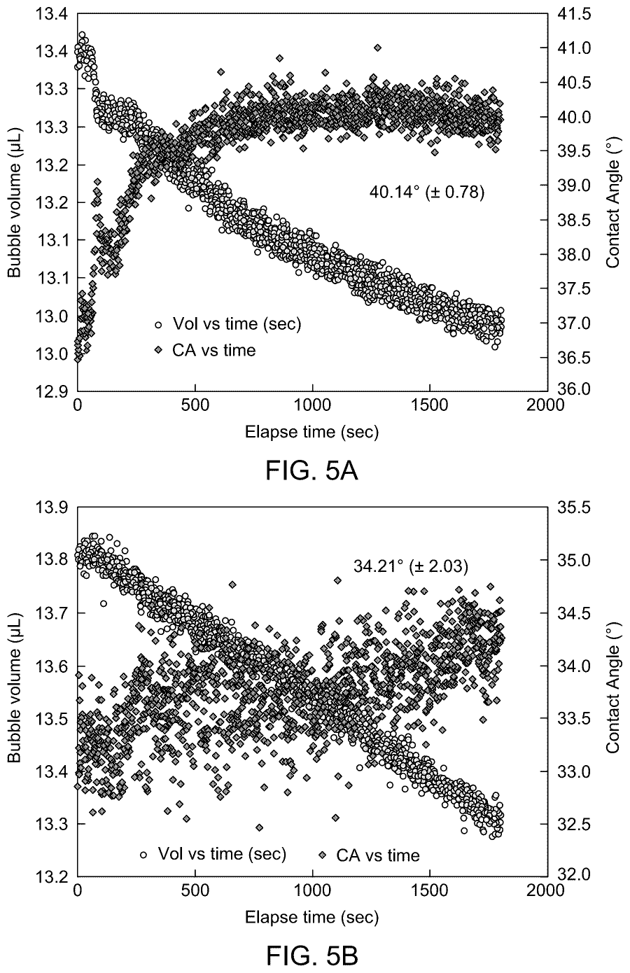

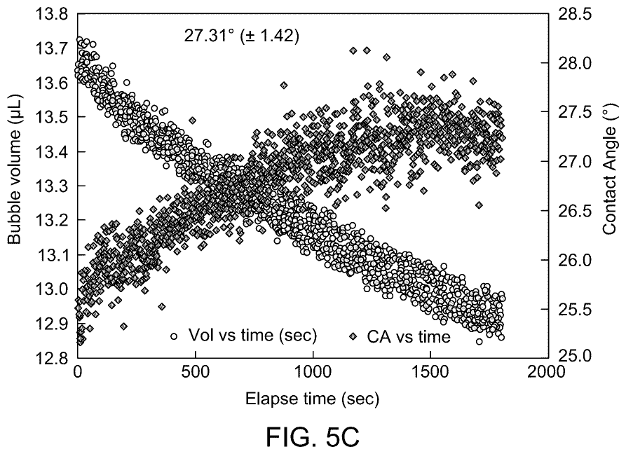

FIGS. 5A-5C shows the effect of bubble size and time on contact angle for ([H₂+cushion]+n-octane)/brine/quartz three-phase system at 30° C., 50° C., and 70° C., respectively. The data set was plotted for 10 wt. % NaCl brine salinity and 2000 psi pressure. As depicted in FIG. 5, the volume of the bubble decreased with time, whereas the CA of the bubble at any given temperature, pressure, and salinity increased with time. Interestingly, it was also noted that as the volume of the n-octane bubble decreases, the CA increases. This behavior could result from dissolved gases in the brine environment. Moreover, this dissolution effect became more significant with time, implying that the n-octane bubble became more saturated; as a result, there was less water wetting to the rock substrates as time increased. This behavior is consistent with two-phase contact angle studies via captive bubble. For instance, the studies on H₂/brine/rock [See: L. Hashemi, W. Glerum, R. Farajzadeh, H. Hajibeygi, Contact angle measurement for hydrogen/brine/sandstone system using captive-bubble method relevant for underground hydrogen storage, Adv. Water Resour. 154 (2021) 103964, incorporated herein by reference in its entirety] and H₂-CH₄/brine/rock [See: L. Hashemi, M. Boon, W. Glerum, R. Farajzadeh, H. Hajibeygi, A comparative study for H₂-CH₄ mixture wettability in sandstone porous rocks relevant to underground hydrogen storage, Adv. Water Resour. 163 (2022), incorporated herein by reference in its entirety] systems observed that the size of the created bubbles gradually diminished due to the dissolution and diffusion of H₂ gas into the brine, eventually leading to their disappearance. Thus, the rock samples were more water-wet at larger bubble sizes (smaller CA) and less water-wet at smaller bubble sizes (higher CA). Their observation was also consistent with CO₂/brine/rock systems [See: N. S. Kaveh, E. S. J. Rudolph, P. van Hemert, W. R. Rossen, K.-H. Wolf, Wettability Evaluation of a CO₂/Water/Bentheimer Sandstone System: Contact Angle, Dissolution, and Bubble Size, Energy & Fuels. 28 (2014) 4002-4020, incorporated herein by reference in its entirety], and [See: F. Haeri, D. Tapriyal, S. Sanguinito, F. Shi, S. J. Fuchs, L. E. Dalton, J. Baltrus, B. Howard, D. Crandall, C. Matranga, A. Goodman, CO 2-Brine Contact Angle Measurements on Navajo, Nugget, Bentheimer, Bandera Brown, Berea, and Mt. Simon Sandstones, Energy & Fuels. 34 (2020) 6085-6100, incorporated herein by reference in its entirety], and [See: J.-W. Jung, J. Wan, Supercritical CO₂ and Ionic Strength Effects on Wettability of Silica Surfaces: Equilibrium Contact Angle Measurements, Energy & Fuels. 26 (2012) 6053-6059, incorporated herein by reference in its entirety].

FIGS. 5A-5C show that the bubble volume range used in this study (12 μL±2.5 μL) was uniform and independent of temperature. This is because, before releasing the n-octane bubble, the system attained the desired temperature to ensure that the data acquisition was uniform across the investigated reservoir conditions. The CA values reported in FIG. 5 represent how all the experimental data were systematically reported with their respective standard deviation based on the data discrepancies. These values were automatically generated by the DSA device, which was void of human intervention. For clarity, occasionally, a bit of n-octane bubble instability was observed at temperatures beyond 50° C. as well as pressures above 2500 psi. As such, such an experiment was repeated to ensure each reported CA value was automated by the device, though at a shorter time before the bubble disappeared.

The influence of reservoir pressure and temperature on the wetting characteristics of liquid-gas systems is of great interest, especially in the presence of a third fluid. Thus, it is reasonable to focus on the relative effects of varying reservoir conditions rather than on the absolute values of CAs. Primarily, the impact of pressure and temperature in this sense is better explained via two critical factors: compressibility and miscibility. First, H₂, CH₄, N₂, and CO₂ are miscible gases which can mix uniformly in any proportion. Additionally, these gases are compressible, meaning their volume can change significantly in response to changes in pressure. On the other hand, n-octane is an incompressible liquid that is miscible with other hydrocarbon compounds and non-polar solvents. This means it can mix and dissolve uniformly in certain substances without separating into distinct phases (based on the conditions under which the mixing occurs).

In the case of the three-phase CA measurements, where the n-octane drop is fully submerged into brine (underlying the rock substrates), the miscibility susceptibility of n-octane becomes insignificant. This is because water is a polar solvent consisting of a positive and a negative end, with the O atom being more electronegative than the H₂ atoms. This polarity allows water molecules to interact with other polar or charged molecules, making it an excellent solvent for many substances. However, n-octane is a hydrocarbon compound that consists of C and H atoms arranged in a nonpolar structure. It lacks the electronegativity differences between elements that create polarity in molecules like water. As a result, n-octane does not have a positive and negative end like polar molecules do, and it does not have strong interactions with polar or charged substances.

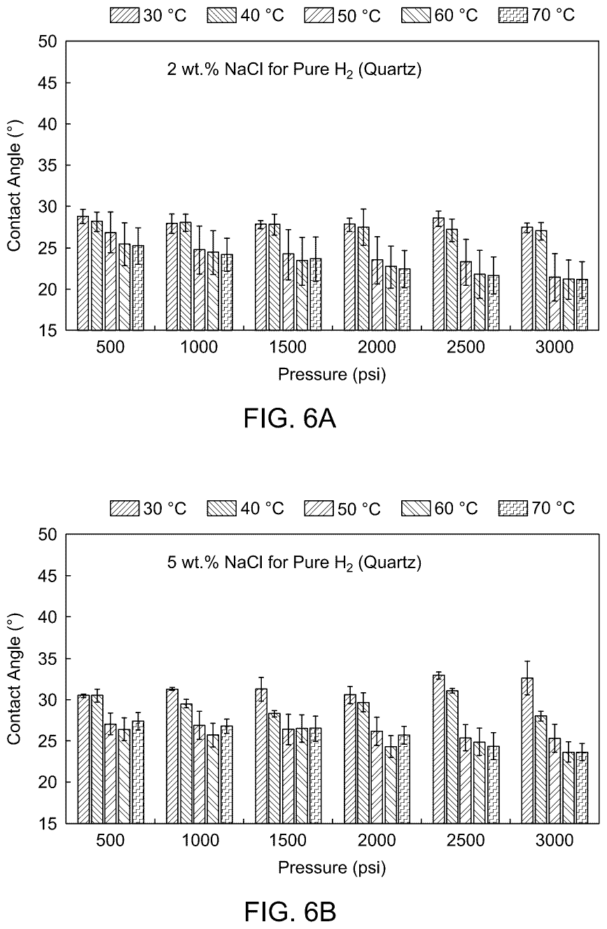

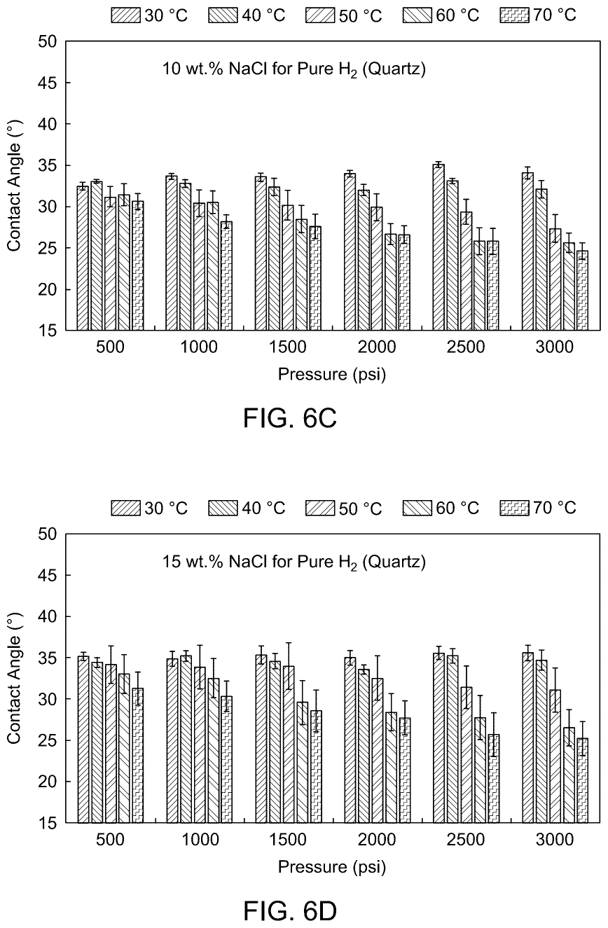

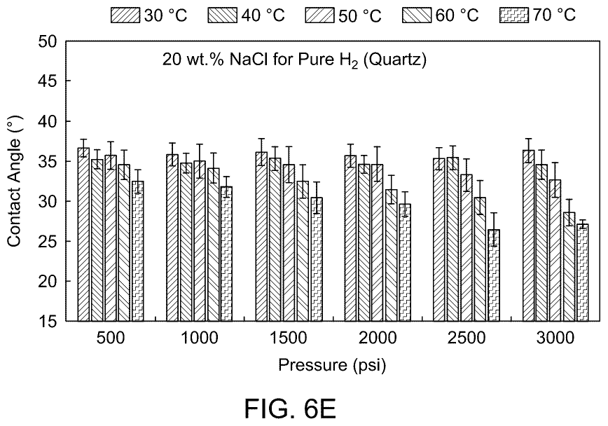

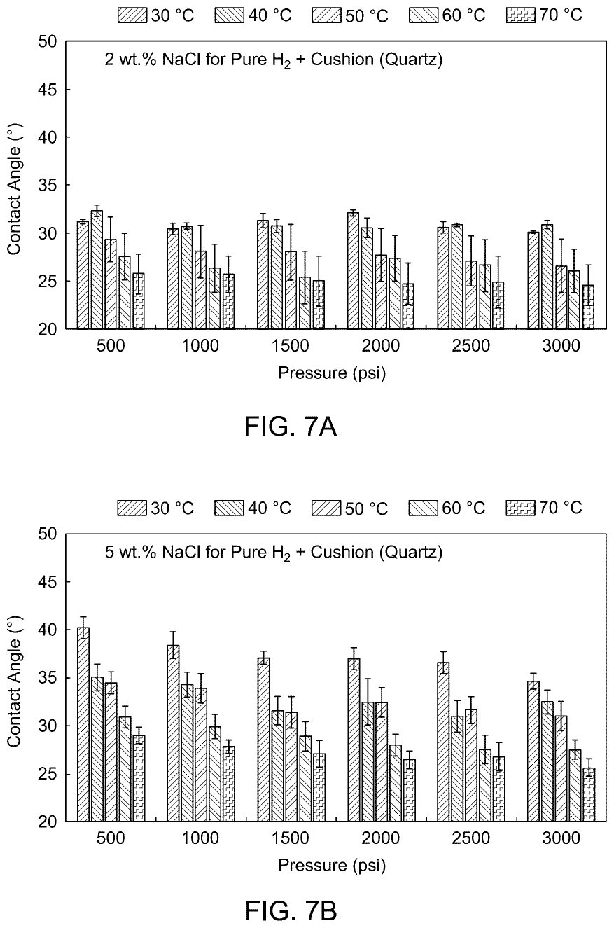

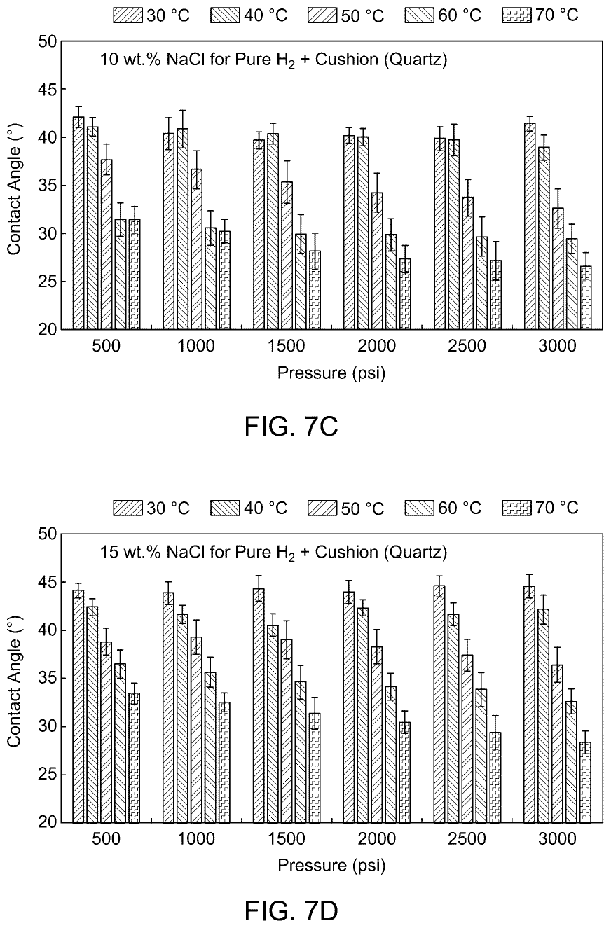

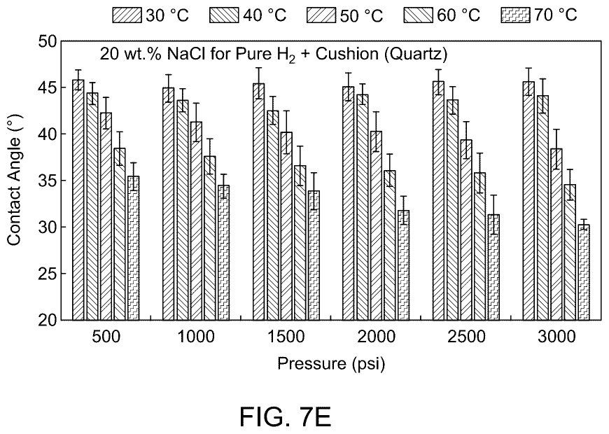

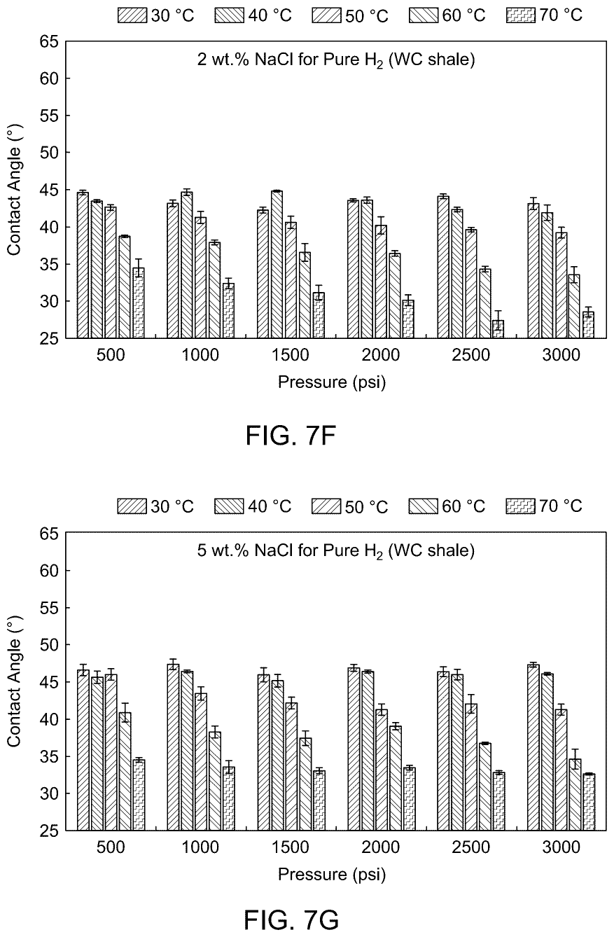

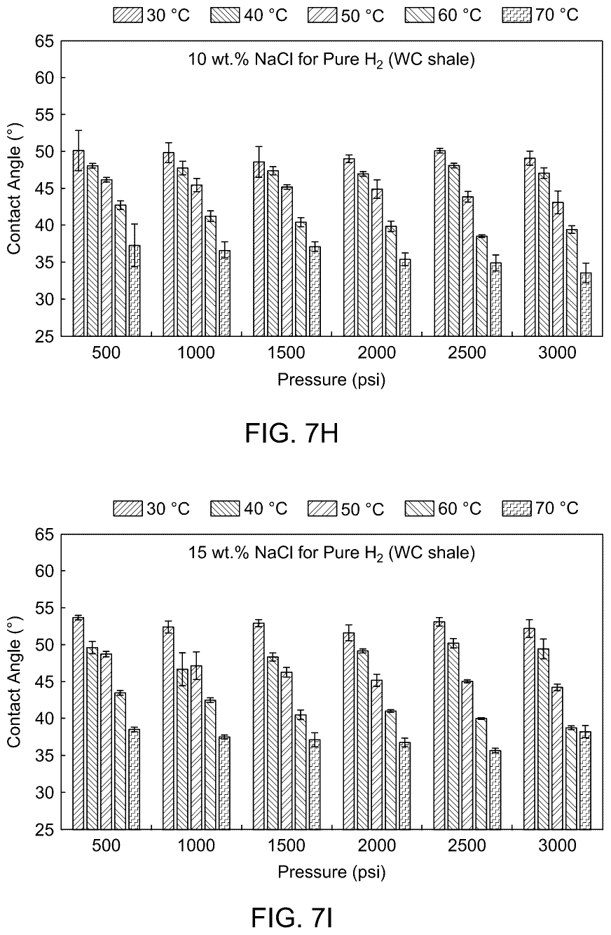

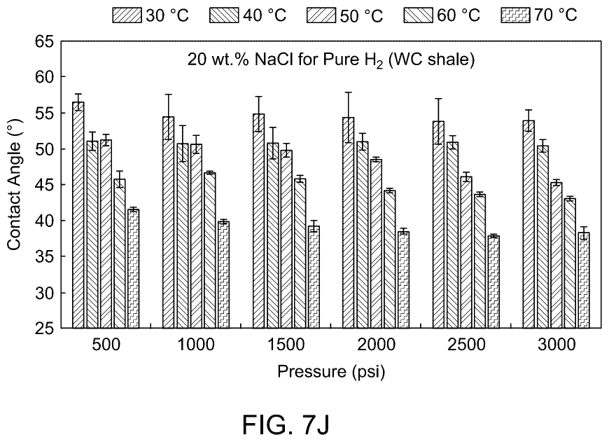

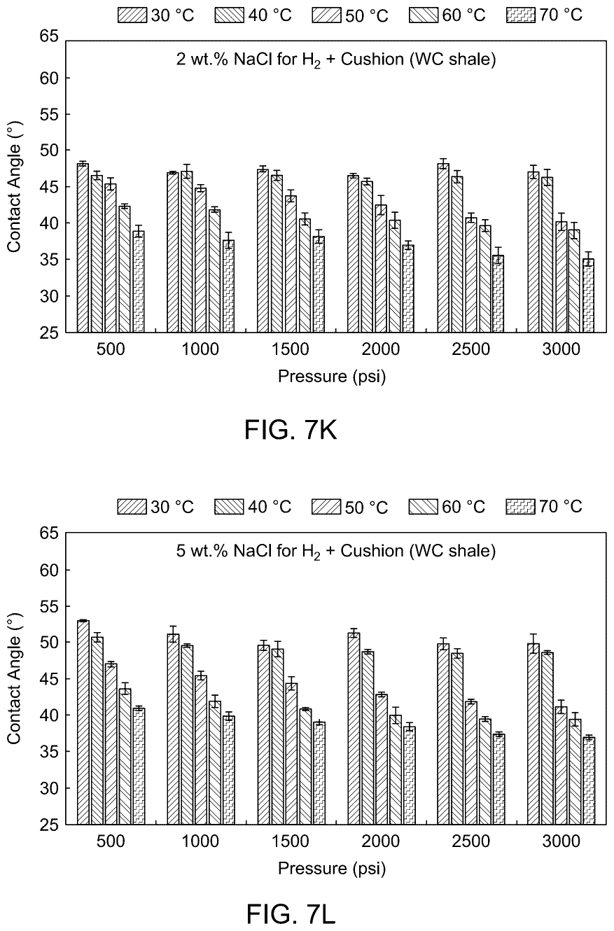

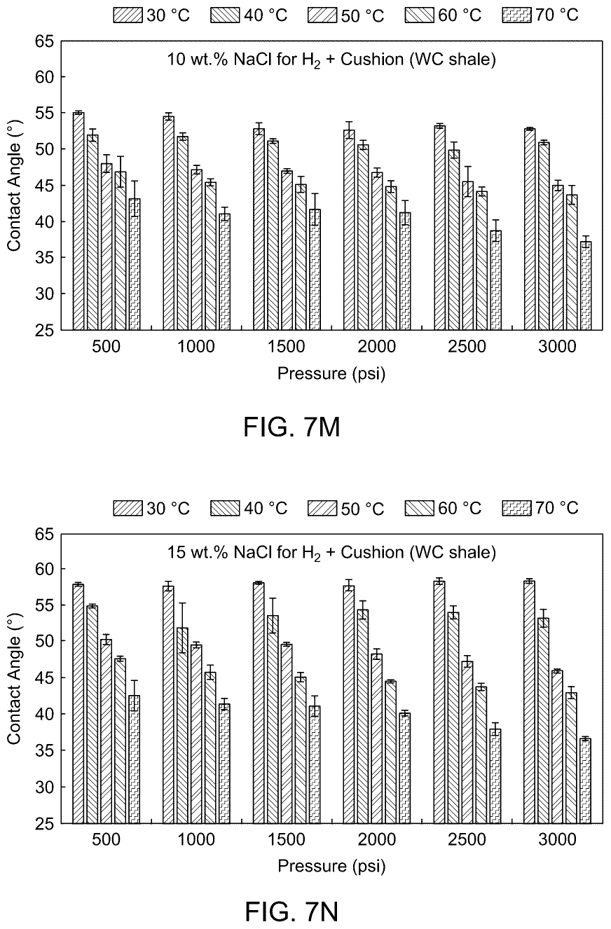

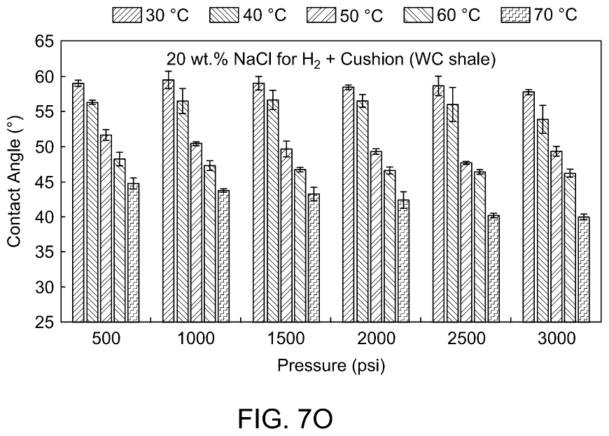

This, therefore, implies that while the pure H₂ and gas mixture (H₂, CH₄, CO₂, and N₂) are compressible and miscible, their impact is likely to be felt more in the HPHT chamber at higher pressure and temperature (as the molecules become more heated), with the n-octane having less impact to their response. Thus, CA for the H₂+brine+octane and (H₂+cushion)+brine+octane was inconsistent with increasing pressure but systematically decreased with increasing temperature across the investigated medium. This behavior can be observed in FIGS. 6A-6E and FIGS. 7A-7E for quartz, as well as FIGS. 7F-7O for WC shale substrates.

To elaborate on this point, 2 wt. % salinity was randomly assumed from both figures, depicting pure H₂ (FIG. 6A) and (H₂+cushion) (FIG. 7A), for quartz, respectively. As shown in FIG. 6A in terms of the pressure behavior, it can be seen that CA at constant 30° C., initially decreased from 28.75°±0.87 (at 500 psi) to 27.76°±0.78 (at 2000 psi), then increased to 28.52°±0.89 (at 2500 psi) before dropping back to 27.42°±0.57 (at 3000 psi). Also, at 70° C., the CA drops from 25.20°±1.21 (at 500 psi) to 22.41°±1.26 (at 2000 psi) and finally to 21.16°±2.19 (at 3000 psi). This trend is closely observed across FIGS. 6B-6E for the different salinities and temperatures. Likewise, FIG. 7A also highlights similar behavior after injecting H₂+cushion. Particularly, CA at constant 2 wt. % in FIG. 7A at a constant temperature of 30° C. also decreased and increased with increasing pressure, as observed in FIGS. 7B-7E. Based on their standard deviation, which is approximately within 5% uncertainty, it can be said that the pressure effect on three-phase CA is insensitive to the system.

This has also been observed in some two-phase gas/brine/systems via captive bubbles where the CA effect was indistinguishable with increasing pressure [See: H. Aghaei, A. Al-Yaseri, A. Toorajipour, B. Shahsavani, N. Yekeen, K. Edlmann, Host-rock and caprock wettability during hydrogen drainage: Implications of hydrogen subsurface storage, Fuel. 351 (2023) 129048., L. Hashemi, W. Glerum, R. Farajzadeh, H. Hajibeygi, Contact angle measurement for hydrogen/brine/sandstone system using captive-bubble method relevant for underground hydrogen storage, Adv. Water Resour. 154 (2021) 103964, incorporated herein by reference in its entirety, L. Hashemi, M. Boon, W. Glerum, R. Farajzadeh, H. Hajibeygi, A comparative study for H₂-CH₄ mixture wettability in sandstone porous rocks relevant to underground hydrogen storage, Adv. Water Resour. 163 (2022), incorporated herein by reference in its entirety]. However, the results show that the CA for the system decreases with increasing temperature at any given pressure and salinity. Thus, injecting H₂ or H₂+cushion in the presence of n-octane will significantly remain trapped in the reservoir pores when the temperature is at the highest. As a result, the wettability of the three-phase system for assessment of the residual (quartz) and structural (WC shale) trapping showed that hotter reservoirs are the most favorable conditions for H₂ storage in depleted gas conditions as the measured CAs were smaller (strongly water-wet). Recent studies have also shown that hotter reservoir rocks and caprocks are favorable conditions for UHS. Notwithstanding, a variation was observed in the measured CA between the rock substrates and the injected gases.

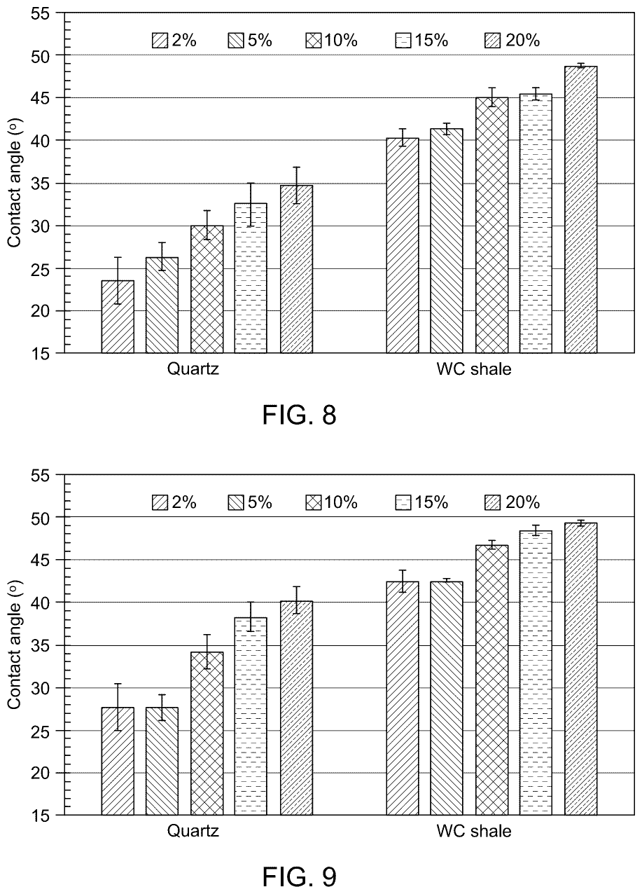

In the context of depleted reservoirs for UHS, it's important to acknowledge the presence of inherent formation brine salinity, which could significantly impact the storage process. To study this impact, brine solutions with varying salinities (2 wt. %, 5 wt. %, 10 wt. %, 15 wt. %, and 20 wt. %) were tested at different temperatures. Herein, the salinity effect for the three-phase system was reported for quartz (reservoir rock), WC shale (caprock) as well as the case of injecting 100% H₂ and 60% H₂+40% cushion at a constant temperature of 50° C. and 2000 psi pressure. The results reveal that changes in CA increased with increasing salinity. This outcome is consistent with two-phase studies reported in the literature for different (gas+brine) [See: M. Hosseini, J. Fahimpour, M. Ali, A. Keshavarz, S. Iglauer, Hydrogen wettability of carbonate formations: Implications for hydrogen geo-storage, J. Colloid Interface Sci. 614 (2022) 256-266, incorporated herein by reference in its entirety, J. Hou, S. Lin, M. Zhang, W. Li, Salinity, temperature and pressure effect on hydrogen wettability of carbonate rocks, Int. J. Hydrogen Energy. 48 (2023) 11303-11311.] or (gas+cushion)+brine [See: N. S. Muhammed, B. Haq, D. Al Shehri, CO₂ rich cushion gas for hydrogen storage in depleted gas reservoirs: Insight on contact angle and surface tension, Int. J. Hydrogen Energy. (2023), incorporated herein by reference in its entirety] systems, respectively. As can be seen in FIG. 8, CA increased with salinity on the substrates. For example, the CA increased from 23.45°±2.87 at 2 wt. % to 34.57°±2.13 at 20 wt. % on the quartz, whereas it increased from 40.20°±1.03 at 2 wt. % to 48.62°±0.26 at 20 wt. % on the WC shale, respectively. This indicates that, in the presence of brine and n-octane, the injection of 100% H₂ on the reservoir rock was more water-wetting (lower CA) than the caprock (higher CA). The wetting behavior of pure H₂ on the rock substrates may increase not only with varying salinity but also with rock type.

FIG. 9 shows the contact angle effect on salinity with respect to Quartz and WC shale when injecting (60% H₂+40% cushion) at 50° C. and 2000 psi. In the case of the (60% H₂+40% cushion) as displayed in FIG. 9, the CA for quartz increased from 27.70°±2.74 at 2 wt. %, to 34.21°±2.03 at 10 wt. % and finally to 40.25°±1.61 at 20 wt. %. Consequently, the CA for the WC shale increased from 42.48°±1.25 at 2 wt. % to 46.73°±0.54 at 10 wt. % before reaching a maximum of 49.28°±0.32 at 20 wt. %. As in the case of pure H₂, the injection of H₂+cushion was less water-wetting in quartz than in shale. This systematic increase of CA with salinity is observed in FIG. 8 and FIG. 9 for 50° C., and 2000 psi are consistent with other data reported in the Tables 3A-3E, Tables 4A-4E, and Tables 5A-5B at similar thermo-physical conditions. Overall, the CA increase with salinity for the without and with cushion implies that the addition of cushion gas makes the substrate surface less water wetting with the n-octane. Furthermore, WC shale had more H₂ and H₂+cushion wetting than the quartz substrates, indicating that residual trapping would be efficient in the reservoir rock.

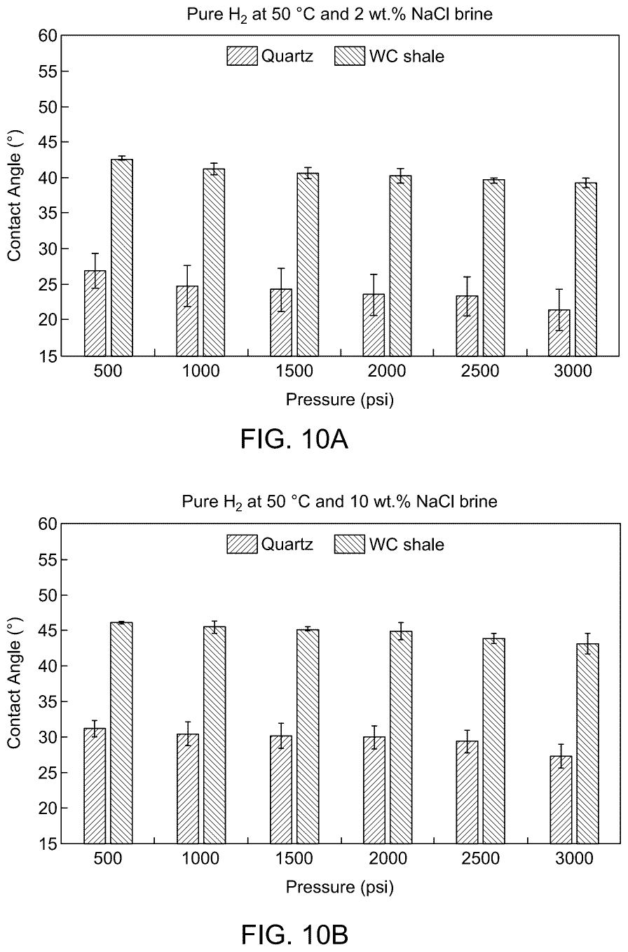

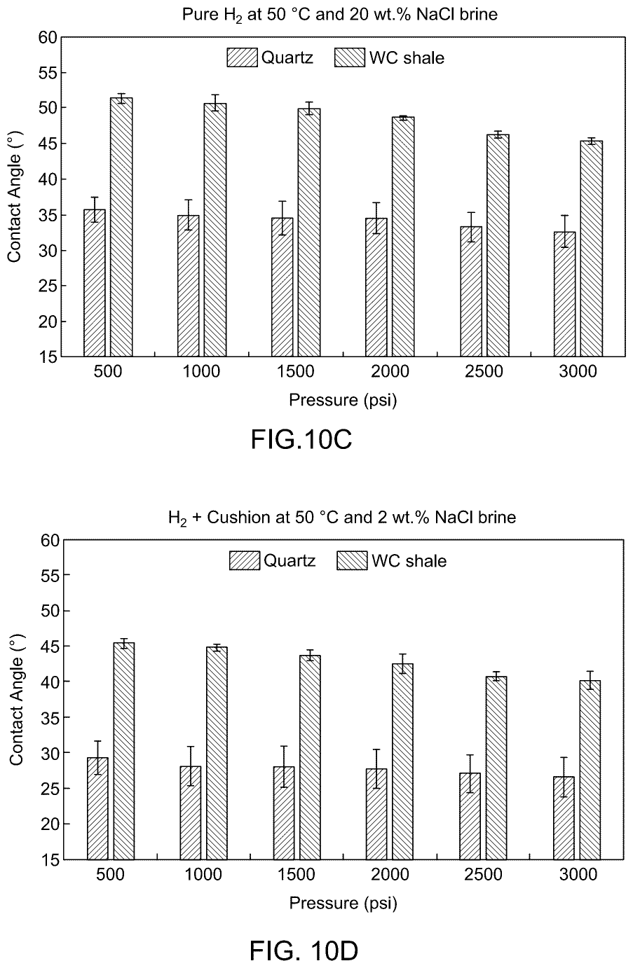

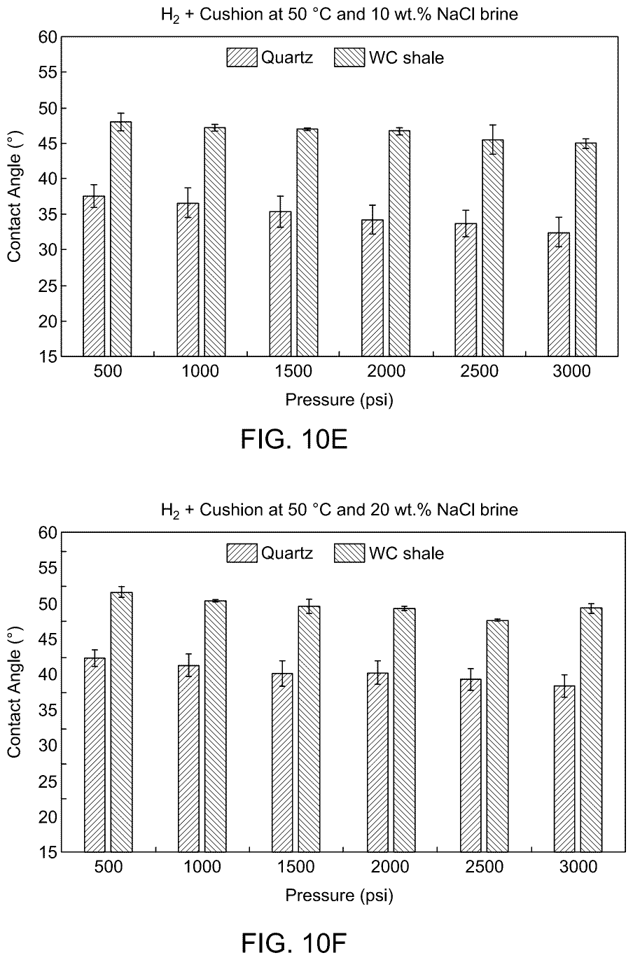

FIGS. 10A-10F shows the effect of rock type on the contact angles of the (H₂+n-octane)/brine/rock and (H₂+cushion+n-octane)/brine/rock three-phase systems, respectively. A clear correlation was found, as the CA for the quartz (reservoir rock) was smaller than those of the WC shale (caprock). The higher CA values recorded by WC shale are due to the presence of calcite minerals, as the tendency of a geological storage medium to remain hydrophilic decreases when there is high calcite and low quartz content. Moreover, surfaces with higher roughness (quartz sample=0.367 mm) generally exhibit greater water-wettability or hydrophilicity. Despite the lower CA by the reservoir rock compared to the caprock, a significant effect was noticed when injecting the gas in the presence or absence of cushion within the studied rock substrates. For example, a closer look at FIG. 10 shows that, for the case of injecting only H₂ in the presence of n-octane submerged in the brine for the quartz sample, CA was generally smaller than when injecting H₂+cushion in the presence of n-octane. This means that the propensity for the injected 100% H₂ to be residually trapped in the reservoir pores becomes higher, whereas the 60% H₂₊₄₀% cushion can be useful for withdrawal. This can be implied as H₂ gas is an entirely non-wetting phase; however, cushion gas is essential to overcome snap-off and H₂ residual trapping to avoid losses during withdrawal. Moreover, the CA of the WC shale, as well as the IFT, will help to estimate the height of the injected gas that can be permanently immobilized beneath the caprock based on its pore size.

The initial measurement of the IFT between water and n-octane (in the absence of any gas) was conducted at a temperature of 25° C. and a pressure of 100 psi to validate the experimental procedures. The obtained measurement yielded an IFT value of 49.34±1.15 mN/m, which exhibited a remarkable consistency with the literature data [See: B. Y. Cai, J. T. Yang, T. M. Guo, Interfacial tension of hydrocarbon+water/brine systems under high pressure, J. Chem. Eng. Data. 41 (1996) 493-496, and T. Al-Sahhaf, A. Elkamel, A. S. Ahmed, A. R. Khan, The influence of temperature, pressure, salinity, and surfactant concentration on the interfacial tension of the n-octane-water system, Chem. Eng. Commun. 192 (2005) 667-684, each incorporated herein by reference in its entirety]. Subsequently, the investigation extended to determining both the dynamic and equilibrium IFTs covering a range of temperatures (30, 40, 50, 60, and 70° C.), and pressures (500 to 3000 psi). Notably, this value is the average IFTs resulting from many experimental data considered at each state point collected after the creation of every drop. Given that, before achieving thermodynamic equilibrium, pure H₂ and (H₂+cushion) molecules continually diffuse into the droplet, thus necessitating a variable n-octane bubble density, as mentioned earlier.

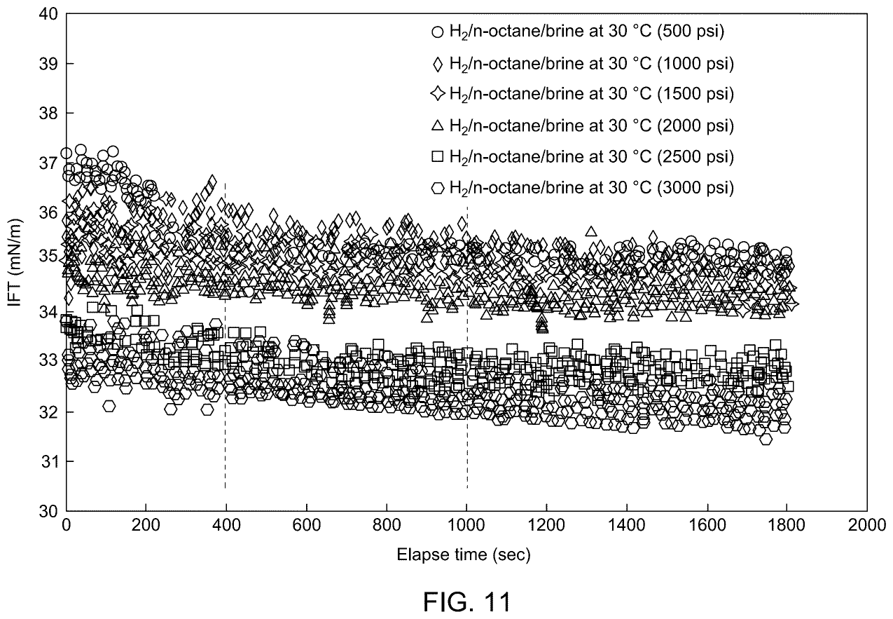

As an illustrative example, the dynamic IFTs at a specific temperature (30° C.), salinity (2 wt. %), and varying pressure (500 to 3000 psi) are presented in FIG. 11. It can be observed that from the initial 400 seconds, there was a transfer of pure H₂ gas that became adsorbed onto the aqueous brine interface and subsequently diffused into the bulk of the n-octane phase. This led to a rapid reduction in the IFT. Following this initial phase, the rate of mass transfer slowed down, leading to a more gradual decline in the IFT. After approximately 1000 seconds, the IFT reached a stable state, indicating the attainment of equilibrium. At this point, the net flux of pure H₂ toward the interface and into the n-octane phase remained stable. This behavior was also observed for the (H₂+cushion)/brine/n-octane system. However, after similar experimental conditions, the equilibrium IFT seemingly became lower than pure H₂/brine/n-octane. This was attributed to a 40% cushion (30% CH₄₊₅% CO₂₊₅% N₂). This observed trend with respect to dynamic IFT changes with time [See: Z. Pan, J. P. M. Trusler, Experimental and modelling study of the interfacial tension of (n-decane+carbon dioxide+water) in the three phase region, Fluid Phase Equilib. 568 (2023) 113760, incorporated herein by reference in its entirety].

To determine the equilibrium IFT at each specific state point, the drop profile was closely monitored for a duration substantial enough to ensure that the IFT reached a steady state. FIG. 11 shows that longer durations were required to achieve equilibrium IFT values at predominantly higher pressure. For instance, at 30° C., the H₂/n-octane/brine IFT became stable before attaining 1000 sec elapse time (see 500 to 2000 psi data points). However, longer timing was imminent for attaining stability at 2500 and 3000 psi pressures. This correlation is consistent with increased solubility of the gas component (pure H₂ and [H₂+cushion]) and increased resistance to interfacial mass transfer under these thermophysical conditions.

The influences of temperature and pressure on IFT are best studied using single and pure binary systems such as CO₂/brine, CH₄/brine, N₂/brine, and H₂/brine. These systems are appropriate to show the principal differences between completely non-polar gases (e.g., H₂, CH₄, N₂) and gases that contain dipole or quadrupole moments like CO₂. The complications arise when the gases are mixed with, for example, CO₂-CH₄/brine, CO₂-N₂/brine, CO₂-H₂/brine, CH₄-H₂/brine, N₂-H₂/brine, and even more complicated when ternary or quaternary mixtures are involved.

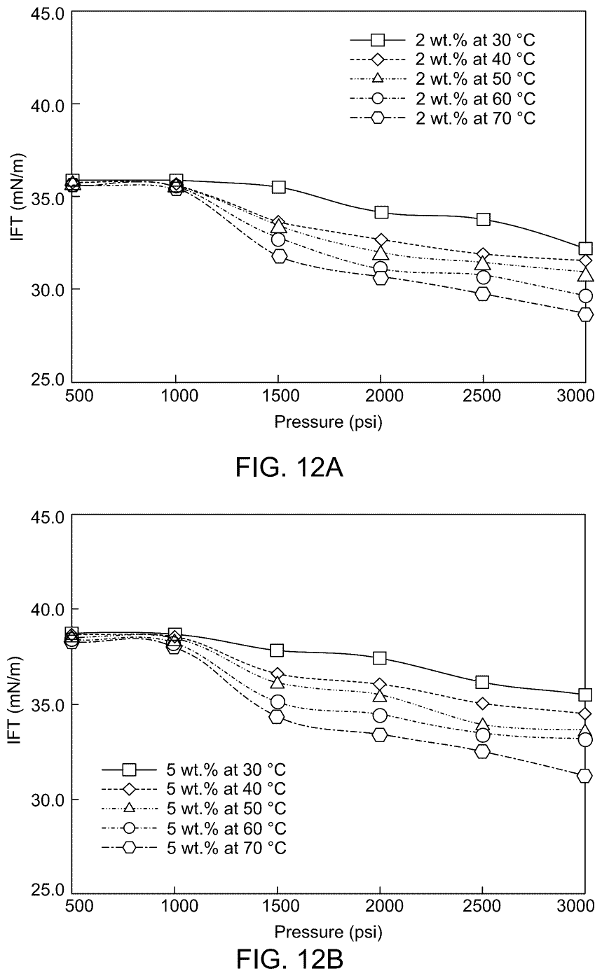

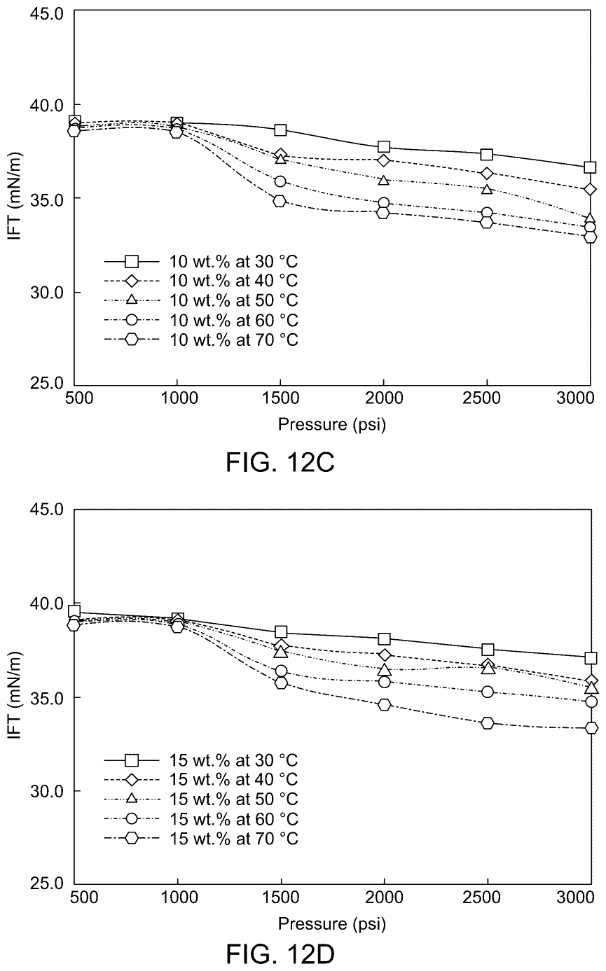

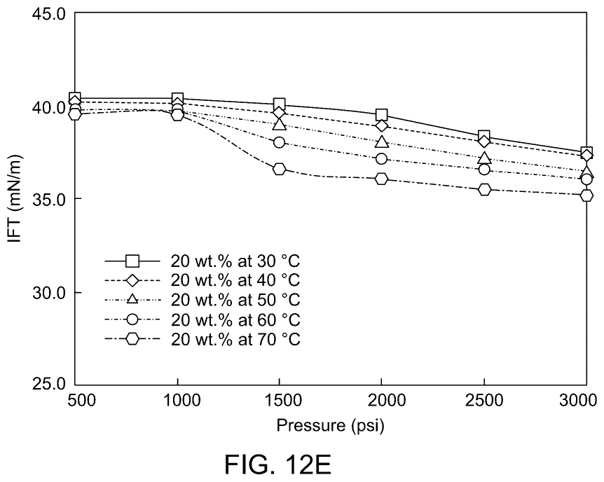

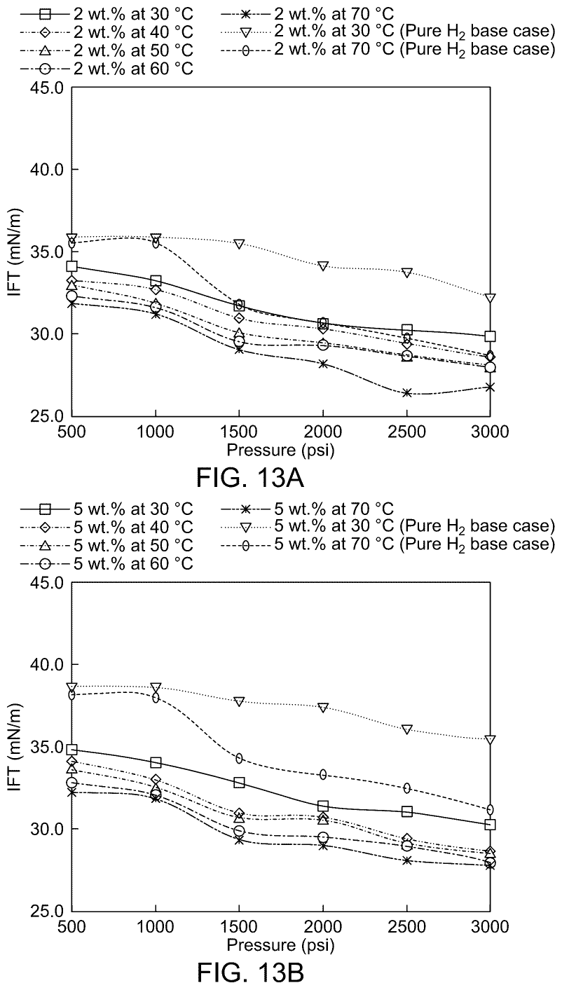

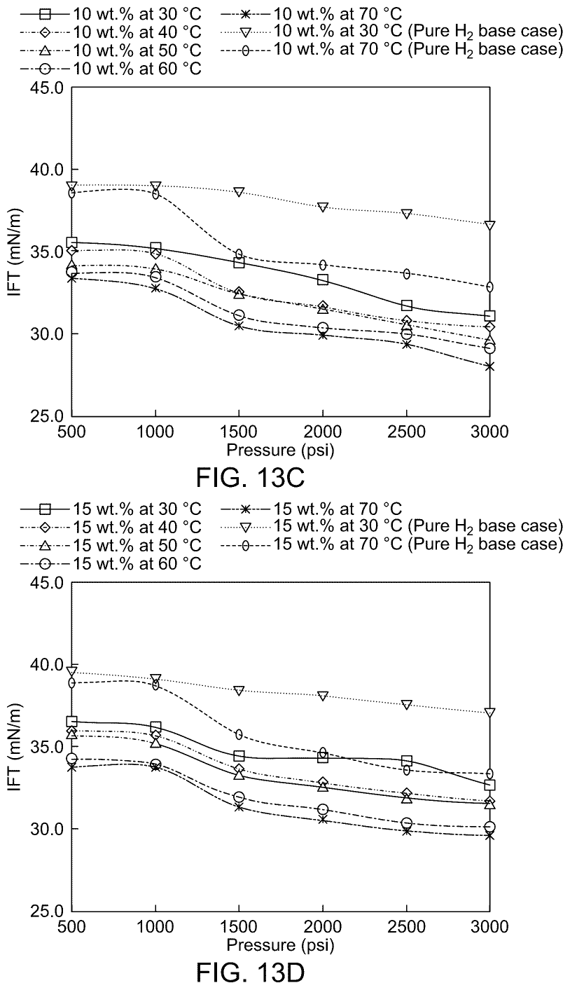

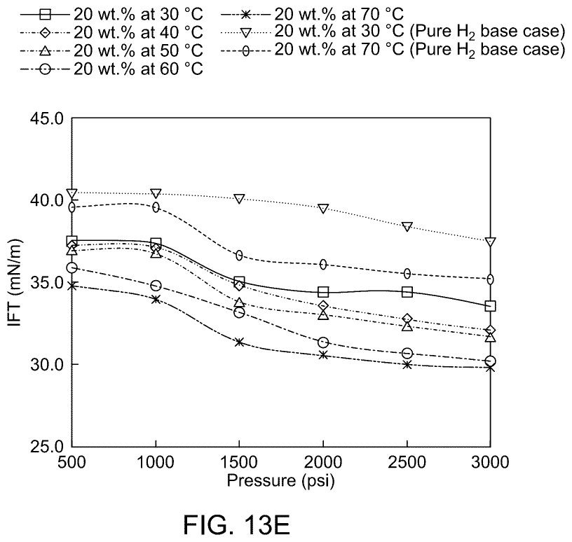

In FIGS. 12A-12E and FIGS. 13A-13E, it is evident that the equilibrium IFTs exhibit a decreasing trend with increasing pressure and temperature consistent with two-phase systems. Notably, between 500 and 1000 psi pressures in FIGS. 12A-12E, there is some stability in equilibrium IFTs at each temperature, while at high pressures (beyond 1000 psi), the equilibrium

IFTs showed a significant decrease. This behavior can be attributed to the dissolution rate of the gas over time. At lower pressures, the limited solubility of H₂ in the liquid (brine phase) results in a passive influence of the gas. Alternatively, at higher pressures, an increased dissolution of H₂ amplifies its impact on IFT. Interestingly, the studies also observed that the measured IFTs for 100% H₂/brine/n-octane were much higher than those of 60% H₂+40% cushion displayed in FIGS. 13A-13E, implying that the cushion gas significantly impacts the interfacial forces between the fluids in the reservoir. However, the result of similar IFT values at isobar ranges of 500 and 1000 psi was not observed. The clear reason behind this observation is not known yet. However, it is thought that the 40% cushion, which includes 30% CH₄₊₅% CO₂ and 5% N₂, may have impacted the purity of the gas, as their combined dissolution effect may have led to such a decrease.

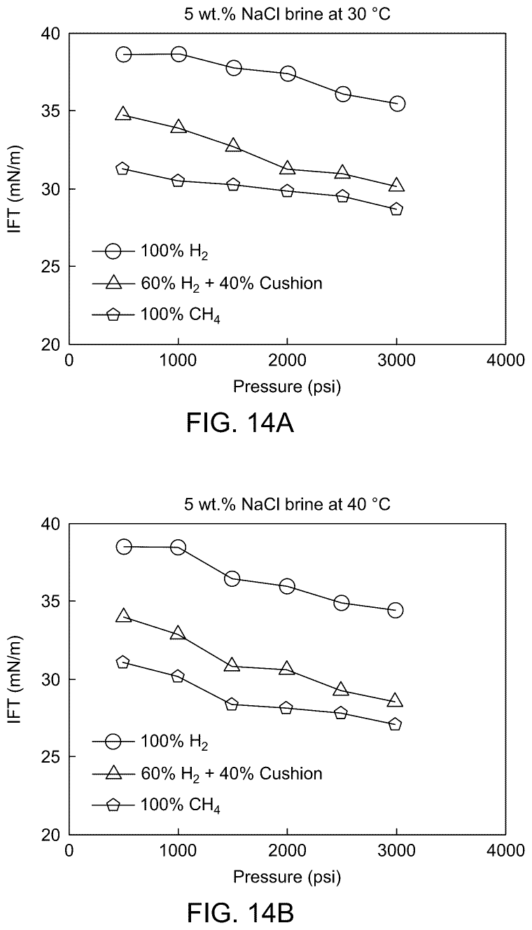

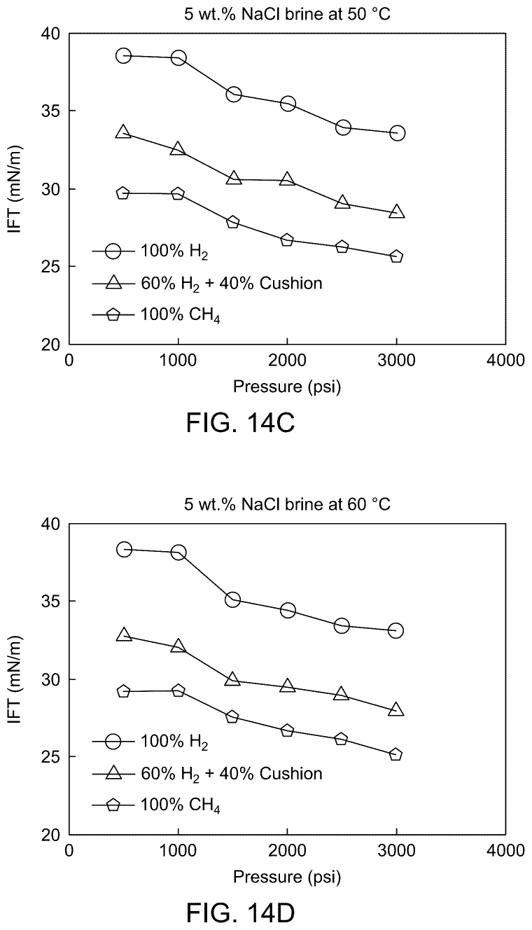

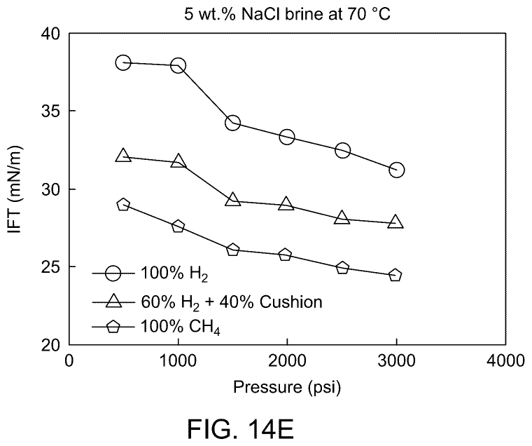

To effectively delineate the impact of increasing the CH₄ fraction, the IFT of (n-octane/brine) was measured in the presence of 100% CH₄. Herein, the density of pure CH₄ and n-octane were retrieved from the NIST database, whereas the 5 wt. % NaCl brine density was taken from the previous study on CH₄ two-phase cushion gas. Note that 5 wt. % salinity was assumed as gas fields generally have low salinity, as seen in the RAG Austria report on the Sun storage pilot project. Accordingly, the previously derived Eq. (3) was utilized to calculate the corrected IFTs. It can be seen from FIGS. 14A-14E that for every isobar and isotherm, IFT for pure H₂ were higher than those of their mixture, which was also higher than those of pure CH₄, implying that increasing CH₄ fraction (at constant 5% CO₂ and 5% N₂) will continually lead to a lower IFTs.

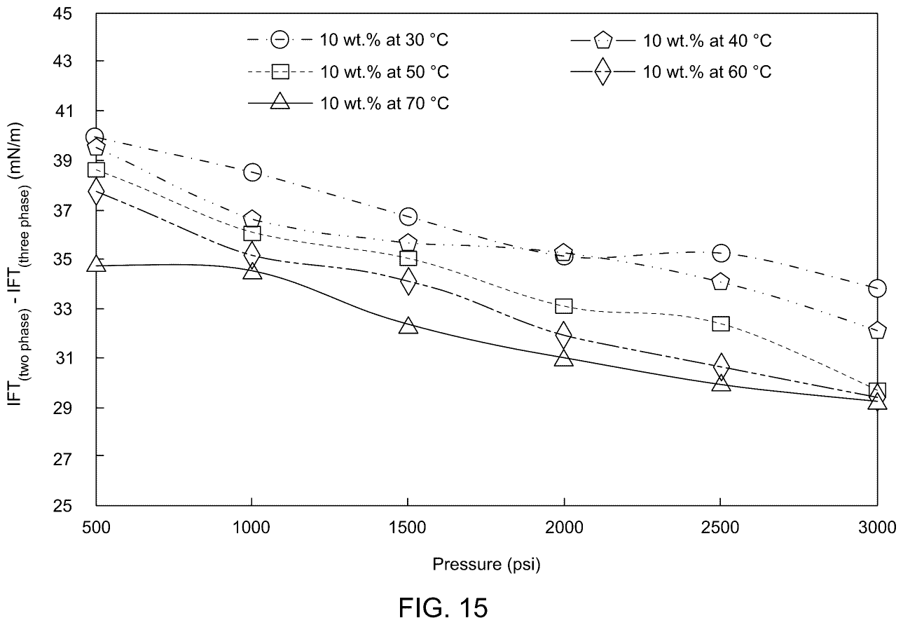

Additionally, it has been observed that within the (gas+brine+n-octane) three-phase system, the IFTs are consistently lower than those of the (gas+brine) two-phase system from the previous study under similar conditions [See: N. S. Muhammed, B. Haq, D. Al Shehri, Role of methane as a cushion gas for hydrogen storage in depleted gas reservoirs, Int. J. Hydrogen Energy. (2023)]. (FIG. 15 shows the difference between two-phase and three-phase systems and highlighting almost 50% reduction in IFT by introducing n-octane). This phenomenon aligns with previous findings for CO₂ and H₂ gases. For instance, Yang and coworkers [See: D. Yang, P. Tontiwachwuthikul, Y. Gu, Interfacial tensions of the crude oil+reservoir brine+CO₂ systems at pressures up to 31 MPa and temperatures of 27° C. and 58° C., J. Chem. Eng. Data. 50 (2005) 1242-1249] report that the equilibrium IFT of the (crude oil+brine+CO₂) system is reduced in comparison with that of the (crude oil+brine) system. Similarly, Pan and coworkers [See: Z. Pan, J. P. M. Trusler, Experimental and modelling study of the interfacial tension of (n-decane+carbon dioxide+water) in the three phase region, Fluid Phase Equilib. 568 (2023) 113760] also noted that the equilibrium IFT of the ternary (decane+CO₂+H₂O) system was much lower than those of the binary (decane+H₂O) system at any given temperature and pressure. More recently, Yang and coworkers [See: Y. Yang, J. Wan, J. Li, G. Zhao, X. Shang, Molecular modeling of interfacial properties of the hydrogen+water+decane mixture in three-phase equilibrium, (2023)] provided deeper insight into the IFTs between the three phases encountered (H₂+H₂O+decane): the H₂—H₂O, the H₂-decane, and the H₂O-decane. Specifically, it was demonstrated that IFTs of the H₂—H₂O interface in the (H₂+H₂O+decane) three-phase mixture were smaller than IFTs in the H₂+H₂O two-phase mixture, which they attributed to the adsorption of decane on the interface. Similarly, H₂ accumulates at the interface between H₂O and decane in the three-phase systems. This leads to a comparatively milder increase in IFT as pressure rises, unlike the IFTs observed in the two-phase mixture of (H₂O+decane). Lastly, the IFTs at the (H₂-decane) interface were minimally influenced by the presence of H₂O, mainly due to the limited amount of water dissolved in the bulk phases. Nonetheless, there was a noticeable and positive enrichments of H₂O in the interfacial region between (H₂-decane).

From a chemistry point of view and the result obtained here, it can be said that IFT reduction was more pronounced at high pressure. The decrease in IFT can be attributed, at least in part, to the solubility of the gas in the liquid phases as well as the phase and thermodynamic changes. In the case of pressure, the solubility of H₂ increases with increasing pressure. This is solely attributed to the fact that increasing pressure causes more gas molecules to be forced into the liquid, thereby increasing the concentration of the dissolved gas in the liquid. Thus, as pressure increases, a higher amount of pure H₂ or (H₂+cushion) dissolves in the liquid phase, which becomes adsorbed at the n-octane interface, resulting in a more pronounced IFT reduction.

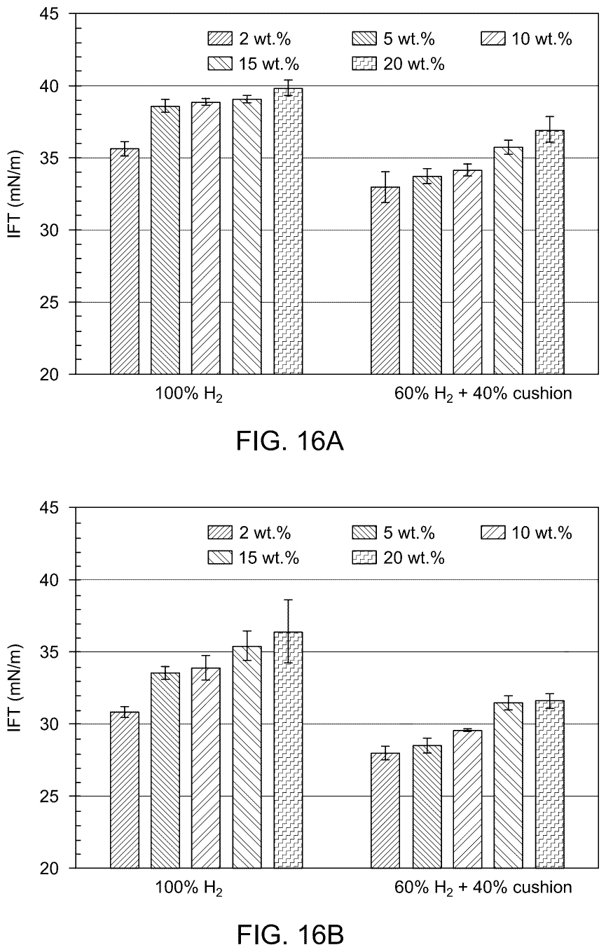

FIGS. 16A-16B explains the effect of salinity between the H₂/n-octane/brine and (H₂+cushion)/n-octane/brine systems, respectively. For clarity, the result of the salinity effect has been presented at a constant temperature of 50° C. and pressure of 500 psi in FIG. 16A and 3000 psi in FIG. 16B. The IFT for H₂/brine/n-octane and (H₂+cushion)/brine/n-octane systematically increased with salinity consistent with most two-phase systems. For example, at 500 psi, the IFT for 100 H₂ increased from 35.66 mN/m±0.48 at 2 wt. % to 39.87 mN/m±0.55 at 20 wt. %, whereas it increased from 32.97 mN/m±1.08 at 2 wt. % to 36.97 mN/m±0.86 at 20 wt. % when 60% H₂+40% cushion was injected. After increasing the pressure to 3000 psi at the same temperature of 50° C., the IFT for 100 H₂ then increased from 30.91 mN/m±0.35 at 2 wt. % to 36.52 mN/m±2.17 at 20 wt. %. Alternatively, it increased from 28.07 mN/m±0.48 at 2 wt. % to 31.69 mN/m±0.52 at 20 wt. % in the case of 60% H₂+40% cushion. Each reported case herein indicates that introducing a cushion can reduce the interfacial forces between the interfaces, which is considered promising for withdrawal scenarios. Furthermore, while IFT increases with salinity, it was also observed that it decreases with increasing pressure.

This behavior is attributed to the effect of the salting out mechanism based on solubility. This is because the NaCl salt in the water may decrease the solubility proportional to the salt concentration until the solution is saturated. Hence, the reduction in solubility with increasing salinity will lead to an increase in IFT. An inverse relationship exists between solubility and IFT concerning increasing salinity. This implies that as the solubility of H₂ or (H₂+cushion) gas in the liquid phase increases, the IFT between the gas and the liquid phase tends to decrease. This observation is well consistent in the study as IFT increased in the order: 2 wt. %<5 wt. %<10 wt. %<15 wt. %<20 wt. % whereas, the solubility decreased in the order: 2 wt. %>5 wt. %>10 wt. %>15 wt. %>20 wt. %. Alternatively, it can be said to be the result of the solute depletion at the interphase between the gas and brine as well as the brine and n-octane. For instance, structure-making ions such as cations (present in the NaCl salt) tend to be expelled from the interphase, whereas structure-breaking anions (in the salts) accumulate at the interphase. The accumulated anions at the interphase lead to the reduction in solubility with increasing salt concentration because less amount of gas can be dissolved into the brine phase. This mechanism technically leads to the increase in the density of the aqueous phase, resulting in more attraction of water molecules towards the solution. Consequently, the IFT increases since more work is required to expand the interface.

Assessing a caprock's sealing efficiency involves an examination of capillary properties at the interface between the brine (and fluids) within the formation caprock and the injected gas. Thus, the quantification of gas storage capacity relies on achieving equilibrium between capillary and buoyancy forces. More precisely, the pressure from buoyancy (P_{b}) exerted by the H₂ or (H₂+cushion) plume (as per Eq. (4)) must be counteracted by capillary pressure (P_{c}) (as per Eq. (5)). By equating P_{b} to P_{c}, the column height (h) of the injected gas can be predicted that can be permanently trapped beneath the caprock, as described in Eq. (6).

$${P}_{b} = Δρ gh \qquad ( 4 )$$

$${P}_{c} = \frac{2 γcos θ}{r} \qquad ( 5 )$$

$${h}_{seal} = \frac{2 γ Cos θ}{g Δρ {r}_{seal}} \qquad ( 6 )$$

Where Δρ is the density difference (kg/m³) between the brine and gas, g=9.81 (m²/s) is the gravitational constant, and r=50 nm is the average pore radius of the caprock which assumes that the rock pore can be modeled as cylindrical capillary tubes. γ is the IFT between H₂/brine/octane and (H₂+cushion)/brine/octane, θ is the measured contact angle for the WC shale caprock, and hₛₑₐₗ represents the maximum H₂ column height permanently immobilized beneath the caprock.

Recent studies in the field of UHS have utilized Eq. (6) without incorporating the capillary effects arising from both the reservoir and seal rock. This omission becomes evident when considering carbon geo-storage, as demonstrated by Thanasaksukthawee and coworkers [See: V. Thanasaksukthawee, N. Santha, S. Saenton, N. Tippayawong, P. Jaroonpattanapong, J. Foroozesh, S. Tangparitkul, Relative CO₂ Column Height for CO₂ Geological Storage: A Non-Negligible Contribution from Reservoir Rock Characteristics, Energy and Fuels. 36 (2022) 3727-3736], highlighting the importance of comprehensively evaluating structural trapping mechanisms. Hence, Eq. (7) can be used to account for this difference as it justifies the natural accumulations of gases beneath the subsurface since it balances the relative capillary contribution from both seal and reservoir rocks (r=2 μm for the reservoir rock was assumed).

$${h}_{seal - reservoir} = \frac{2 γ Cos θ}{g Δρ} \times ( \frac{1}{{r}_{seal}} - \frac{1}{{r}_{reservoir}} ) \qquad ( 7 )$$

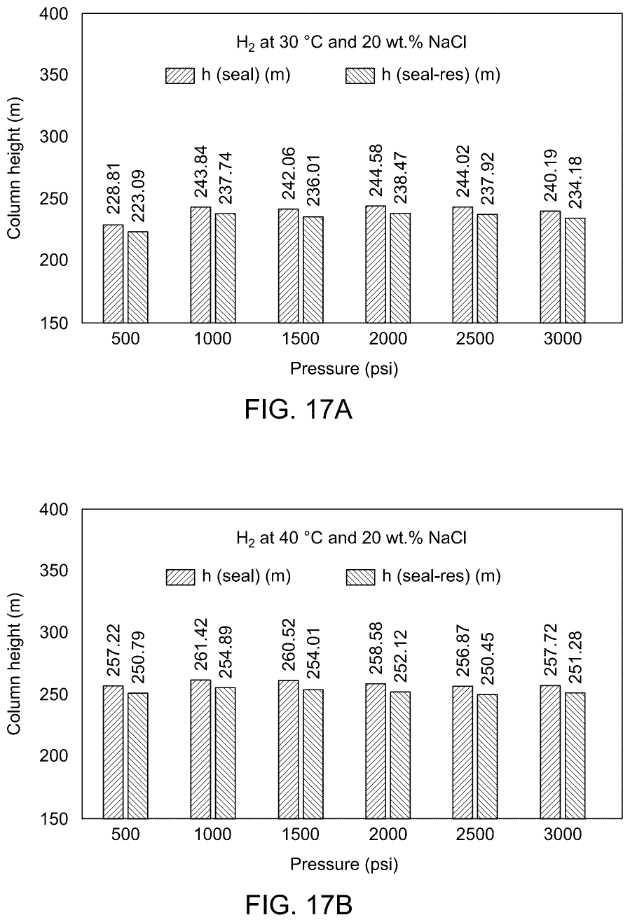

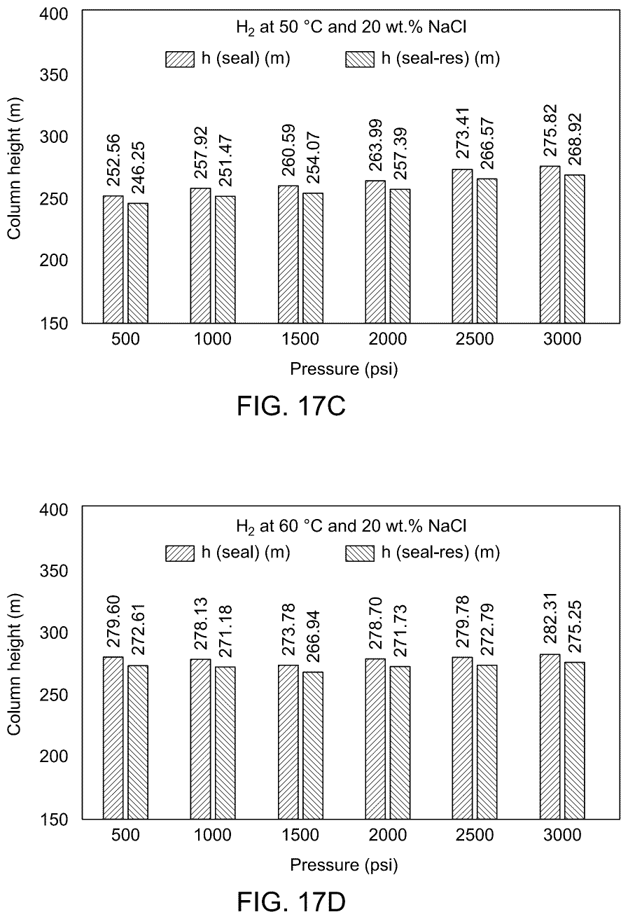

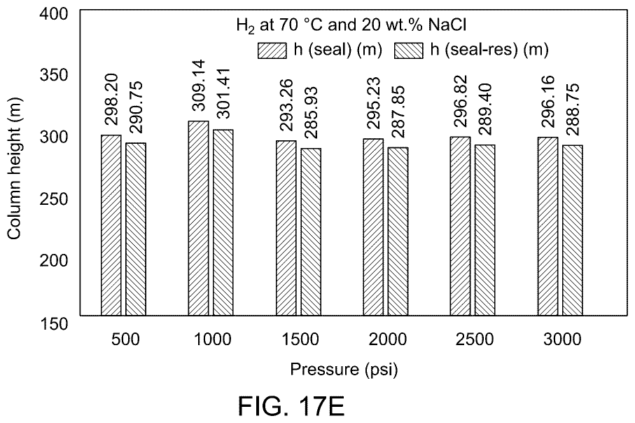

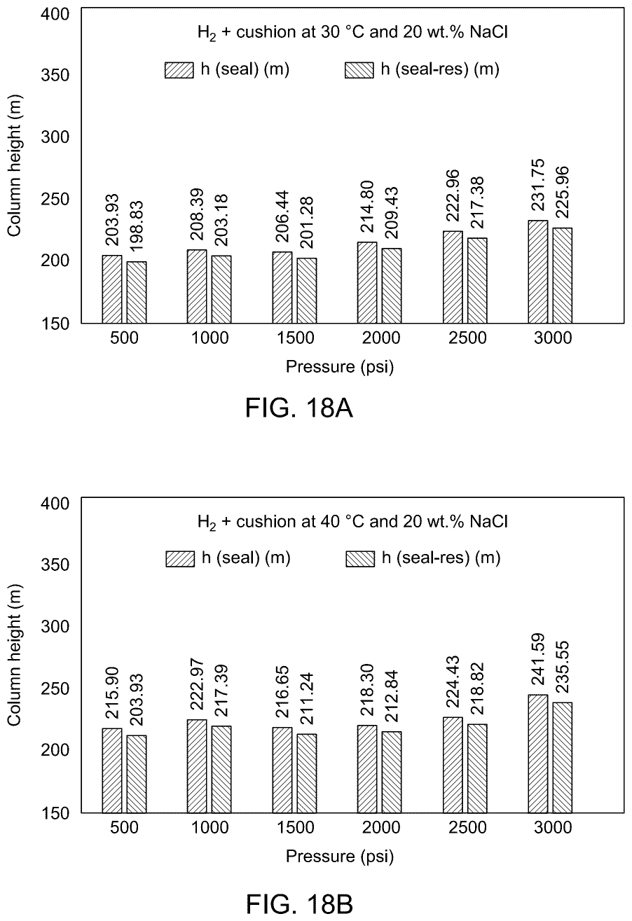

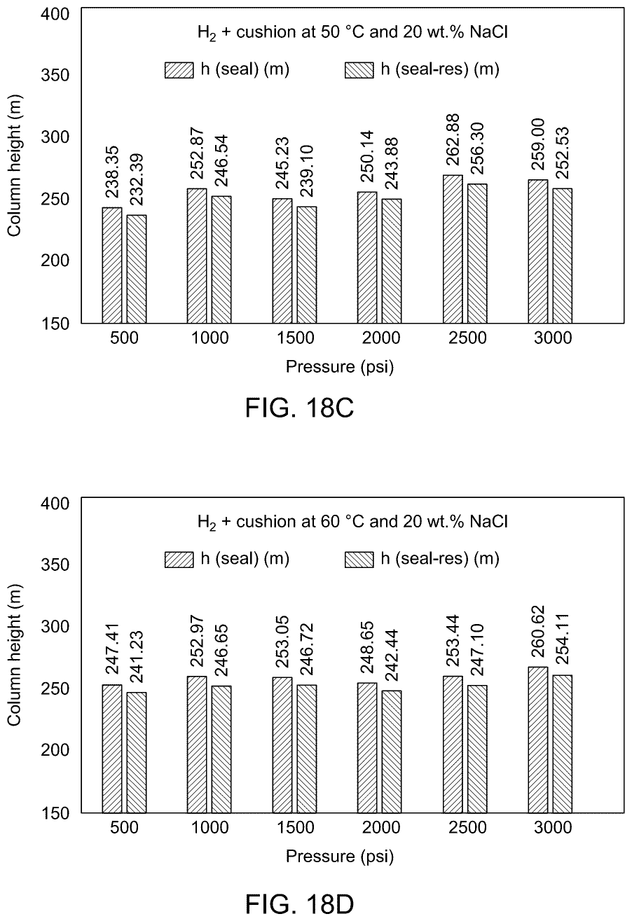

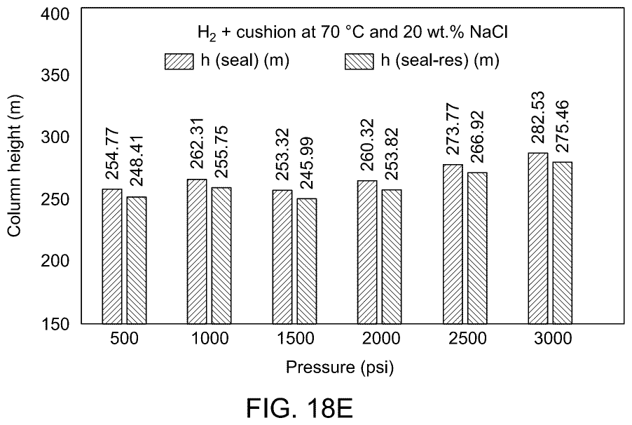

FIGS. 17A-17E shows calculated maximum H₂ column heights of the WC shale for 100% H₂/n-octane/brine three-phase system while FIGS. 18A-18E shows calculated maximum H₂ column heights of the WC shale for (60% H₂+40% cushion)/n-octane/brine three-phase system for different pressures (500 to 3000 psi), temperatures (30 to 70° C.), and 20 wt. % constant NaCl salinity. It can be seen that a variation between column heights for the 100% H₂ and the 60% H_{2 +40}% cushion gas existed. Particularly, the hₛₑₐₗ for 100% H₂ in FIG. 17 was found to be higher than the hₛₑₐₗ₋ᵣₑₛₑᵣᵥₒᵢᵣ for 100% H₂. Consequently, hₛₑₐₗ for 60% H₂+40% cushion in FIG. 18 were also higher than hₛₑₐₗ₋ᵣₑₛₑᵣᵥₒᵢᵣ for 60% H₂+40% cushion, indicating the significance of reservoir pore characteristics. This, therefore, accounts for the fair column heights estimate in the subsurface with the presence of n-octane hydrocarbon fluid. By comparing FIGS. 17 and 18, it can be seen that, at any given reservoir condition (pressure, temperature, and salinity), the estimated column heights for pure 100% H₂ where greater than those of 60% H₂+40% cushion. This observation is largely attributed to the measured CA and IFT (a function of density difference) results from the experimental study.

The CA for H₂/brine/n-octane for the WC shale was lower than those of (H₂+cushion)/brine/n-octane three-phase system (see e.g. FIGS. 7F-70). This implies that the structural trapping capacity will be higher as the injection of 100% H₂ will cause the gas bubbles to occupy the larger pore cluster due to their higher capillary entry pressure than those of H₂+cushion. As a result, during withdrawal cycles, the relatively high CA observed in the case of 60% H₂+40% cushion and the lower IFTs will help promote gas extraction.

A further implication of the estimated column heights is that it provides a faster means of theoretically estimating H₂ storage potential in the presence of other hydrocarbon fluids based on contact angle and IFT experiments, which can be easily conducted across laboratories. Hence, once these parameters are measured on a real-time sample from any potential geological formation, and the potential gas-field data such as porosity, areal extent, and connate water saturation (just to mention a few) are known, its hydrogen storage capacity can be theoretically estimated while accounting for possible over or underestimation from the underlying reservoir rock pores.

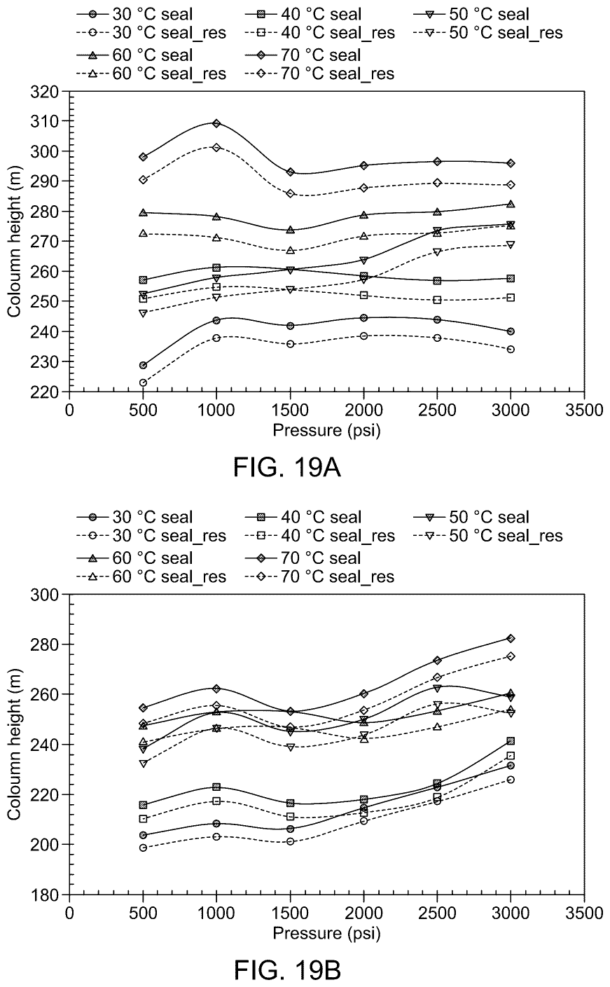

FIGS. 19A-19B shows the effect of temperature on the plotted column heights from FIGS. 17A-17E and FIGS. 18A-18E at constant reservoir salinity of 20 wt. %. The observation reported herein is uniform to the other reservoir salinities. Overall, column height increased with temperature, indicating that more of the injected H₂ or (H₂+cushion) gas plumes will be contained by the Wolf Camp shale caprock at elevated temperatures. This can be adduced to the lower contact angle and higher IFT result experimentally measured. Assuming a constant pressure of 500 psi, it can be seen that the estimated column height in terms of capillary seal (hₛₑₐₗ) contribution in FIG. 19A increased from 228 m (at 30° C.) to 252 m (at 50° C.) and 298 m (at 70° C.) when pure H₂ gas was injected. Alternatively, when the capillary contribution combines the reservoir and caprock, hₛₑₐₗ-reservoir for pure H₂ injection, it increased from 223 m (at 30° C.) to 246 m (at 50° C.) and 290 m (at 70° C.). A difference of 5 m (at 30° C.), 6 m (at 50° C., and 8 m (at 70° C.) was observed between the calculated column heights with increasing temperature for pure H₂ injection.

In the case of injecting H₂+cushion in FIG. 19B and with the similar assumption of 500 psi pressure, the projected column height concerning the capillary seal (hₛₑₐₗ) contribution rose from 203 m (at 30° C.) to 238 m (at 50° C.) and further to 254 m (at 70° C.). On the other hand, when the combined capillary contribution encompasses both the reservoir and caprock, hₛₑₐₗ₋ᵣₑₛₑᵣᵥₒᵢᵣ increased from 198 m (at 30° C.) to 232 m (at 50° C.) and further to 248 m (at 70° C.). A variation of 5 m (at 30° C.), 6 m (at 50° C.), and 6 m (at 70° C.) was noted in the calculated column heights with increasing temperature for H₂+cushion gas injection. While this may seem insignificant, the extended effect of the pore throat can be of great significance when estimating storage capacity at elevated temperatures in depleted gas condensate reservoirs, especially where the storage reservoir is loosely consolidated.

Overall, comparing the direct effect of temperature on the column height can significantly impact hydrogen storage. For instance, using hₛₑₐₗ as a basis, the estimated column height in FIG. 19A increased from 228 m (at 30° C.) to 298 m (at 70° C.) when injecting pure H₂. However, it increased from 203 m (at 30° C.) to 254 m (at 70° C.) in the case of injection H₂+cushion in FIG. 19B at a constant 500 psi pressure. This gives a difference of 70 m containment of pure H₂ injection and 51 m of H₂+cushion. This therefore shows that even at elevated reservoir temperatures the caprock layers can retain significant plumes of the injected gas.

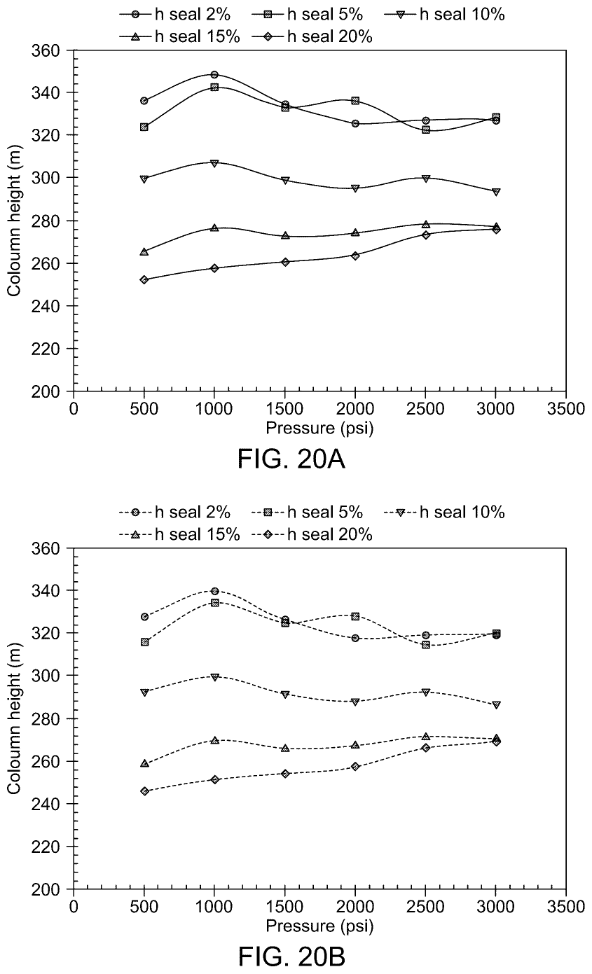

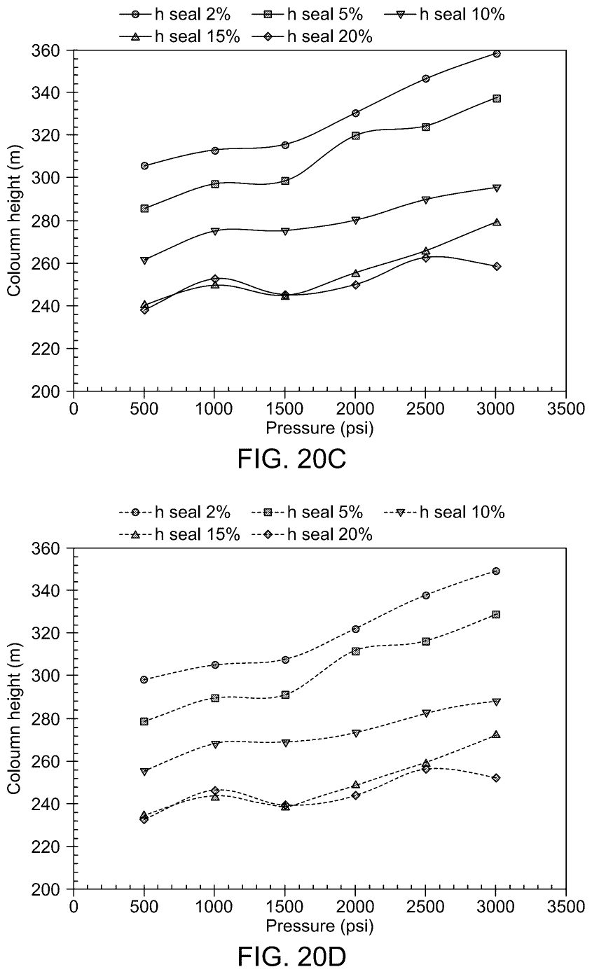

As can be seen in FIGS. 20A-20D, the data demonstrates that the column height for H₂/brine/n-octane and (H₂+cushion)/brine/n-octane systematically decreases with increasing salinity. For instance, at 500 psi in FIG. 20A, the hₛₑₐₗ for 100% H₂ decreased from 336 m at 2 wt. % to 252 m at 20 wt. %. In a similar vein, the hₛₑₐₗ₋ᵣₑₛₑᵣᵥₒᵢᵣ for 100% H₂ in FIG. 20B decreased from 327 m at 2 wt. % to 246 m at 20 wt. %. Upon increasing the pressure to 3000 psi, hₛₑₐₗ for 100% H₂ subsequently decreased from 327 m at 2 wt. % to 275 m at 20 wt. %. Similarly, hₛₑₐₗ₋ᵣₑₛₑᵣᵥₒᵢᵣ decreased from 319 m at 2 wt. % to 268 m at 20 wt. %. The introduction of a cushion gas also recorded a similar sequence. For example, at 500 psi as shown in FIG. 20C, the column height hₛₑₐₗ for 60% H₂+40% cushion declined from 306 m at 2 wt. % to 238 m at 20 wt. %. In the case of FIG. 20D, the hₛₑₐₗ-reservoir decreased from 298 m at 2 wt. % to 232 m at 20 wt. %. With an increase in pressure to 3000 psi, the hₛₑₐₗ subsequently dropped from 358 m at 2 wt. % to 259 m at 20 wt. %, whereas hₛₑₐₗ₋ᵣₑₛₑᵣᵥₒᵢᵣ decreased from 349 m at 2 wt. % to 252 m at 20 wt. %.

Tables 3A, 3B, 3C, 3D and 3E represent experimental data for (H₂+n-octane+brine) at 2 wt. %, 5 wt. %, 10 wt. %, 15 wt. %, and 20 wt. % salinity, respectively. The errors in Tables 3A-3E correspond to the standard deviation of the interfacial tension and contact angle measurements. Tables 4A, 4B, 4C, 4D and 4E represent experimental data for ([H₂+cushion] +n-octane+brine) at 2 wt. %, 5 wt. %, 10 wt. %, 15 wt. %, and 20 wt. % salinity, respectively. The errors in Tables 4A-4E correspond to the standard deviation of the interfacial tension and contact angle measurements in the respective tables. Table 5A represents (CH₄+n-octane+brine) experimental data at temperatures of 30° C., 40° C., and 50° C. while Table 5B represents (CH₄+n-octane+brine) experimental data at temperatures of 60° C. and 70° C. The errors in Tables 5A-5B correspond to the standard deviation of the interfacial tensions. The density of pure H₂ [See: J. W. Leachman, R. T. Jacobsen, S. G. Penoncello, E. W. Lemmon, Fundamental Equations of State for Parahydrogen, Normal Hydrogen, and Orthohydrogen, J. Phys. Chem. Ref. Data. 38 (2009) 721-748, incorporated herein by reference in its entirety], n-octane [See: R. Beckmüller, R. Span, E. W. Lemmon, M. Thol, A Fundamental Equation of State for the Calculation of Thermodynamic

Properties of n-Octane, J. Phys. Chem. Ref. Data. 51 (2022), incorporated herein by reference in its entirety], and CH₄ [See: U. Setzmann, W. Wagner, A New Equation of State and Tables of Thermodynamic Properties for Methane Covering the Range from the Melting Line to 625 K at Pressures up to 1000 MPa, J. Phys. Chem. Ref. Data. 20 (1991) 1061-1155, incorporated herein by reference in its entirety] were retrieved from NIST data base. The density of 60% H₂+40% cushion and brine was taken from the previous study on CH₄ two phase cushion gas [See: N. S. Muhammed, B. Haq, D. Al Shehri, Role of methane as a cushion gas for hydrogen storage in depleted gas reservoirs, Int. J. Hydrogen Energy. 48 (2023) 29663-29681, incorporated herein by reference in its entirety].

TABLE 3A
(H₂ + n-octane + brine) experimental data at 2 wt. % salinity.

| | | | | | | | | | CA for | | CA for WC | | | |
|---|---|---|---|---|---|---|---|---|---|---|---|---|---|---|
| Salinity | P | T | ρ_{brine} | ρ_{octane} | ρ_{100% H}_{₂} | Δρ | IFT (mN/m) | | Quartz (°) | | shale (°) | | hₛₑₐₗ | h_{(seal/res)} |
| (wt. %) | (psi) | (° C.) | (kg/m³) | (kg/m³) | (kg/m³) | (kg/m³) | VALUES | ±SD | VALUES | ±SD | VALUES | ±SD | (m) | (m) |
| 2 | 500 | 30 | 1009.62 | 697.59 | 2.7027 | 309.33 | 35.92 | 0.28 | 28.75 | 0.87 | 44.60 | 0.21 | 337.12 | 328.69 |
| | 1000 | | 1010.52 | 700.62 | 5.2989 | 304.60 | 35.88 | 0.17 | 27.89 | 1.14 | 43.10 | 0.45 | 350.73 | 341.96 |
| | 1500 | | 1011.33 | 703.53 | 7.7923 | 300.01 | 35.50 | 0.27 | 27.81 | 0.46 | 42.20 | 0.37 | 357.51 | 348.57 |
| | 2000 | | 1012.14 | 706.32 | 10.187 | 295.63 | 34.14 | 0.21 | 27.76 | 0.78 | 43.50 | 0.21 | 341.63 | 333.09 |
| | 2500 | | 1013.54 | 709.02 | 12.486 | 292.03 | 33.76 | 0.31 | 28.52 | 0.89 | 44.08 | 0.21 | 338.65 | 330.18 |
| | 3000 | | 1015.34 | 711.62 | 14.694 | 289.02 | 32.23 | 0.78 | 27.42 | 0.57 | 43.10 | 0.78 | 332.03 | 323.73 |
| | 500 | 40 | 1006.73 | 689.65 | 2.6174 | 314.46 | 35.77 | 0.43 | 28.12 | 1.17 | 43.40 | 0.15 | 337.02 | 328.60 |
| | 1000 | | 1007.96 | 692.88 | 5.1341 | 309.95 | 35.57 | 0.51 | 28.03 | 1.05 | 44.68 | 0.31 | 332.75 | 324.43 |
| | 1500 | | 1009.16 | 695.97 | 7.5535 | 305.64 | 33.69 | 0.45 | 27.79 | 1.24 | 44.73 | 0.06 | 319.34 | 311.36 |
| | 2000 | | 1010.36 | 698.93 | 9.8794 | 301.55 | 32.70 | 0.69 | 27.45 | 2.16 | 43.60 | 0.37 | 320.23 | 312.23 |
| | 2500 | | 1011.56 | 701.78 | 12.115 | 297.67 | 31.92 | 0.55 | 27.13 | 1.38 | 42.30 | 0.29 | 323.41 | 315.33 |
| | 3000 | | 1012.76 | 704.52 | 14.266 | 293.97 | 31.58 | 0.47 | 27.00 | 1.02 | 41.90 | 1.03 | 326.08 | 317.92 |
| | 500 | 50 | 1002.50 | 681.63 | 2.5375 | 318.33 | 35.66 | 0.48 | 26.80 | 2.46 | 42.60 | 0.32 | 336.25 | 327.84 |
| | 1000 | | 1003.90 | 685.08 | 4.9794 | 313.84 | 35.63 | 0.44 | 24.71 | 2.87 | 41.20 | 0.82 | 348.33 | 339.62 |
| | 1500 | | 1005.30 | 688.37 | 7.3293 | 309.60 | 33.46 | 0.36 | 24.17 | 3.03 | 40.60 | 0.74 | 334.56 | 326.20 |
| | 2000 | | 1006.70 | 691.51 | 9.5906 | 305.60 | 31.98 | 0.77 | 23.45 | 2.87 | 40.20 | 1.03 | 325.88 | 317.73 |
| | 2500 | | 1008.10 | 694.52 | 11.767 | 301.81 | 31.43 | 0.27 | 23.24 | 2.76 | 39.60 | 0.31 | 327.14 | 318.97 |
| | 3000 | | 1009.50 | 697.42 | 13.862 | 298.22 | 30.91 | 0.35 | 21.40 | 2.89 | 39.20 | 0.65 | 327.53 | 319.35 |
| | 500 | 60 | 995.76 | 673.54 | 2.4623 | 319.75 | 35.55 | 0.41 | 25.40 | 2.56 | 38.67 | 0.08 | 353.97 | 345.12 |
| | 1000 | | 996.96 | 677.23 | 4.8339 | 314.89 | 35.41 | 0.39 | 24.41 | 2.62 | 37.90 | 0.21 | 361.82 | 352.78 |
| | 1500 | | 998.16 | 680.73 | 7.1182 | 310.31 | 32.76 | 0.17 | 23.36 | 2.86 | 36.59 | 1.12 | 345.72 | 337.07 |
| | 2000 | | 999.36 | 684.07 | 9.3187 | 305.97 | 31.09 | 0.67 | 22.64 | 2.51 | 36.37 | 0.38 | 333.65 | 325.31 |
| | 2500 | | 1000.56 | 687.25 | 11.439 | 301.87 | 30.69 | 0.37 | 21.76 | 2.86 | 34.20 | 0.37 | 342.88 | 334.31 |
| | 3000 | | 1001.76 | 690.31 | 13.482 | 297.96 | 29.65 | 0.74 | 21.12 | 2.39 | 33.50 | 1.04 | 338.36 | 329.91 |
| | 500 | 70 | 986.54 | 665.36 | 2.3915 | 318.78 | 35.55 | 0.33 | 25.20 | 1.21 | 34.40 | 1.15 | 375.21 | 365.83 |
| | 1000 | | 986.97 | 669.31 | 4.6968 | 312.96 | 35.51 | 0.27 | 24.14 | 0.83 | 32.32 | 0.75 | 390.99 | 381.21 |
| | 1500 | | 987.41 | 673.05 | 6.9192 | 307.44 | 31.81 | 0.26 | 23.60 | 2.72 | 31.12 | 0.93 | 361.14 | 352.11 |
| | 2000 | | 987.84 | 676.59 | 9.0621 | 302.19 | 30.71 | 1.69 | 22.41 | 1.26 | 30.12 | 0.63 | 358.38 | 349.42 |
| | 2500 | | 988.28 | 679.97 | 11.129 | 297.18 | 29.77 | 0.76 | 21.60 | 2.25 | 27.40 | 1.25 | 362.65 | 353.59 |
| | 3000 | | 988.71 | 683.19 | 13.122 | 292.40 | 28.73 | 1.14 | 21.16 | 2.19 | 28.50 | 0.67 | 352.04 | 343.24 |

TABLE 3B
(H₂ + n-octane + brine) experimental data at 5 wt. % salinity.

| | | | | | | | | | CA for | | CA for WC | | | |
|---|---|---|---|---|---|---|---|---|---|---|---|---|---|---|
| Salini y | P | T | ρ_{brine} | ρ_{octane} | ρ_{100% H}_{₂} | Δρ | IFT (mN/m) | | Quartz (°) | | shale (°) | | hₛₑₐₗ | h_{(seal/res)} |
| (wt. %) | (psi) | (° C.) | (kg/m³) | (kg/m³) | (kg/m³) | (kg/m³) | VALUES | ±SD | VALUES | ±SD | VALUES | ±SD | (m) | (m) |
| 5 | 500 | 30 | 1029.77 | 697.59 | 2.7027 | 329.48 | 38.70 | 0.43 | 30.47 | 0.13 | 46.47 | 0.75 | 329.87 | 321.62 |
| | 1000 | | 1030.77 | 700.62 | 5.2989 | 324.85 | 38.68 | 0.44 | 31.31 | 0.14 | 47.31 | 0.64 | 329.21 | 320.98 |
| | 1500 | | 1031.77 | 703.53 | 7.7923 | 320.45 | 37.83 | 0.43 | 31.28 | 1.45 | 45.87 | 0.92 | 335.16 | 326.78 |
| | 2000 | | 1032.97 | 706.32 | 10.187 | 316.46 | 37.46 | 0.46 | 30.56 | 1.02 | 46.81 | 0.38 | 330.37 | 322.12 |
| | 2500 | | 1034.07 | 709.02 | 12.486 | 312.56 | 36.14 | 0.44 | 32.92 | 0.46 | 46.19 | 0.67 | 326.41 | 318.25 |
| | 3000 | | 1035.12 | 711.62 | 14.694 | 308.81 | 35.52 | 0.43 | 32.60 | 2.02 | 47.21 | 0.23 | 318.59 | 310.63 |
| | 500 | 40 | 1027.01 | 689.65 | 2.6174 | 334.75 | 38.63 | 0.43 | 30.47 | 0.78 | 45.58 | 0.76 | 329.37 | 321.14 |
| | 1000 | | 1028.23 | 692.88 | 5.1341 | 330.21 | 38.59 | 0.43 | 29.50 | 0.51 | 46.31 | 0.09 | 329.19 | 320.96 |
| | 1500 | | 1029.44 | 695.97 | 7.5535 | 325.92 | 36.59 | 0.42 | 28.30 | 0.35 | 45.08 | 0.83 | 323.23 | 315.15 |
| | 2000 | | 1031.13 | 698.93 | 9.8794 | 322.32 | 36.08 | 0.47 | 29.67 | 1.19 | 46.32 | 0.12 | 315.21 | 307.33 |
| | 2500 | | 1031.45 | 701.78 | 12.115 | 317.56 | 35.02 | 0.41 | 31.06 | 0.26 | 45.86 | 0.65 | 313.18 | 305.35 |
| | 3000 | | 1031.87 | 704.52 | 14.266 | 313.08 | 34.53 | 0.42 | 28.02 | 0.56 | 46.02 | 0.08 | 312.26 | 304.46 |
| | 500 | 50 | 1022.29 | 681.63 | 2.5375 | 338.12 | 38.61 | 0.43 | 27.07 | 1.28 | 45.86 | 0.76 | 324.29 | 316.18 |
| | 1000 | | 1023.27 | 685.08 | 4.9794 | 333.21 | 38.51 | 0.42 | 26.88 | 1.69 | 43.38 | 0.83 | 342.53 | 333.97 |
| | 1500 | | 1024.26 | 688.37 | 7.3293 | 328.56 | 36.17 | 0.40 | 26.41 | 1.85 | 42.05 | 0.74 | 333.30 | 324.96 |
| | 2000 | | 1024.86 | 691.51 | 9.5906 | 323.76 | 35.51 | 0.46 | 26.17 | 1.69 | 41.21 | 0.65 | 336.42 | 328.01 |
| | 2500 | | 1025.21 | 694.52 | 11.767 | 318.92 | 33.96 | 0.42 | 25.40 | 1.58 | 42.02 | 1.12 | 322.54 | 314.48 |
| | 3000 | | 1025.68 | 697.42 | 13.862 | 314.40 | 33.62 | 0.47 | 25.30 | 1.71 | 41.21 | 0.65 | 328.05 | 319.84 |
| | 500 | 60 | 1017.23 | 673.54 | 2.4623 | 341.23 | 38.36 | 0.42 | 26.40 | 1.38 | 40.80 | 1.23 | 347.02 | 338.34 |
| | 1000 | | 1018.26 | 677.23 | 4.8339 | 336.20 | 38.18 | 0.41 | 25.70 | 1.44 | 38.17 | 0.76 | 364.07 | 354.97 |
| | 1500 | | 1019.29 | 680.73 | 7.1182 | 331.44 | 35.11 | 0.41 | 26.50 | 1.68 | 37.40 | 0.87 | 343.15 | 334.57 |
| | 2000 | | 1019.86 | 684.07 | 9.3187 | 326.47 | 34.43 | 0.31 | 24.30 | 1.33 | 38.97 | 0.41 | 334.33 | 325.97 |
| | 2500 | | 1020.61 | 687.25 | 11.439 | 321.92 | 33.44 | 0.45 | 24.89 | 1.68 | 36.60 | 0.08 | 340.06 | 331.55 |
| | 3000 | | 1021.18 | 690.31 | 13.482 | 317.39 | 33.13 | 0.22 | 23.67 | 1.21 | 34.60 | 1.29 | 350.41 | 341.65 |
| | 500 | 70 | 1010.80 | 665.36 | 2.3915 | 343.05 | 38.21 | 0.47 | 27.41 | 1.03 | 34.47 | 0.16 | 374.43 | 365.07 |
| | 1000 | | 1011.90 | 669.31 | 4.6968 | 337.89 | 38.04 | 0.22 | 26.80 | 0.87 | 33.48 | 0.83 | 382.88 | 373.31 |
| | 1500 | | 1013.00 | 673.05 | 6.9192 | 333.03 | 34.34 | 0.56 | 26.50 | 1.54 | 32.97 | 0.34 | 352.71 | 343.89 |
| | 2000 | | 1013.82 | 676.59 | 9.0621 | 328.17 | 33.40 | 0.26 | 25.72 | 1.08 | 33.40 | 0.29 | 346.45 | 337.79 |
| | 2500 | | 1014.64 | 679.97 | 11.129 | 323.54 | 32.53 | 0.41 | 24.36 | 1.65 | 32.71 | 0.19 | 345.01 | 336.38 |
| | 3000 | | 1015.46 | 683.19 | 13.122 | 319.15 | 31.22 | 0.45 | 23.64 | 1.07 | 32.56 | 0.07 | 336.14 | 327.74 |

TABLE 3C
(H₂ + n-octane + brine) experimental data at 10 wt. % salinity.

| | | | | | | | | | CA for | | CA for WC | | | |
|---|---|---|---|---|---|---|---|---|---|---|---|---|---|---|
| Salinity | P | T | ρ_{brine} | ρ_{octane} | ρ_{100% H}_{₂} | Δρ | IFT (mN/m) | | Quartz (°) | | shale (°) | | hₛₑₐₗ | h_{(seal/res)} |
| (wt. %) | (psi) | (° C.) | (kg/m³) | (kg/m³) | (kg/m³) | (kg/m³) | VALUES | ±SD | VALUES | ±SD | VALUES | ±SD | (m) | (m) |
| 10 | 500 | 30 | 1059.08 | 697.59 | 2.7027 | 358.79 | 39.06 | 0.22 | 32.46 | 0.45 | 50.07 | 2.74 | 284.96 | 277.83 |
| | 1000 | | 1060.06 | 700.62 | 5.2989 | 354.14 | 39.01 | 0.21 | 33.70 | 0.31 | 49.82 | 1.28 | 289.80 | 282.55 |
| | 1500 | | 1061.08 | 703.53 | 7.7923 | 349.76 | 38.65 | 0.75 | 33.60 | 0.51 | 48.60 | 2.11 | 298.00 | 290.55 |
| | 2000 | | 1062.10 | 706.32 | 10.187 | 345.59 | 37.72 | 0.54 | 34.00 | 0.36 | 49.00 | 0.45 | 292.03 | 284.73 |
| | 2500 | | 1063.12 | 709.02 | 12.486 | 341.61 | 37.34 | 0.65 | 35.10 | 0.38 | 50.10 | 0.18 | 285.93 | 278.78 |
| | 3000 | | 1064.14 | 711.62 | 14.694 | 337.83 | 36.66 | 0.71 | 34.09 | 0.73 | 49.09 | 0.76 | 289.83 | 282.58 |
| | 500 | 40 | 1055.00 | 689.65 | 2.6174 | 362.74 | 39.02 | 0.23 | 33.07 | 0.21 | 48.07 | 0.15 | 293.13 | 285.80 |
| | 1000 | | 1056.21 | 692.88 | 5.1341 | 358.19 | 39.01 | 0.23 | 32.82 | 0.46 | 47.82 | 0.79 | 298.18 | 290.73 |
| | 1500 | | 1057.41 | 695.97 | 7.5535 | 353.89 | 37.32 | 0.53 | 32.38 | 1.05 | 47.38 | 0.56 | 291.17 | 283.89 |
| | 2000 | | 1058.62 | 698.93 | 9.8794 | 349.81 | 37.04 | 0.53 | 32.00 | 0.69 | 47.00 | 0.15 | 294.45 | 287.09 |
| | 2500 | | 1059.82 | 701.78 | 12.115 | 345.93 | 36.35 | 0.75 | 33.10 | 0.34 | 48.10 | 0.16 | 286.14 | 278.98 |
| | 3000 | | 1061.02 | 704.52 | 14.266 | 342.24 | 35.48 | 0.60 | 32.09 | 1.06 | 47.09 | 0.65 | 287.79 | 280.59 |
| | 500 | 50 | 1050.20 | 681.63 | 2.5375 | 366.03 | 38.88 | 0.22 | 31.18 | 1.23 | 46.18 | 0.26 | 299.90 | 292.40 |
| | 1000 | | 1051.30 | 685.08 | 4.9794 | 361.24 | 38.77 | 0.25 | 30.42 | 1.64 | 45.42 | 0.88 | 307.18 | 299.51 |
| | 1500 | | 1052.40 | 688.37 | 7.3293 | 356.70 | 37.11 | 0.59 | 30.18 | 1.80 | 45.18 | 0.26 | 299.05 | 291.58 |
| | 2000 | | 1053.29 | 691.51 | 9.5906 | 352.19 | 36.03 | 0.46 | 29.93 | 1.64 | 44.93 | 1.17 | 295.33 | 287.94 |
| | 2500 | | 1054.18 | 694.52 | 11.767 | 347.89 | 35.51 | 1.19 | 29.38 | 1.53 | 43.87 | 0.72 | 300.03 | 292.52 |
| | 3000 | | 1055.07 | 697.42 | 13.862 | 343.79 | 33.96 | 0.86 | 27.36 | 1.66 | 43.14 | 1.48 | 293.89 | 286.54 |
| | 500 | 60 | 1045.30 | 673.54 | 2.4623 | 369.30 | 38.69 | 0.30 | 31.42 | 1.33 | 42.74 | 0.58 | 313.77 | 305.92 |
| | 1000 | | 1046.70 | 677.23 | 4.8339 | 364.64 | 38.67 | 0.31 | 30.53 | 1.39 | 41.21 | 0.64 | 325.32 | 317.19 |
| | 1500 | | 1048.10 | 680.73 | 7.1182 | 360.25 | 35.93 | 0.57 | 28.52 | 1.63 | 40.39 | 0.63 | 309.72 | 301.98 |
| | 2000 | | 1048.87 | 684.07 | 9.3187 | 355.48 | 34.78 | 0.62 | 26.67 | 1.28 | 39.84 | 0.72 | 306.35 | 298.69 |
| | 2500 | | 1049.63 | 687.25 | 11.439 | 350.94 | 34.24 | 0.83 | 25.84 | 1.63 | 38.52 | 0.11 | 311.23 | 303.45 |
| | 3000 | | 1050.40 | 690.31 | 13.482 | 346.60 | 33.43 | 0.74 | 25.60 | 1.16 | 39.42 | 0.45 | 303.85 | 296.25 |
| | 500 | 70 | 1039.42 | 665.36 | 2.3915 | 371.67 | 38.57 | 0.30 | 30.65 | 0.98 | 37.29 | 2.83 | 336.66 | 328.25 |
| | 1000 | | 1040.74 | 669.31 | 4.6968 | 366.74 | 38.52 | 0.33 | 28.20 | 0.82 | 36.67 | 1.07 | 343.54 | 334.95 |
| | 1500 | | 1042.06 | 673.05 | 6.9192 | 362.09 | 34.88 | 0.66 | 27.60 | 1.49 | 37.12 | 0.61 | 313.16 | 305.34 |
| | 2000 | | 1042.72 | 676.59 | 9.0621 | 357.07 | 34.23 | 0.56 | 26.60 | 1.03 | 35.39 | 0.76 | 318.68 | 310.71 |
| | 2500 | | 1043.38 | 679.97 | 11.129 | 352.28 | 33.70 | 0.50 | 25.80 | 1.60 | 34.89 | 1.09 | 319.97 | 311.97 |
| | 3000 | | 1044.03 | 683.19 | 13.122 | 347.72 | 32.93 | 0.98 | 24.65 | 1.02 | 33.56 | 1.34 | 321.79 | 313.75 |

TABLE 3D
(H₂ + n-octane + brine) experimental data at 15 wt. % salinity.

| | | | | | | | | | CA for | | CA for WC | | | |
|---|---|---|---|---|---|---|---|---|---|---|---|---|---|---|
| Salinity | P | T | ρ_{brine} | ρ_{octane} | ρ_{100% H}_{₂} | Δρ | IFT (mN/m) | | Quartz (°) | | shale (°) | | hₛₑₐₗ | h_{(seal/res)} |
| (wt. %) | (psi) | (° C.) | (kg/m³) | (kg/m³) | (kg/m³) | (kg/m³) | VALUES | ±SD | VALUES | ±SD | VALUES | ±SD | (m) | (m) |
| 15 | 500 | 30 | 1089.71 | 697.59 | 2.7027 | 389.42 | 39.58 | 0.26 | 35.14 | 0.49 | 53.67 | 0.24 | 245.56 | 239.42 |
| | 1000 | | 1090.92 | 700.62 | 5.2989 | 385.00 | 39.15 | 0.25 | 34.86 | 0.90 | 52.46 | 0.78 | 252.68 | 246.36 |
| | 1500 | | 1092.13 | 703.53 | 7.7923 | 380.81 | 38.47 | 0.88 | 35.33 | 1.06 | 52.93 | 0.45 | 248.31 | 242.10 |
| | 2000 | | 1092.87 | 706.32 | 10.187 | 376.37 | 38.12 | 0.64 | 34.98 | 0.90 | 51.62 | 1.05 | 256.45 | 250.04 |
| | 2500 | | 1093.62 | 709.02 | 12.486 | 372.11 | 37.57 | 0.77 | 35.53 | 0.79 | 53.13 | 0.56 | 247.05 | 240.87 |
| | 3000 | | 1094.36 | 711.62 | 14.694 | 368.05 | 37.08 | 0.84 | 35.56 | 0.92 | 52.27 | 1.15 | 251.42 | 245.14 |
| | 500 | 40 | 1085.10 | 689.65 | 2.6174 | 392.83 | 39.13 | 0.27 | 34.40 | 0.59 | 49.70 | 0.78 | 262.74 | 256.18 |
| | 1000 | | 1086.30 | 692.88 | 5.1341 | 388.29 | 39.10 | 0.27 | 35.20 | 0.65 | 46.72 | 2.18 | 281.51 | 274.47 |
| | 1500 | | 1087.50 | 695.97 | 7.5535 | 383.98 | 37.76 | 0.63 | 34.60 | 0.89 | 48.37 | 0.52 | 266.42 | 259.76 |
| | 2000 | | 1088.17 | 698.93 | 9.8794 | 379.36 | 37.24 | 0.62 | 33.56 | 0.54 | 49.18 | 0.21 | 261.64 | 255.10 |
| | 2500 | | 1088.84 | 701.78 | 12.115 | 374.95 | 36.68 | 0.89 | 35.20 | 0.89 | 50.23 | 0.62 | 255.20 | 248.82 |
| | 3000 | | 1089.51 | 704.52 | 14.266 | 370.73 | 35.85 | 0.71 | 34.67 | 1.24 | 49.51 | 1.27 | 256.07 | 249.67 |
| | 500 | 50 | 1079.92 | 681.63 | 2.5375 | 395.75 | 39.09 | 0.26 | 34.15 | 2.25 | 48.75 | 0.32 | 265.61 | 258.97 |
| | 1000 | | 1081.14 | 685.08 | 4.9794 | 391.08 | 39.05 | 0.29 | 33.85 | 2.66 | 47.23 | 1.81 | 276.50 | 269.59 |
| | 1500 | | 1082.36 | 688.37 | 7.3293 | 386.66 | 37.46 | 0.69 | 33.94 | 2.82 | 46.31 | 0.63 | 272.86 | 266.04 |
| | 2000 | | 1083.26 | 691.51 | 9.5906 | 382.16 | 36.52 | 0.54 | 32.50 | 2.66 | 45.28 | 0.72 | 274.17 | 267.31 |
| | 2500 | | 1084.15 | 694.52 | 11.767 | 377.87 | 36.57 | 1.40 | 31.38 | 2.55 | 45.12 | 0.16 | 278.48 | 271.52 |
| | 3000 | | 1085.05 | 697.42 | 13.862 | 373.77 | 35.51 | 1.01 | 31.10 | 2.68 | 44.27 | 0.36 | 277.37 | 270.44 |
| | 500 | 60 | 1073.82 | 673.54 | 2.4623 | 397.82 | 39.01 | 0.35 | 32.97 | 2.35 | 43.57 | 0.18 | 289.72 | 282.48 |
| | 1000 | | 1075.04 | 677.23 | 4.8339 | 392.98 | 38.87 | 0.37 | 32.51 | 2.41 | 42.58 | 0.26 | 297.00 | 289.57 |
| | 1500 | | 1076.26 | 680.73 | 7.1182 | 388.41 | 36.37 | 0.68 | 29.56 | 2.65 | 40.56 | 0.65 | 290.09 | 282.84 |
| | 2000 | | 1076.91 | 684.07 | 9.3187 | 383.52 | 35.81 | 0.74 | 28.36 | 2.30 | 41.11 | 0.12 | 286.83 | 279.66 |
| | 2500 | | 1077.57 | 687.25 | 11.439 | 378.88 | 35.28 | 0.99 | 27.74 | 2.65 | 40.12 | 0.04 | 290.32 | 283.06 |
| | 3000 | | 1078.22 | 690.31 | 13.482 | 374.43 | 34.77 | 0.88 | 26.50 | 2.18 | 38.81 | 0.14 | 295.07 | 287.69 |
| | 500 | 70 | 1066.63 | 665.36 | 2.3915 | 398.88 | 38.87 | 0.35 | 31.27 | 2.00 | 38.59 | 0.27 | 310.59 | 302.83 |
| | 1000 | | 1067.86 | 669.31 | 4.6968 | 393.86 | 38.76 | 0.39 | 30.30 | 1.84 | 37.53 | 0.18 | 318.24 | 310.29 |
| | 1500 | | 1069.09 | 673.05 | 6.9192 | 389.12 | 35.79 | 0.78 | 28.56 | 2.51 | 37.22 | 0.83 | 298.62 | 291.15 |
| | 2000 | | 1069.86 | 676.59 | 9.0621 | 384.21 | 34.64 | 0.66 | 27.70 | 2.05 | 36.78 | 0.51 | 294.42 | 287.06 |
| | 2500 | | 1070.63 | 679.97 | 11.129 | 379.53 | 33.63 | 0.59 | 25.70 | 2.62 | 35.76 | 0.24 | 293.20 | 285.87 |
| | 3000 | | 1071.40 | 683.19 | 13.122 | 375.09 | 33.37 | 1.16 | 25.20 | 2.04 | 38.25 | 0.85 | 284.90 | 277.78 |

TABLE 3E
(H₂ + n-octane + brine) experimental data at 20 wt. % salinity.

| | | | | | | | | | CA for | | CA for WC | | | |
|---|---|---|---|---|---|---|---|---|---|---|---|---|---|---|
| Salinity | P | T | ρ_{brine} | ρ_{octane} | ρ_{100% H}_{₂} | Δρ | IFT (mN/m) | | Quartz (°) | | shale (°) | | hₛₑₐₗ | h_{(seal/res)} |
| (wt. %) | (psi) | (° C.) | (kg/m³) | (kg/m³) | (kg/m³) | (kg/m³) | VALUES | ±SD | VALUES | ±SD | VALUES | ±SD | (m) | (m) |
| 20 | 500 | 30 | 1096.52 | 697.59 | 2.7027 | 396.23 | 40.40 | 0.55 | 36.62 | 1.07 | 56.62 | 1.21 | 228.81 | 223.09 |
| | 1000 | | 1097.54 | 700.62 | 5.2989 | 391.62 | 40.37 | 0.54 | 35.80 | 1.48 | 54.55 | 3.17 | 243.84 | 237.74 |
| | 1500 | | 1098.56 | 703.53 | 7.7923 | 387.24 | 40.07 | 1.89 | 36.10 | 1.64 | 54.99 | 2.42 | 242.06 | 236.01 |
| | 2000 | | 1098.91 | 706.32 | 10.187 | 382.40 | 39.49 | 1.37 | 35.65 | 1.48 | 54.49 | 3.52 | 244.58 | 238.47 |
| | 2500 | | 1099.25 | 709.02 | 12.486 | 377.75 | 38.38 | 1.65 | 35.30 | 1.37 | 53.92 | 3.21 | 244.02 | 237.92 |
| | 3000 | | 1099.60 | 711.62 | 14.694 | 373.28 | 37.46 | 1.80 | 36.30 | 1.50 | 54.06 | 1.48 | 240.19 | 234.18 |
| | 500 | 40 | 1092.34 | 689.65 | 2.6174 | 400.08 | 40.23 | 0.58 | 35.23 | 1.17 | 51.15 | 1.25 | 257.22 | 250.79 |
| | 1000 | | 1093.26 | 692.88 | 5.1341 | 395.24 | 40.13 | 0.59 | 34.78 | 1.23 | 50.85 | 2.47 | 261.42 | 254.89 |
| | 1500 | | 1094.17 | 695.97 | 7.5535 | 390.65 | 39.61 | 1.35 | 35.32 | 1.47 | 50.94 | 2.11 | 260.52 | 254.01 |
| | 2000 | | 1094.41 | 698.93 | 9.8794 | 385.60 | 38.91 | 1.34 | 34.56 | 1.12 | 51.07 | 1.16 | 258.58 | 252.12 |
| | 2500 | | 1094.64 | 701.78 | 12.115 | 380.75 | 38.09 | 1.91 | 35.40 | 1.47 | 50.98 | 0.87 | 256.87 | 250.45 |
| | 3000 | | 1094.87 | 704.52 | 14.266 | 376.09 | 37.36 | 1.53 | 34.57 | 1.82 | 50.49 | 0.92 | 257.72 | 251.28 |
| | 500 | 50 | 1086.46 | 681.63 | 2.5375 | 402.29 | 39.87 | 0.55 | 35.70 | 1.72 | 51.33 | 0.73 | 252.56 | 246.25 |
| | 1000 | | 1087.59 | 685.08 | 4.9794 | 397.53 | 39.73 | 0.62 | 35.00 | 2.13 | 50.74 | 1.12 | 257.92 | 251.47 |
| | 1500 | | 1088.72 | 688.37 | 7.3293 | 393.02 | 39.03 | 1.48 | 34.54 | 2.29 | 49.94 | 0.85 | 260.59 | 254.07 |
| | 2000 | | 1089.85 | 691.51 | 9.5906 | 388.75 | 38.07 | 1.16 | 34.57 | 2.13 | 48.62 | 0.26 | 263.99 | 257.39 |
| | 2500 | | 1090.40 | 694.52 | 11.767 | 384.11 | 37.22 | 3.01 | 33.25 | 2.02 | 46.21 | 0.51 | 273.41 | 266.57 |
| | 3000 | | 1090.95 | 697.42 | 13.862 | 379.67 | 36.52 | 2.17 | 32.65 | 2.15 | 45.31 | 0.38 | 275.82 | 268.92 |
| | 500 | 60 | 1079.53 | 673.54 | 2.4623 | 403.53 | 39.75 | 0.75 | 34.56 | 1.82 | 45.89 | 1.14 | 279.60 | 272.61 |
| | 1000 | | 1080.76 | 677.23 | 4.8339 | 398.70 | 39.68 | 0.79 | 34.12 | 1.88 | 46.74 | 0.12 | 278.13 | 271.18 |
| | 1500 | | 1081.99 | 680.73 | 7.1182 | 394.14 | 38.06 | 1.45 | 32.43 | 2.12 | 45.94 | 0.43 | 273.78 | 266.94 |
| | 2000 | | 1083.22 | 684.07 | 9.3187 | 389.83 | 37.17 | 1.58 | 31.45 | 1.77 | 44.21 | 0.31 | 278.70 | 271.73 |
| | 2500 | | 1083.56 | 687.25 | 11.439 | 384.87 | 36.56 | 2.11 | 30.45 | 2.12 | 43.75 | 0.26 | 279.78 | 272.79 |
| | 3000 | | 1083.90 | 690.31 | 13.482 | 380.11 | 36.08 | 1.88 | 28.55 | 1.65 | 43.16 | 0.18 | 282.31 | 275.25 |
| | 500 | 70 | 1072.43 | 665.36 | 2.3915 | 404.68 | 39.58 | 0.76 | 32.46 | 1.47 | 41.61 | 0.26 | 298.20 | 290.75 |
| | 1000 | | 1073.41 | 669.31 | 4.6968 | 399.41 | 39.51 | 0.83 | 31.80 | 1.31 | 39.97 | 0.21 | 309.14 | 301.41 |
| | 1500 | | 1074.40 | 673.05 | 6.9192 | 394.43 | 36.62 | 1.67 | 30.43 | 1.98 | 39.23 | 0.82 | 293.26 | 285.93 |
| | 2000 | | 1075.39 | 676.59 | 9.0621 | 389.74 | 36.07 | 1.42 | 29.65 | 1.52 | 38.52 | 0.43 | 295.23 | 287.85 |
| | 2500 | | 1076.15 | 679.97 | 11.129 | 385.05 | 35.52 | 1.18 | 26.46 | 2.09 | 37.89 | 0.11 | 296.82 | 289.40 |
| | 3000 | | 1076.92 | 683.19 | 13.122 | 380.61 | 35.18 | 1.72 | 27.12 | 0.51 | 38.21 | 0.84 | 296.16 | 288.75 |

TABLE 4A
([H2 + cushion] + n-octane + brine) experimental data at 2 wt. % salinity.

| | | | | | | | | | CA for | | CA for WC | | | |
|---|---|---|---|---|---|---|---|---|---|---|---|---|---|---|
| Salinity | P | T | ρ_{brine} | ρ_{octane} | ρ_{60% H}_{₂}_{+40% Impurity} | Δρ | IFT (mN/m) | | Quartz (°) | | shale (°) | | hₛₑₐₗ | h_{(seal/res)} |
| (wt. %) | (psi) | (° C.) | (kg/m³) | (kg/m³) | (kg/m³) | (kg/m³) | VALUES | ±SD | VALUES | ±SD | VALUES | ±SD | (m) | (m) |
| 2 | 500 | 30 | 1009.62 | 697.59 | 13.10 | 298.93 | 34.12 | 1.42 | 31.20 | 0.21 | 48.14 | 0.14 | 310.61 | 302.84 |
| | 1000 | | 1010.52 | 700.62 | 25.95 | 283.95 | 33.21 | 1.27 | 30.40 | 0.63 | 46.93 | 0.06 | 325.70 | 317.56 |
| | 1500 | | 1011.33 | 703.53 | 38.40 | 269.40 | 31.71 | 1.54 | 31.30 | 0.71 | 47.41 | 0.42 | 324.80 | 316.68 |
| | 2000 | | 1012.14 | 706.32 | 50.34 | 255.48 | 30.57 | 1.25 | 32.10 | 0.32 | 46.51 | 0.29 | 335.86 | 327.46 |
| | 2500 | | 1013.54 | 709.02 | 61.71 | 242.81 | 30.25 | 1.24 | 30.60 | 0.56 | 48.17 | 0.53 | 338.85 | 330.38 |
| | 3000 | | 1015.34 | 711.62 | 72.49 | 231.23 | 29.85 | 0.88 | 30.10 | 0.13 | 47.07 | 0.83 | 358.61 | 349.64 |
| | 500 | 40 | 1006.73 | 689.65 | 12.67 | 304.41 | 33.24 | 1.79 | 32.31 | 0.62 | 46.51 | 0.61 | 306.46 | 298.80 |
| | 1000 | | 1007.96 | 692.88 | 25.09 | 289.99 | 32.71 | 1.25 | 30.68 | 0.31 | 47.09 | 0.89 | 313.18 | 305.35 |
| | 1500 | | 1009.16 | 695.97 | 37.11 | 276.08 | 30.97 | 0.37 | 30.73 | 0.67 | 46.52 | 0.67 | 314.81 | 306.94 |
| | 2000 | | 1010.36 | 698.93 | 48.66 | 262.77 | 30.33 | 0.75 | 30.56 | 1.06 | 45.71 | 0.36 | 328.62 | 320.41 |
| | 2500 | | 1011.56 | 701.78 | 59.66 | 250.12 | 29.43 | 0.35 | 30.84 | 0.18 | 46.35 | 0.78 | 331.22 | 322.94 |
| | 3000 | | 1012.76 | 704.52 | 70.11 | 238.13 | 28.61 | 0.41 | 30.89 | 0.42 | 46.21 | 1.03 | 338.99 | 330.51 |
| | 500 | 50 | 1002.50 | 681.63 | 12.27 | 308.60 | 32.97 | 1.08 | 29.30 | 2.33 | 45.37 | 0.78 | 306.07 | 298.42 |
| | 1000 | | 1003.90 | 685.08 | 24.28 | 294.54 | 31.87 | 1.30 | 28.12 | 2.74 | 44.81 | 0.47 | 313.03 | 305.21 |
| | 1500 | | 1005.30 | 688.37 | 35.92 | 281.01 | 30.07 | 0.60 | 28.00 | 2.90 | 43.68 | 0.72 | 315.57 | 307.68 |
| | 2000 | | 1006.70 | 691.51 | 47.09 | 268.10 | 29.46 | 1.08 | 27.70 | 2.74 | 42.48 | 1.27 | 330.51 | 322.24 |
| | 2500 | | 1008.10 | 694.52 | 57.75 | 255.83 | 28.70 | 0.42 | 27.10 | 2.63 | 40.78 | 0.59 | 346.45 | 337.79 |
| | 3000 | | 1009.50 | 697.42 | 67.89 | 244.19 | 28.07 | 0.48 | 26.60 | 2.76 | 40.14 | 1.21 | 358.32 | 349.36 |
| | 500 | 60 | 995.76 | 673.54 | 11.89 | 310.33 | 32.32 | 0.28 | 27.50 | 2.43 | 42.32 | 0.18 | 314.00 | 306.15 |
| | 1000 | | 996.96 | 677.23 | 23.53 | 296.20 | 31.65 | 0.73 | 26.30 | 2.49 | 41.86 | 0.34 | 324.51 | 316.40 |
| | 1500 | | 998.16 | 680.73 | 34.80 | 282.63 | 29.57 | 0.34 | 25.40 | 2.73 | 40.55 | 0.86 | 324.14 | 316.03 |
| | 2000 | | 999.36 | 684.07 | 45.63 | 269.66 | 29.34 | 0.22 | 27.37 | 2.38 | 40.33 | 1.12 | 338.21 | 329.76 |
| | 2500 | | 1000.56 | 687.25 | 55.98 | 257.33 | 28.68 | 0.32 | 26.62 | 2.73 | 39.58 | 0.74 | 350.35 | 341.59 |
| | 3000 | | 1001.76 | 690.31 | 65.83 | 245.62 | 28.00 | 0.04 | 26.02 | 2.26 | 38.98 | 1.09 | 361.36 | 352.32 |
| | 500 | 70 | 986.54 | 665.36 | 11.54 | 309.64 | 31.89 | 0.92 | 25.75 | 2.08 | 38.87 | 0.76 | 326.98 | 318.80 |
| | 1000 | | 986.97 | 669.31 | 22.82 | 294.84 | 31.21 | 0.73 | 25.69 | 1.92 | 37.64 | 1.04 | 341.80 | 333.26 |
| | 1500 | | 987.41 | 673.05 | 33.75 | 280.61 | 29.05 | 0.31 | 25.00 | 2.59 | 38.12 | 0.82 | 332.06 | 323.75 |
| | 2000 | | 987.84 | 676.59 | 44.26 | 266.99 | 28.20 | 0.78 | 24.72 | 2.13 | 36.97 | 0.61 | 344.06 | 335.46 |
| | 2500 | | 988.28 | 679.97 | 54.31 | 254.00 | 26.43 | 1.57 | 24.90 | 2.70 | 35.56 | 1.16 | 345.24 | 336.61 |
| | 3000 | | 988.71 | 683.19 | 63.90 | 241.62 | 26.79 | 0.38 | 24.59 | 2.12 | 35.02 | 0.94 | 370.26 | 361.01 |

TABLE 4B
([H2 + cushion] + n-octane + brine) experimental data at 5 wt. % salinity.

| | | | | | | | | | CA for | | CA for WC | | | |
|---|---|---|---|---|---|---|---|---|---|---|---|---|---|---|
| Salinity | P | T | ρ_{brine} | ρ_{octane} | ρ_{60% H}_{₂}_{+40% Impurity} | Δρ | IFT (mN/m) | | Quartz (°) | | shale (°) | | hₛₑₐₗ | h_{(seal/res)} |
| (wt. %) | (psi) | (° C.) | (kg/m³) | (kg/m³) | (kg/m³) | (kg/m³) | VALUES | ±SD | VALUES | ±SD | VALUES | ±SD | (m) | (m) |
| 5 | 500 | 30 | 1029.77 | 697.59 | 13.10 | 319.08 | 34.88 | 0.41 | 40.20 | 1.12 | 52.95 | 0.07 | 268.60 | 261.88 |
| | 1000 | | 1030.77 | 700.62 | 25.95 | 304.20 | 34.08 | 0.56 | 38.40 | 1.39 | 51.11 | 1.07 | 286.88 | 279.70 |
| | 1500 | | 1031.77 | 703.53 | 38.40 | 289.84 | 32.88 | 0.53 | 37.10 | 0.71 | 49.56 | 0.61 | 300.05 | 292.54 |
| | 2000 | | 1032.97 | 706.32 | 50.34 | 276.31 | 31.43 | 0.53 | 37.00 | 1.03 | 51.28 | 0.53 | 290.14 | 282.89 |
| | 2500 | | 1034.07 | 709.02 | 61.71 | 263.34 | 31.10 | 0.42 | 36.64 | 1.14 | 49.81 | 0.72 | 310.80 | 303.03 |
| | 3000 | | 1035.12 | 711.62 | 72.49 | 251.01 | 30.31 | 0.39 | 34.62 | 0.82 | 49.84 | 1.26 | 317.61 | 309.67 |
| | 500 | 40 | 1027.01 | 689.65 | 12.67 | 324.69 | 34.18 | 0.53 | 35.06 | 1.42 | 50.71 | 0.51 | 271.82 | 265.03 |
| | 1000 | | 1028.23 | 692.88 | 25.09 | 310.26 | 33.08 | 0.63 | 34.31 | 1.30 | 49.52 | 0.15 | 282.23 | 275.18 |
| | 1500 | | 1029.44 | 695.97 | 37.11 | 296.36 | 31.03 | 0.51 | 31.57 | 1.49 | 49.07 | 1.02 | 279.70 | 272.71 |
| | 2000 | | 1031.13 | 698.93 | 48.66 | 283.54 | 30.80 | 0.56 | 32.50 | 2.41 | 48.76 | 0.25 | 291.95 | 284.65 |
| | 2500 | | 1031.45 | 701.78 | 59.66 | 270.01 | 29.47 | 0.56 | 30.98 | 1.63 | 48.48 | 0.56 | 294.97 | 287.60 |
| | 3000 | | 1031.87 | 704.52 | 70.11 | 257.24 | 28.71 | 0.55 | 32.50 | 1.27 | 48.61 | 0.14 | 300.87 | 293.34 |
| | 500 | 50 | 1022.29 | 681.63 | 12.27 | 328.39 | 33.73 | 0.52 | 34.49 | 1.10 | 46.98 | 0.25 | 285.76 | 278.62 |
| | 1000 | | 1023.27 | 685.08 | 24.28 | 313.91 | 32.60 | 0.61 | 33.91 | 1.51 | 45.41 | 0.51 | 297.27 | 289.84 |
| | 1500 | | 1024.26 | 688.37 | 35.92 | 299.97 | 30.73 | 0.55 | 31.40 | 1.67 | 44.37 | 0.83 | 298.57 | 291.11 |
| | 2000 | | 1024.86 | 691.51 | 47.09 | 286.26 | 30.63 | 0.53 | 32.41 | 1.51 | 42.88 | 0.23 | 319.78 | 311.79 |
| | 2500 | | 1025.21 | 694.52 | 57.75 | 272.94 | 29.17 | 0.52 | 31.65 | 1.40 | 41.87 | 0.31 | 324.47 | 316.36 |
| | 3000 | | 1025.68 | 697.42 | 67.89 | 260.37 | 28.59 | 0.51 | 31.05 | 1.53 | 41.08 | 0.87 | 337.46 | 329.02 |
| | 500 | 60 | 1017.23 | 673.54 | 11.89 | 331.80 | 32.87 | 0.66 | 30.87 | 1.20 | 43.70 | 0.76 | 292.07 | 284.77 |
| | 1000 | | 1018.26 | 677.23 | 23.53 | 317.50 | 32.13 | 0.79 | 29.90 | 1.26 | 41.88 | 0.82 | 307.26 | 299.58 |
| | 1500 | | 1019.29 | 680.73 | 34.80 | 303.76 | 29.94 | 0.37 | 28.92 | 1.50 | 40.90 | 0.12 | 303.77 | 296.17 |
| | 2000 | | 1019.86 | 684.07 | 45.63 | 290.16 | 29.57 | 0.55 | 27.97 | 1.15 | 39.95 | 1.02 | 318.56 | 310.59 |
| | 2500 | | 1020.61 | 687.25 | 55.98 | 277.38 | 29.04 | 0.64 | 27.56 | 1.50 | 39.54 | 0.21 | 329.17 | 320.94 |
| | 3000 | | 1021.18 | 690.31 | 65.83 | 265.04 | 28.04 | 0.55 | 27.51 | 1.03 | 39.49 | 0.82 | 332.93 | 324.60 |
| | 500 | 70 | 1010.80 | 665.36 | 11.54 | 333.90 | 32.26 | 0.80 | 29.01 | 0.85 | 40.99 | 0.18 | 297.40 | 289.96 |
| | 1000 | | 1011.90 | 669.31 | 22.82 | 319.77 | 31.89 | 0.81 | 27.86 | 0.69 | 39.84 | 0.52 | 312.26 | 304.46 |
| | 1500 | | 1013.00 | 673.05 | 33.75 | 306.20 | 29.38 | 0.56 | 27.08 | 1.36 | 39.06 | 0.31 | 303.79 | 296.20 |
| | 2000 | | 1013.82 | 676.59 | 44.26 | 292.97 | 29.05 | 0.62 | 26.47 | 0.90 | 38.45 | 0.56 | 316.59 | 308.68 |
| | 2500 | | 1014.64 | 679.97 | 54.31 | 280.36 | 28.15 | 0.35 | 26.80 | 1.47 | 37.46 | 0.15 | 324.93 | 316.80 |
| | 3000 | | 1015.46 | 683.19 | 63.90 | 268.37 | 27.83 | 0.56 | 25.67 | 0.89 | 36.95 | 0.28 | 337.94 | 329.49 |

TABLE 4C
([H₂ + cushion] + n-octane + brine) experimental data at 10 wt. % salinity.

| | | | | | | | | | CA for | | CA for WC | | | |
|---|---|---|---|---|---|---|---|---|---|---|---|---|---|---|
| Salinity | P | T | ρ_{brine} | ρ_{octane} | ρ_{60% H}_{₂}_{+40% Impurity} | Δρ | IFT (mN/m) | | Quartz (°) | | shale (°) | | hₛₑₐₗ | h_{(seal/res)} |
| (wt. %) | (psi) | (° C.) | (kg/m³) | (kg/m³) | (kg/m³) | (kg/m³) | VALUES | ±SD | VALUES | ±SD | VALUES | ±SD | (m) | (m) |
| 10 | 500 | 30 | 1059.08 | 697.59 | 13.10 | 348.39 | 35.58 | 0.45 | 42.10 | 1.06 | 55.01 | 0.12 | 238.83 | 232.85 |
| | 1000 | | 1060.06 | 700.62 | 25.95 | 333.49 | 35.26 | 0.02 | 40.36 | 1.65 | 54.47 | 0.45 | 250.57 | 244.31 |
| | 1500 | | 1061.08 | 703.53 | 38.40 | 319.15 | 34.36 | 0.29 | 39.65 | 0.89 | 52.85 | 0.77 | 265.17 | 258.54 |
| | 2000 | | 1062.10 | 706.32 | 50.34 | 305.44 | 33.32 | 0.03 | 40.14 | 0.78 | 52.60 | 1.11 | 270.18 | 263.42 |
| | 2500 | | 1063.12 | 709.02 | 61.71 | 292.39 | 31.78 | 0.06 | 39.87 | 1.23 | 53.28 | 0.27 | 265.04 | 258.42 |
| | 3000 | | 1064.14 | 711.62 | 72.49 | 280.03 | 31.13 | 0.05 | 41.40 | 0.76 | 52.84 | 0.13 | 273.84 | 267.00 |
| | 500 | 40 | 1055.00 | 689.65 | 12.67 | 352.68 | 35.12 | 0.12 | 41.07 | 0.94 | 51.87 | 0.76 | 250.74 | 244.47 |
| | 1000 | | 1056.21 | 692.88 | 25.09 | 338.24 | 34.89 | 0.18 | 40.82 | 1.95 | 51.62 | 0.41 | 261.15 | 254.62 |
| | 1500 | | 1057.41 | 695.97 | 37.11 | 324.33 | 32.52 | 0.55 | 40.38 | 1.08 | 51.18 | 0.26 | 256.33 | 249.92 |
| | 2000 | | 1058.62 | 698.93 | 48.66 | 311.03 | 31.69 | 0.38 | 40.00 | 0.87 | 50.59 | 0.63 | 263.76 | 257.17 |
| | 2500 | | 1059.82 | 701.78 | 59.66 | 298.38 | 30.86 | 0.28 | 39.70 | 1.63 | 49.91 | 1.05 | 271.59 | 264.80 |
| | 3000 | | 1061.02 | 704.52 | 70.11 | 286.39 | 30.47 | 0.21 | 38.90 | 1.28 | 50.89 | 0.22 | 273.68 | 266.84 |
| | 500 | 50 | 1050.20 | 681.63 | 12.27 | 356.30 | 34.18 | 0.41 | 37.67 | 1.62 | 47.98 | 1.21 | 261.81 | 255.27 |
| | 1000 | | 1051.30 | 685.08 | 24.28 | 341.94 | 33.98 | 0.33 | 36.62 | 2.03 | 47.22 | 0.47 | 275.22 | 268.34 |
| | 1500 | | 1052.40 | 688.37 | 35.92 | 328.11 | 32.49 | 0.25 | 35.31 | 2.19 | 46.98 | 0.19 | 275.50 | 268.61 |
| | 2000 | | 1053.29 | 691.51 | 47.09 | 314.69 | 31.56 | 0.22 | 34.21 | 2.03 | 46.73 | 0.54 | 280.30 | 273.29 |
| | 2500 | | 1054.18 | 694.52 | 57.75 | 301.91 | 30.61 | 0.21 | 33.67 | 1.92 | 45.48 | 2.11 | 289.84 | 282.60 |
| | 3000 | | 1055.07 | 697.42 | 67.89 | 289.76 | 29.67 | 0.06 | 32.56 | 2.05 | 44.94 | 0.64 | 295.51 | 288.13 |
| | 500 | 60 | 1045.30 | 673.54 | 11.89 | 359.87 | 33.79 | 0.14 | 31.42 | 1.72 | 46.87 | 2.11 | 261.77 | 255.22 |
| | 1000 | | 1046.70 | 677.23 | 23.53 | 345.94 | 33.48 | 0.17 | 30.53 | 1.78 | 45.40 | 0.48 | 277.10 | 270.17 |
| | 1500 | | 1048.10 | 680.73 | 34.80 | 332.57 | 31.18 | 0.13 | 29.92 | 2.02 | 45.18 | 1.04 | 269.46 | 262.73 |
| | 2000 | | 1048.87 | 684.07 | 45.63 | 319.17 | 30.44 | 0.08 | 29.84 | 1.67 | 44.77 | 0.82 | 276.13 | 269.23 |
| | 2500 | | 1049.63 | 687.25 | 55.98 | 306.40 | 30.05 | 0.15 | 29.65 | 2.02 | 44.17 | 0.53 | 286.90 | 279.73 |
| | 3000 | | 1050.40 | 690.31 | 65.83 | 294.26 | 29.18 | 0.08 | 29.42 | 1.55 | 43.60 | 1.22 | 292.84 | 285.52 |
| | 500 | 70 | 1039.42 | 665.36 | 11.54 | 362.52 | 33.43 | 0.07 | 31.40 | 1.37 | 43.16 | 2.41 | 274.30 | 267.44 |
| | 1000 | | 1040.74 | 669.31 | 22.82 | 348.61 | 32.79 | 0.08 | 30.21 | 1.21 | 41.03 | 0.89 | 289.34 | 282.11 |
| | 1500 | | 1042.06 | 673.05 | 33.75 | 335.26 | 30.54 | 0.01 | 28.13 | 1.88 | 41.64 | 2.12 | 277.58 | 270.64 |
| | 2000 | | 1042.72 | 676.59 | 44.26 | 321.87 | 29.99 | 0.02 | 27.31 | 1.42 | 41.18 | 1.67 | 286.00 | 278.85 |
| | 2500 | | 1043.38 | 679.97 | 54.31 | 309.10 | 29.44 | 0.06 | 27.11 | 1.99 | 38.67 | 1.42 | 303.24 | 295.65 |
| | 3000 | | 1044.03 | 683.19 | 63.90 | 296.94 | 28.06 | 0.11 | 26.60 | 1.41 | 37.18 | 0.74 | 307.01 | 299.33 |

TABLE 4D
([H₂ + cushion] + n-octane + brine) experimental data at 15 wt. % salinity.

| | | | | | | | | | CA for | | CA for WC | | | |
|---|---|---|---|---|---|---|---|---|---|---|---|---|---|---|
| Salinity | P | T | ρ_{brine} | ρ_{octane} | ρ_{60% H}_{₂}_{+40% Impurity} | Δρ | IFT (mN/m) | | Quartz (°) | | shale (°) | | hₛₑₐₗ | h_{(seal/res)} |
| (wt. %) | (psi) | (° C.) | (kg/m³) | (kg/m³) | (kg/m³) | (kg/m³) | VALUES | ±SD | VALUES | ±SD | VALUES | ±SD | (m) | (m) |
| 15 | 500 | 30 | 1089.71 | 697.59 | 13.10 | 379.02 | 36.57 | 0.50 | 44.14 | 0.77 | 58.03 | 0.13 | 208.36 | 203.15 |
| | 1000 | | 1090.92 | 700.62 | 25.95 | 364.35 | 36.23 | 0.40 | 43.86 | 1.18 | 57.75 | 0.64 | 216.40 | 210.99 |
| | 1500 | | 1092.13 | 703.53 | 38.40 | 350.20 | 34.43 | 0.46 | 44.33 | 1.34 | 58.22 | 0.14 | 211.15 | 205.87 |
| | 2000 | | 1092.87 | 706.32 | 50.34 | 336.21 | 34.36 | 0.40 | 43.98 | 1.18 | 57.87 | 0.72 | 221.68 | 216.14 |
| | 2500 | | 1093.62 | 709.02 | 61.71 | 322.89 | 34.14 | 0.41 | 44.53 | 1.07 | 58.42 | 0.28 | 225.83 | 220.18 |
| | 3000 | | 1094.36 | 711.62 | 72.49 | 310.25 | 32.67 | 0.40 | 44.56 | 1.20 | 58.45 | 0.25 | 224.72 | 219.10 |
| | 500 | 40 | 1085.10 | 689.65 | 12.67 | 382.78 | 35.97 | 0.42 | 42.40 | 0.87 | 54.99 | 0.12 | 219.86 | 214.36 |
| | 1000 | | 1086.30 | 692.88 | 25.09 | 368.33 | 35.68 | 0.43 | 41.65 | 0.93 | 52.01 | 3.47 | 243.14 | 237.06 |
| | 1500 | | 1087.50 | 695.97 | 37.11 | 354.42 | 33.67 | 0.52 | 40.56 | 1.17 | 53.66 | 2.41 | 229.62 | 223.88 |
| | 2000 | | 1088.17 | 698.93 | 48.66 | 340.58 | 32.83 | 0.48 | 42.30 | 0.82 | 54.47 | 1.22 | 228.42 | 222.71 |
| | 2500 | | 1088.84 | 701.78 | 59.66 | 327.40 | 32.19 | 0.46 | 41.67 | 1.17 | 54.18 | 0.87 | 234.66 | 228.79 |
| | 3000 | | 1089.51 | 704.52 | 70.11 | 314.88 | 31.70 | 0.44 | 42.14 | 1.52 | 53.38 | 1.18 | 244.90 | 238.78 |
| | 500 | 50 | 1079.92 | 681.63 | 12.27 | 386.02 | 35.76 | 0.49 | 38.80 | 1.38 | 50.43 | 0.64 | 240.63 | 234.61 |
| | 1000 | | 1081.14 | 685.08 | 24.28 | 371.78 | 35.22 | 0.47 | 39.30 | 1.79 | 49.68 | 0.32 | 249.96 | 243.71 |
| | 1500 | | 1082.36 | 688.37 | 35.92 | 358.07 | 33.29 | 0.45 | 39.01 | 1.95 | 49.72 | 0.18 | 245.11 | 238.98 |
| | 2000 | | 1083.26 | 691.51 | 47.09 | 344.66 | 32.56 | 0.44 | 38.30 | 1.79 | 48.42 | 0.67 | 255.66 | 249.27 |
| | 2500 | | 1084.15 | 694.52 | 57.75 | 331.88 | 31.90 | 0.44 | 37.40 | 1.68 | 47.31 | 0.72 | 265.77 | 259.13 |
| | 3000 | | 1085.05 | 697.42 | 67.89 | 319.74 | 31.57 | 0.40 | 36.41 | 1.81 | 46.06 | 0.19 | 279.43 | 272.44 |
| | 500 | 60 | 1073.82 | 673.54 | 11.89 | 388.39 | 34.31 | 0.42 | 36.47 | 1.48 | 47.71 | 0.28 | 242.40 | 236.34 |
| | 1000 | | 1075.04 | 677.23 | 23.53 | 374.28 | 33.96 | 0.43 | 35.62 | 1.54 | 45.85 | 1.04 | 257.72 | 251.28 |
| | 1500 | | 1076.26 | 680.73 | 34.80 | 360.73 | 31.91 | 0.42 | 34.60 | 1.78 | 45.21 | 0.72 | 254.14 | 247.78 |
| | 2000 | | 1076.91 | 684.07 | 45.63 | 347.21 | 31.23 | 0.41 | 34.12 | 1.43 | 44.62 | 0.11 | 261.03 | 254.50 |
| | 2500 | | 1077.57 | 687.25 | 55.98 | 334.34 | 30.39 | 0.43 | 33.84 | 1.78 | 43.78 | 0.42 | 267.62 | 260.93 |
| | 3000 | | 1078.22 | 690.31 | 65.83 | 322.08 | 30.12 | 0.41 | 32.60 | 1.31 | 43.06 | 0.72 | 278.58 | 271.62 |
| | 500 | 70 | 1066.63 | 665.36 | 11.54 | 389.73 | 33.79 | 0.41 | 33.43 | 1.13 | 42.64 | 2.11 | 260.07 | 253.56 |
| | 1000 | | 1067.86 | 669.31 | 22.82 | 375.73 | 33.78 | 0.41 | 32.46 | 0.97 | 41.44 | 0.74 | 274.83 | 267.96 |
| | 1500 | | 1069.09 | 673.05 | 33.75 | 362.29 | 31.34 | 0.39 | 31.35 | 1.64 | 41.18 | 1.42 | 265.45 | 258.82 |
| | 2000 | | 1069.86 | 676.59 | 44.26 | 349.01 | 30.56 | 0.40 | 30.43 | 1.18 | 40.22 | 0.41 | 272.59 | 265.78 |
| | 2500 | | 1070.63 | 679.97 | 54.31 | 336.35 | 29.89 | 0.40 | 29.36 | 1.75 | 38.03 | 0.85 | 285.44 | 278.30 |
| | 3000 | | 1071.40 | 683.19 | 63.90 | 324.31 | 29.61 | 0.42 | 28.34 | 1.17 | 36.69 | 0.17 | 298.49 | 291.03 |

TABLE 4E
([H₂ + cushion] + n-octane + brine) experimental data at 20 wt. % salinity.

| | | | | | | | | | CA for | | CA for WC | | | |
|---|---|---|---|---|---|---|---|---|---|---|---|---|---|---|
| Salinity | P | T | ρ_{brine} | ρ_{octane} | ρ_{60% H}_{₂}_{+40% Impurity} | Δρ | IFT (mN/m) | | Quartz (°) | | shale (°) | | hₛₑₐₗ | h_{(seal/res)} |
| (wt. %) | (psi) | (° C.) | (kg/m³) | (kg/m³) | (kg/m³) | (kg/m³) | VALUES | ±SD | VALUES | ±SD | VALUES | ±SD | (m) | (m) |
| 20 | 500 | 30 | 1096.52 | 697.59 | 13.10 | 385.83 | 37.51 | 1.54 | 45.76 | 1.02 | 59.05 | 0.41 | 203.93 | 198.83 |
| | 1000 | | 1097.54 | 700.62 | 25.95 | 370.97 | 37.34 | 1.38 | 44.92 | 1.43 | 59.49 | 1.11 | 208.39 | 203.18 |
| | 1500 | | 1098.56 | 703.53 | 38.40 | 356.63 | 35.04 | 1.67 | 45.39 | 1.59 | 58.99 | 0.87 | 206.44 | 201.28 |
| | 2000 | | 1098.91 | 706.32 | 50.34 | 342.25 | 34.42 | 1.36 | 45.04 | 1.43 | 58.42 | 0.21 | 214.80 | 209.43 |
| | 2500 | | 1099.25 | 709.02 | 61.71 | 328.52 | 34.44 | 1.35 | 45.59 | 1.32 | 58.56 | 1.30 | 222.96 | 217.38 |
| | 3000 | | 1099.60 | 711.62 | 72.49 | 315.49 | 33.56 | 0.96 | 45.62 | 1.45 | 57.71 | 0.31 | 231.75 | 225.96 |
| | 500 | 40 | 1092.34 | 689.65 | 12.67 | 390.02 | 37.26 | 1.60 | 44.35 | 1.12 | 56.35 | 0.21 | 215.90 | 210.50 |
| | 1000 | | 1093.26 | 692.88 | 25.09 | 375.29 | 37.12 | 1.02 | 43.60 | 1.18 | 56.44 | 1.78 | 222.97 | 217.39 |
| | 1500 | | 1094.17 | 695.97 | 37.11 | 361.09 | 34.82 | 0.05 | 42.51 | 1.42 | 56.57 | 1.29 | 216.65 | 211.24 |
| | 2000 | | 1094.41 | 698.93 | 48.66 | 346.82 | 33.62 | 0.47 | 44.25 | 1.07 | 56.48 | 0.89 | 218.30 | 212.84 |
| | 2500 | | 1094.64 | 701.78 | 59.66 | 333.20 | 32.78 | 0.03 | 43.62 | 1.42 | 55.99 | 2.43 | 224.43 | 218.82 |
| | 3000 | | 1094.87 | 704.52 | 70.11 | 320.24 | 32.13 | 0.10 | 44.09 | 1.77 | 53.81 | 1.87 | 241.59 | 235.55 |
| | 500 | 50 | 1086.46 | 681.63 | 12.27 | 392.56 | 36.97 | 0.86 | 42.25 | 1.20 | 51.64 | 0.75 | 238.35 | 232.39 |
| | 1000 | | 1087.59 | 685.08 | 24.28 | 378.23 | 36.77 | 1.04 | 41.25 | 1.61 | 50.37 | 0.21 | 252.87 | 246.54 |
| | 1500 | | 1088.72 | 688.37 | 35.92 | 364.43 | 33.82 | 0.66 | 40.15 | 1.77 | 49.61 | 1.02 | 245.23 | 239.10 |
| | 2000 | | 1089.85 | 691.51 | 47.09 | 351.25 | 33.03 | 1.17 | 40.25 | 1.61 | 49.28 | 0.32 | 250.14 | 243.88 |
| | 2500 | | 1090.40 | 694.52 | 57.75 | 338.13 | 32.34 | 0.46 | 39.35 | 1.50 | 47.62 | 0.13 | 262.88 | 256.30 |
| | 3000 | | 1090.95 | 697.42 | 67.89 | 325.64 | 31.69 | 0.52 | 38.36 | 1.63 | 49.26 | 0.63 | 259.00 | 252.53 |
| | 500 | 60 | 1079.53 | 673.54 | 11.89 | 394.10 | 35.89 | 0.30 | 38.42 | 1.30 | 48.22 | 0.87 | 247.41 | 241.23 |
| | 1000 | | 1080.76 | 677.23 | 23.53 | 380.00 | 34.78 | 0.79 | 37.57 | 1.36 | 47.33 | 0.63 | 252.97 | 246.65 |
| | 1500 | | 1081.99 | 680.73 | 34.80 | 366.46 | 33.17 | 0.37 | 36.55 | 1.60 | 46.72 | 0.28 | 253.05 | 246.72 |
| | 2000 | | 1083.22 | 684.07 | 45.63 | 353.52 | 31.40 | 0.23 | 36.07 | 1.25 | 46.64 | 0.46 | 248.65 | 242.44 |
| | 2500 | | 1083.56 | 687.25 | 55.98 | 340.33 | 30.70 | 0.35 | 35.79 | 1.60 | 46.45 | 0.23 | 253.44 | 247.10 |
| | 3000 | | 1083.90 | 690.31 | 65.83 | 327.76 | 30.27 | 0.04 | 34.55 | 1.13 | 46.22 | 0.51 | 260.62 | 254.11 |
| | 500 | 70 | 1072.43 | 665.36 | 11.54 | 395.53 | 34.78 | 1.00 | 35.38 | 0.95 | 44.72 | 0.65 | 254.77 | 248.41 |
| | 1000 | | 1073.41 | 669.31 | 22.82 | 381.28 | 33.97 | 0.79 | 34.41 | 0.79 | 43.78 | 0.15 | 262.31 | 255.75 |
| | 1500 | | 1074.40 | 673.05 | 33.75 | 367.60 | 31.36 | 0.33 | 33.87 | 1.46 | 43.26 | 0.87 | 253.32 | 246.99 |
| | 2000 | | 1075.39 | 676.59 | 44.26 | 354.54 | 30.60 | 0.85 | 31.78 | 1.00 | 42.30 | 1.04 | 260.32 | 253.82 |
| | 2500 | | 1076.15 | 679.97 | 54.31 | 341.87 | 30.01 | 1.71 | 31.31 | 1.57 | 40.11 | 0.18 | 273.77 | 266.92 |
| | 3000 | | 1076.92 | 683.19 | 63.90 | 329.83 | 29.84 | 0.53 | 30.29 | 0.99 | 40.02 | 0.32 | 282.53 | 275.46 |

TABLE 5A
(CH₄ + n-octane + brine) experimental data at a temperature of 30, 40, and 50° C.

| Salinity | P | T | ρ_{brine} | ρ_{octane} | ρ_{100% CH}_{₄} | Δρ | IFT (mN/m) | |
|---|---|---|---|---|---|---|---|---|
| (wt. %) | (psi) | (° C.) | (kg/m³) | (kg/m³) | (kg/m³) | (kg/m³) | VALUES | ±SD |
| 5 | 500 | 30 | 1029.77 | 697.59 | 23.202 | 308.98 | 31.26 | 0.11 |
| | 1000 | | 1030.77 | 700.62 | 48.914 | 281.24 | 30.48 | 0.32 |
| | 1500 | | 1031.77 | 703.53 | 76.65 | 251.59 | 30.25 | 0.43 |
| | 2000 | | 1032.97 | 706.32 | 105.08 | 221.57 | 29.80 | 0.06 |
| | 2500 | | 1034.07 | 709.02 | 132.33 | 192.72 | 29.48 | 1.03 |
| | 3000 | | 1035.12 | 711.62 | 156.91 | 166.59 | 28.69 | 0.26 |
| | 500 | 40 | 1027.01 | 689.65 | 22.304 | 315.06 | 31.11 | 1.11 |
| | 1000 | | 1028.23 | 692.88 | 46.66 | 288.69 | 30.23 | 0.62 |
| | 1500 | | 1029.44 | 695.97 | 72.592 | 260.88 | 28.40 | 0.32 |
| | 2000 | | 1031.13 | 698.93 | 99.041 | 233.16 | 28.17 | 0.21 |
| | 2500 | | 1031.45 | 701.78 | 124.59 | 205.08 | 27.84 | 0.42 |
| | 3000 | | 1031.87 | 704.52 | 148.02 | 179.33 | 27.12 | 1.03 |
| | 500 | 50 | 1022.29 | 681.63 | 21.483 | 319.17 | 29.71 | 0.76 |
| | 1000 | | 1023.27 | 685.08 | 44.65 | 293.54 | 29.67 | 0.42 |
| | 1500 | | 1024.26 | 688.37 | 69.051 | 266.84 | 27.80 | 0.56 |
| | 2000 | | 1024.86 | 691.51 | 93.823 | 239.53 | 26.71 | 0.76 |
| | 2500 | | 1025.21 | 694.52 | 117.86 | 212.83 | 26.24 | 0.64 |
| | 3000 | | 1025.68 | 697.42 | 140.19 | 188.07 | 25.66 | 0.32 |

TABLE 5B
(CH₄ + n-octane + brine) experimental data at a temperature of 60 and 70° C.

| Salinity | P | T | ρ_{brine} | ρ_{octane} | ρ_{100% CH}_{₄} | Δρ | IFT (mN/m) | |
|---|---|---|---|---|---|---|---|---|
| (wt. %) | (psi) | (° C.) | (kg/m³) | (kg/m³) | (kg/m³) | (kg/m³) | VALUES | ±SD |
| | 500 | 60 | 1017.23 | 673.54 | 20.727 | 322.96 | 29.15 | 0.33 |
| | 1000 | | 1018.26 | 677.23 | 42.841 | 298.19 | 29.21 | 0.67 |
| | 1500 | | 1019.29 | 680.73 | 65.923 | 272.64 | 27.56 | 0.81 |
| | 2000 | | 1019.86 | 684.07 | 89.256 | 246.53 | 26.65 | 0.25 |
| | 2500 | | 1020.61 | 687.25 | 111.96 | 221.40 | 26.11 | 0.68 |
| | 3000 | | 1021.18 | 690.31 | 133.26 | 197.61 | 25.11 | 0/48 |
| | 500 | 70 | 1010.80 | 665.36 | 20.029 | 325.41 | 28.94 | 0.56 |
| | 1000 | | 1011.90 | 669.31 | 41.201 | 301.39 | 27.57 | 0.22 |
| | 1500 | | 1013.00 | 673.05 | 63.131 | 276.82 | 26.06 | 0.11 |
| | 2000 | | 1013.82 | 676.59 | 85.215 | 252.02 | 25.72 | 1.04 |
| | 2500 | | 1014.64 | 679.97 | 106.74 | 227.93 | 24.82 | 0.67 |
| | 3000 | | 1015.46 | 683.19 | 127.08 | 205.19 | 24.42 | 0.83 |

The decrease of the column height with salinity variations is partly attributable to the calculated density difference, as well as the measured contact angle and IFT. It should be noted that the densities of brine, n-octane, and the gas (either H₂ or [H₂+cushion]) increase with pressure but decrease with increasing temperature. In contrast, brine density increases with salinity. By examining Tables 3A-3E and Tables 4A-4E, it becomes apparent that the density disparity between the liquid (brine+octane) and H₂ surpasses that of (H₂+cushion). Since column height is inversely related to density difference, the projected column height for the injection of pure H₂ exceeds that of H₂+cushion (compare FIGS. 20A and 20B with FIGS. 20C and 20D. This disparity is primarily linked to increased brine density with increasing salinity (while the n-octane density remains constant). Furthermore, the observation of lower contact angle (CA) and higher interfacial tension (IFT) during the injection of pure H₂, compared to H₂+cushion gas, aligns with the descriptions in Eqs. (6) and (7), respectively, enabling a more extensive column height for gas storage within the reservoir. Overall, FIGS. 20A-20D also shows that column height decreases with salinity and increases with pressure.

To conclude, hydrogen storage in depleted gas condensate reservoirs is a promising approach to achieving a long-lasting solution for future clean energy utilization. However, understanding the influence of native gases with hydrocarbon fluids such as n-octane is currently lacking. Herein, extensive contact angle and IFT experiments were performed using reservoir and caprock substrates to understand the hydrodynamic impact in the storage medium over a range of reservoir pressure (500 to 3000 psi), temperature (30 to 70° C.), and NaCl brine salinity (2 to 20 wt. %). This was achieved by employing a drop shape analyzer device. Specifically, the contact angle was measured for H₂/brine/n-octane/rock and (H₂+cushion)/brine/n-octane/rock using a captive bubble cell, whereas the IFT between H₂/brine/n-octane and (H₂+cushion)/brine/n-octane was measured using the well-established pendant drop technique.-Some finds of the present disclosure are summarized below.

In a captive bubble setup for contact angle measurement, the bubble size and time duration can influence the accuracy of the measured contact angle as larger bubble sizes resulted in a smaller contact angle (more water wet) compared to smaller bubble sizes (less water wet).

The presence of calcite mineral can influence the contact angle measurement since the measured contact angle for the quartz (reservoir sample) was generally smaller than those of the Wolf Camp shale (caprock) due to the presence of calcite mineral in the caprock irrespective of the bubble sizes.

The contact angle effect on pressure was insignificant, but it decreased with temperature and increased with salinity.

In the reservoir rock, the contact angle for the H₂/brine/n-octane three-phase system was more strongly water wetting [21 to 37°] than those of (H₂+cushion)/brine/n-octane [24 to 46°] signifying the impact of cushion gas. This implies that while H₂ gas itself does not wet the surface, the presence of a cushion gas is crucial for mitigating snap-off and preventing the residual trapping of H₂, thus ensuring minimal losses during withdrawal.

Accordingly, the contact angle for H₂/brine/n-octane WC shale was more strongly water wetting [28 to 57°] than those of (H₂+cushion)/brine/n-octane [35 to 60°] in a three-phase system which is weakly water wet. This also signifies that structural trapping capacity will be higher in the absence of cushion gas; thus, containment of the gas is essential to avoid leakages during withdrawal.

The IFT decreased with increasing pressure and temperature and increased with reservoir salinity.

For the H₂/brine/n-octane system, the effect of IFT on temperature was almost constant at lower pressure (i.e., between 500 and 1000 psi) compared to IFT's effects on temperature at higher pressure.

In the case of the H₂+cushion/brine/n-octane system, the IFT effect was consistent as it systematically decreased with increasing temperature and pressure at all the different isobars and isotherms.

By comparing the IFTs of ternary (H₂+cushion)/n-octane/brine system with those of binary (H₂+cushion)/brine system, it was found that the n-octane could reduce the system IFT by about 50%.

The estimated column height increased with increasing temperature but decreased with increasing salinity.

Pore sizes can influence column height estimates, typically resulting in a higher estimated column height for the capillary effect of the seal rock compared to the column height that considers both the seal and reservoir rock capillary effects.

Overall, this study offers valuable insights into the fundamental aspects of interfacial phenomena within three-phase systems involving single gas, e.g., H₂, and gas mixtures, e.g., (H₂ +cushion), brine, and n-octane. These findings can be applied to improve the design of processes associated with underground hydrogen storage in depleted gas reservoir fields containing condensate.

Numerous modifications and variations of the present disclosure are possible in light of the above teachings. It is, therefore, to be understood that within the scope of the appended claims, the invention may be practiced otherwise than as specifically described herein.

1: A method of hydrogen (H₂) storage and withdrawal, the method comprising:
injecting a fluid stream into a subsurface formation via at least one injection well to form a composition containing a gas-phase mixture, a first liquid-phase mixture and a solid matrix, wherein
the gas-phase mixture of the composition includes 60 to 100 vol. % of H₂ based on a total volume of the gas-phase mixture,
the first liquid-phase mixture of the composition includes water and at least one water-soluble mineral, and
the solid matrix of the composition includes clay, shale, slate, and minerals;
injecting a H₂-containing gas stream into the subsurface formation via the at least one injection well to form a first gas mixture containing H₂ gas, wherein the H₂-containing gas stream includes at least 50 vol. % of H₂ based on a total volume of the H₂-containing gas stream;
heating and pressurizing the subsurface formation containing the first gas mixture via at least one heat well to achieve a storage condition and maintaining the storage condition to store the H₂ in the subsurface formation;
injecting a CH₄-containing gas stream into the subsurface formation via the at least one injection well to form a second gas mixture;
withdrawing the second gas mixture under a withdrawal condition from the subsurface formation via at least one production well, the withdrawal condition having at least one of a matrix temperature and an injection well pressure the same as the storage condition; and
introducing the second gas mixture into a hydrogen purification device including a plurality of hydrogen-selective membranes to form a product gas stream comprising H₂.

2: The method of claim 1, wherein the composition further includes a second liquid-phase mixture that contains at least one hydrocarbon compound and is immiscible with the first liquid-phase mixture.

3: The method of claim 2, wherein the second liquid-phase mixture contains n-octane.

4: The method of claim 1, wherein:
the gas-phase mixture of the composition includes no methane (CH₄),
the first gas mixture includes no CH₄, and
the second gas mixture includes 30 vol. % to 50 vol. % of CH₄ based on a total volume of the second gas mixture.

5: The method of claim 4, wherein:
the first gas mixture under the storage condition includes about 72 vol. % to 100 vol. % of H₂, about 0 to 14 vol. % of N₂ and about 0 to 14 vol. % of CO₂ based on a total volume of the first gas mixture, and
the second gas mixture includes about 60 vol. % of H₂, about 30 vol. % of CH₄, about 5 vol. % of CO₂ and about 5 vol. % of N₂ based on the total volume of the second gas mixture.

6: The method of claim 5, wherein the gas-phase mixture of the composition includes 60% to 100% of H₂, 0 to 30% of nitrogen (N₂) and 0 to 10% of carbon dioxide (CO₂) based on the total volume of the gas-phase mixture.

7: The method of claim 1, wherein the gas-phase mixture of the composition further includes up to 5 vol. % of hydrogen sulfide (H₂S), based on the total volume of the gas-phase mixture.

8: The method of claim 1, wherein the gas-phase mixture of the composition further includes up to 5 vol. % of moisture (H₂O), based on the total volume of the gas-phase mixture.

9: The method of claim 1, wherein the subsurface formation is a hydrocarbon-containing reservoir, a depleted natural gas reservoir, a carbon sequestration reservoir, an aquifer, a geothermal reservoir, and/or an in-situ leachable ore deposit.

10: The method of claim 1, wherein the subsurface formation includes a rock material from at least one shale selected from the group consisting of Eagle ford shale, Wolfcamp shale, Posidonia shale, Wellington shale, and Mancos shale.

11: The method of claim 10, wherein the rock material includes one or more of Bentheimer sandstone, Berea sandstone, Vosges sandstone, quartz, borosilicate glass, basalt, shale, calcite, granite, dolomite, gypsum, anhydrite, mica, kaolinite, illite, montmorillonite, and coal.

12: The method of claim 1, wherein the at least one water-soluble mineral includes one or more of sodium bicarbonate, sodium carbonate, sodium chloride, potassium bicarbonate, potassium carbonate, and potassium chloride.

13: The method of claim 1, wherein the at least one water-soluble mineral is present in the first liquid-phase mixture at a concentration of 0.1 to 30 wt. % based on a total weight of the first liquid-phase mixture.

14: The method of claim 13, wherein the at least one water-soluble mineral includes sodium chloride at a concentration of 2 to 5 wt. % based on a total weight of the first liquid-phase mixture.

15: The method of claim 1, wherein the solid matrix of the composition further includes silicate, argillite, quartz, sandstone, gypsum, conglomerate, basalt, feldspar, mica, granite, granodiorite, diorite, calcite, kaolinite, illite, montmorillonite, and sand.

16: The method of claim 1, wherein the storage condition has a temperature in a range of 20 to 80° C. in the subsurface formation.

17: The method of claim 1, wherein the storage condition has a pressure of 300 to 5000 psi in the subsurface formation.

18: The method of claim 1, wherein:
the fluid stream is injected to increase an H₂ storage capacity of the subsurface formation,
the first gas mixture under the storage condition includes about 80 vol. % of H₂, about 10 vol. % of N₂ and about 10 vol. % of CO₂ based on a total volume of the first gas mixture, and
the storage condition has a temperature in a range of 30 to 40° C.

19: The method of claim 1, further comprising:
passing the gas mixture through the plurality of hydrogen-selective membranes in the hydrogen purification device thereby allowing hydrogen gas to pass through the hydrogen-selective membranes and rejecting other components in the gas mixture to form a residue composition, wherein the plurality of hydrogen-selective membranes are permeable to hydrogen gas, but are at least substantially impermeable to other components in the gas mixture; and
collecting the hydrogen gas after passing and recycling the residue composition.

20: The method of claim 1, wherein:
the solid matrix, the gas-phase mixture and the first liquid-phase mixture form a three-phase system,
the injecting the fluid stream into the subsurface formation increases wettability of the solid matrix by contact with the gas-phase mixture and the first liquid-phase mixture so that a contact angle of the three-phase system is 20°-50°, and
the injecting the fluid stream into the subsurface formation reduces surface tension of the gas-phase mixture and the first liquid-phase mixture so that an interfacial tension of the three-phase system is 20-45 mN/m.
